(19) United States
(12) Patent Application Publication
(10) Pub. No.: US 2010/0064001 A1
(43) Pub. Date: Mar. 11, 2010

(54) Distributed Processing

(75) Inventor: W. Mark Daily, Denver, CO (US)

Correspondence Address: MARSH, FISCHMANN & BREYFOGLE LLP, 8055 East Tufts Avenue, Suite 450, Denver, CO, 80237, US

(73) Assignee: POWER TAKEOFF, L.P., DENVER, CO (US)

(21) Appl. No.: 12/556,566

(22) Filed: Sep. 9, 2009

Related U.S. Application Data
(63) Continuation-in-part of application No. 12/472,903, filed on May 27, 2009.
Application No. 12/472,903 is a continuation-in-part of application No. 12/249,716, filed on Oct. 10, 2008, now abandoned.
(60) Provisional application No. 61/069,732, filed on Mar. 16, 2008.
(60) Provisional application No. 60/998,483, filed on Oct. 10, 2007.
(60) Provisional application No. 60/998,482, filed on Oct. 10, 2007.

(51) Int. Cl. G06F 15/16

(52) U.S. Cl. 709/203

(57) ABSTRACT

A distributed processing system for acquiring utility usage information from customer facilities, processing the utility usage information, and delivering the utility usage information in formats that facilitate understanding by end-users. The distributed processing system may include a server system that may store utility usage information, generate real-time alert messages, and create spreadsheet report attachments that may be pushed to end-users. Some of the spreadsheet reports may include a number of navigations buttons allowing a user to toggle between various tools that analyze utility usage information.

### CROSS-REFERENCE TO RELATED APPLICATIONS

This application is a continuation-in-part of U.S. patent application Ser. No. 12/472,903, entitled “DISTRIBUTED PROCESSING”, filed on May 27, 2009, which is a continuation-in-part of U.S. patent application Ser. No. 12/249,716, entitled “DISTRIBUTED PROCESSING,” filed on Oct. 10, 2008, which claims the benefit of U.S. Provisional Application No. 61/069,732, entitled, “ENERGY EXPERT—INTEGRATED BILLING AND INTERVAL DATA,” filed on Mar. 16, 2008, U.S. Provisional Application No. 60/998,483, entitled, “BILL REPORT,” filed on Oct. 10, 2007, and U.S. Provisional Application No. 60/998,482, entitled, “BILL ANALYZER,” filed on Oct. 10, 2007. The disclosure of all of the above-mentioned related applications is hereby incorporated into the present application.

### BACKGROUND OF THE INVENTION

The provision of utilities such as electricity, gas and water to consumers has always required regular monitoring of the usage by the utility providers. This function is usually performed by means of a meter installed at the point of usage. The consumer is then billed for the usage of the utility based on readings of the meter at periodic intervals and subsequently pays the company providing utility for the usage. The act of reading the meter and recording the usage was traditionally performed manually by meter readers visiting each individual meter installation at periodic intervals. The utility company then mailed a bill to the consumer who subsequently paid the utility company by mailing a check or even paying in person at the utility company or other receiving location.

More recently, monitoring of utility usage has been accomplished by way of automatic transmission of utility data from the point of usage to the utility company and/or billing entity over communication networks (e.g., WANs, LANs) either in specified intervals or else at the end of each billing period. Thereafter, the utility data is appropriately stored and bills are either mailed to customers (e.g., snail mail, email) or else billing information is made available on a website for access by the consumer. The consumer can then review standard billing information such as the quantity of a particular utility used (e.g., kWh of energy, therms of natural gas) and choose to pay by way of a check (e.g., paper, e-check), credit card, direct debit, and the like.

With the deregulation of the utility industry in addition to heightened concern over environmental issues and utility consumption efficiency, for example, there has been significant interest in providing consumers (e.g., individuals, businesses) with utility usage information to enable consumers to more effectively monitor utility usage and thus reduce or otherwise more appropriately balance utility usage. For instance, demand for electricity, water, gas and other utilities is sometimes greatest during daylight and business hours but may also depend on other factors (e.g., weather patterns, customer's production schedule). Moreover, providing consumers with such usage information reduces the current freedom that many utility operators and suppliers possess to set prices in their own favor.

Some utility management systems exist that allow consumers to manually retrieve utility usage data and store such data on appropriate memory devices to monitor usage. Consumers can operate software programs to observe usage information in a more easily understood manner. For instance, the programs can provide functions such as plotting of usage by time of day or by day of week or presenting hologram plots over the past several months. Such functions can enable the consumer to analyze its usage patterns and thus optimize usage to reduce utility usage costs. Some programs also include functionality allowing consumers to analyze usage patterns and present the consumer or other user with tips to minimize utility bills.

Other programs and applications currently available for utility billing or usage data analysis are typically complex and include a significant learning curve and can fall into a couple different categories. Some of such products are client-based, meaning they run as an executable file on a local computer. These products require that the customer either input the billing data manually or download it from an external source, and can segment the data in many different ways. While such products can be fast and powerful, they are often so complex that they require specialized training and support for one or more dedicated technical employee(s). Other programs are web-based and require the customer to go to a web site and login to use the analysis tools. These programs may use manually loaded billing data but the data is usually from an external source. While these products have the advantage of operating from anywhere as they are web-based, they are typically not as fast or full-featured as client-based versions and are similarly as complex and require the attention of one or more dedicated employees.

### SUMMARY OF THE INVENTION

The inventor has discovered that utility consumers from smaller entities such as families and individuals to large entities such as manufacturing plants, government agencies and even utility providers themselves would benefit from methods and systems for delivering utility usage information (e.g., utility consumption and demand information) to such consumers with little effort on the part of the consumers in easy to utilize formats. Businesses of all sizes can benefit from such utility usage information to manage their energy costs and improve their environmental performance. The financial benefits of such utility usage information knowledge may be most important to businesses in which a larger percentage of their operating expenses are energy related. In all business sectors, there may be a significant marketing value for improved environmental performance. Utilities and regulatory agencies can benefit as they are typically mandated to reduce energy demand (e.g., state and federal laws requiring more energy conservation) and increase alternative energy supply (e.g., solar, wind). Moreover, consultants, contractors and vendors may also benefit as they could increase revenue by designing, implementing and monitoring energy related projects.

The utility usage information in the systems and methods disclosed herein may be automatically delivered to the consumers by way of various communication networks on various platforms and in any desired frequencies from real-time up to utility billing cycles and beyond. While such utility usage information is described as being delivered and/or used by the consumers themselves, it is also contemplated that the utility usage information about such consumers could be received and/or used by other entities as well.

According to a first aspect, a method for providing an analysis of utility usage data (e.g., interval and billing data related to electricity, gas, water) to an end user is provided. Broadly, the method includes receiving utility usage data related to the end user at a server system that includes at least one memory module and at least one processor module, storing the utility usage data in the at least one memory module of the server system, and sending (e.g., pushing), using the at least one processor module, a first message to the user, the first message including an attachment (e.g., spreadsheet) that is operable to access the utility usage data. In this regard, the user or recipient of the message may receive a message (via the processor module) regarding updated or current utility usage data as soon as new data is available in the server system (e.g., real-time, substantially real-time, daily, monthly). The method may allow users to analyze the utility usage information in numerous useful manners to more appropriately exploit utilities while at the same time reducing costs for such exploitation. For instance, after receipt of the spreadsheet and access of the utility usage data, the user can appropriately store the data on a local computing device (e.g., desktop, laptop) and then run the spreadsheet on the same or a different computing device. As such, the user obtains the benefits of both desktop environments (e.g., fast and secure computing) and web-based environments (e.g., ready access to data and no software to download).

In one arrangement, the method may include using a processor module of the server system to create an HTML webpage that includes the utility usage data, and using the processor module to trigger the server system to send the first message to the end user after creation of the HTML webpage. The server system may be triggered on any appropriate basis (e.g., upon receipt of the data in the server system, daily, monthly). In this regard, the spreadsheet attachment may be operable to access the utility usage data from the HTML webpage. As an example, the spreadsheet attachment may use a “web query” function to retrieve the utility usage data from the HTML webpage. In another arrangement, the method may include triggering the server system to send a second message (e.g., text message) to the end user upon creation of the HTML webpage. The second message may appropriately inform one or more users that new data has been received in the server system and/or that an attachment has been transmitted (e.g., emailed, pushed) to a user. In one variation, the server system may send the first and second messages at the same time.

In some arrangements, the body of the first message sent to the end user may include a brief description of the attached spreadsheet as well as descriptions of available tools and instructions for use of the spreadsheet. The message may be in HTML format with hyperlinks for opening up email messages to support teams and for directing the user to other websites. In further arrangements, the method may include automatically accessing the HTML webpage to acquire the utility usage data upon access of the spreadsheet attachment by the end user. Splash screens or other appropriate screens may appear on a display screen of the user's computing device while the utility usage data is being accessed. As the utility usage data may be stored on a remote server system, the user's data may always be available so long as an internet connection is available. After access, the spreadsheet attachment and acquired utility usage data may be appropriately stored on the user's local computing device for subsequent use.

The spreadsheet attachment may be in the form of Microsoft Excel® which may utilize Visual Basic for Applications (VBA) to improve the user experience and minimize the size of the spreadsheets along with the web query function to facilitate retrieval of the utility usage information from the HTML webpage or other location. The user may opt to receive messages with attached spreadsheets in any desired increments such as daily, monthly, etc. The daily spreadsheet attachments generally may only be operable to incorporate current month data while monthly spreadsheet attachments may be operable to incorporate additional billing periods (e.g., up to 18 or more billing periods).

In another arrangement, the spreadsheet attachment may be operable to be run on a computing device that includes a display module (e.g., desktop display, Blackberry® display). A display of the spreadsheet attachment may include a number of regions each of which may be related to utility usage data. For instance, one region may include a plurality of navigation buttons, each of which is operable to be manipulated by a user (e.g., by mouse, stylus, finger), to provide access to a selected one of a number of tools that is operable to analyze utility usage data. A second region of the display may be operable to provide a display or output of the analysis of the utility usage data upon manipulation of at least one of the navigation buttons by the user. Manipulation of one of the navigation buttons may be operable to provide an overview of energy consumption (e.g., kWh) and power demand (e.g., kW) charted over each day of the most recent billing period in the second region. The energy consumption may be indicated in the form of lines while the power demand may be indicated in the form of bars. As such, one column of the chart (e.g., the left “y” axis) may correspond to energy consumption while another column of the chart (e.g., the right “y” axis) may correspond to power demand. Also upon manipulation of the above-described button, another region of the display may be operable to provide additional information regarding energy consumption and power demand such as on and off-peak quantities, estimated costs, advertisements, and the like.

As another example, manipulation of another of the navigation buttons may be operable to display an estimation of how the customer's total cost in one of the billing periods is calculated in the second region. For instance, the second region may display energy and power rates, energy consumption and power demand for the billing period, taxes and fees, etc, in flowchart form. In this regard, the customer or other user may quickly and efficiently see exactly how a current bill is calculated to reduce confusion and locate possible errors. Moreover, in some embodiments the display may include a toggle, drop-down menu or slide bar to allow the user to provide bill estimation for other billing periods. As with the overview tool described above, manipulation of the estimation navigation button may also be operable to display additional information regarding the estimation such as various multipliers used in the calculation, rates and credits. Other types of tools are contemplated for other types of utility usage information analysis and can similarly include various types of graphical depictions, slide bars, drop-down menus and the like. Various color coding can also be utilized to indicate energy consumption versus power demand or other aspects for instance.

As a further example, the second region may be operable to display utility usage data from a number of time periods in a first year for a first location generally adjacent to utility usage data from a number of time periods in a second year for the first location. In another arrangement, the second region may be operable to provide an output of a selected one of the plurality of types of analysis for a first type of utility usage data over a plurality of time periods. Also, the output may operable to be modified. For example, a number of time periods of the plurality of time periods may be operable to be selectively adjusted in any appropriate manner (e.g., slide bar). In an even further arrangement, the second region may be operable to provide an output of a selected one of the plurality of types of analysis for first and second types of utility usage data over a plurality of time periods, the first and second types of utility usage data being different (e.g., power demand and energy consumption). In one variation, the output of the first type of utility usage data may be associated with a first color and the output of the second type of utility usage data may be associated with a second color. Other manners of distinguishing between different types of utility usage data in the second region are also contemplated. For instance, the second region may include a first axis with utility usage information related to the first type of utility usage data and a second axis with utility usage information related to the second type of utility usage data. In one variation, the first axis may be associated with the first color and the second axis may be associated with the second color.

In another arrangement, the output of a selected one of the plurality of types of analyses comprises a visual indication of a calculation of a value in a summary of a user's utility usage. For instance, the summary may be a billing statement, and at least one input in the calculation may be operable to be manipulated. This arrangement may advantageously allow a user to observe, for example, exactly how the user's bill is calculated and to manipulate the bill to uncover as of yet unrealized utility usage savings.

In other arrangements, the first message sent to the user may be designed for larger entities and/or entities with multiple facilities. For instance, the body of the message sent to the end user may include a brief summary of relevant statistics for a number of different facilities (e.g., kWh, kWh/SF, $/SF). The maximum, minimum and average for each of such relevant statistics of all the facilities may also be indicated. Each of the facilities listed in the body may be associated with a hyperlink that is operable when manipulated to have another message transmitted to the user with a spreadsheet attachment as described above regarding the respective facility. The various statistics may be appropriately marked or indicated (e.g., by color coding, patterning) to indicate facilities having the statistic in the highest and/or lowest percentiles relative to the other facilities, other geographic locations, and the like.

In such arrangements, the message may include another spreadsheet attachment (e.g., utilizing Microsoft Excel®) that is operable to utilize and analyze the utility usage data. As described above, an HTML webpage with the current utility usage information may be automatically accessed (e.g. using the web query function of Microsoft Excel®) to retrieve such utility usage information upon a user opening the spreadsheet attachment. This spreadsheet attachment may focus on the financial relationships between total cost and energy, operations, weather and environment of one or more facilities. As such, a display of the spreadsheet (e.g., on a desktop or handheld display) may include a first region with a number of navigation buttons each of which is operable, when manipulated, to provide a display in another region of an estimate or calculation of various aspects of a customer's bill. For example, clicking on a first portion of a “total energy” navigation button may cause a flowchart illustrating each step in the calculation of the customer's total energy calculation to be displayed in a second region of the display. A third region may include a summary box that translates tabular or numerical information from the second region into sentences (e.g., “your electric cost for January, 2009 was 32.6% less than January 2008”). Moreover, each navigation button may include an embedded hyperlink that when manipulated displays another sheet of the spreadsheet with more detailed information related to the specific navigation button. As an example, while clicking on the first portion of the total energy navigation button may illustrate calculation steps such as total electric energy, total electric power, and total natural gas energy, (in other words, more of an overview of the particular navigation button manipulated), the hyperlink associated with the navigation button may present additional information such as total electricity usage and cost over the past several months or years, percentage increases or decreases, etc. This sheet may also include a summary box that translates tabular or numerical information into sentence form. Additional hyperlinks may be included within this sheet to provide additional information.

According to another aspect, a method of providing an analysis of utility usage data to an end user is disclosed. The utility usage data may be related to a plurality of previous utility billing periods before at least one previous utility billing period. The method includes providing a computing device having a memory module and a processor, the processor operable to provide an analysis of utility usage data from at least one previous billing period of the plurality of previous billing periods, creating an email message to be pushed to an inbox of an end user, and pushing the email message to an email inbox of the end user. The pushed email message may include various sections related to utility usage such as at least one customer identification record (e.g., customer description, facility name and address, account number, billing period), at least one analysis of utility usage data from the at least one previous billing period, and at least one marketing message with at least one indication of utility usage data based at least in part on at least one billing period of the plurality of previous billing periods. The marketing message may be related to external (e.g., customizable by the email report sponsor) or internal (e.g., related to the announcement or cross selling of complementary products) marketing. Among other advantageous attributes, the method delivers relevant utility usage information analysis in a straightforward and efficient manner without requiring the user or customer to remember passwords or login names required for a website.

The various sections of the pushed email need not be homogeneous. Stated otherwise, the analysis section may be spread throughout the email message and be interspersed with customer identification records, marketing messages, and the like. The analysis section of the email message may itself include various sub-sections each of which may include a comparison of utility usage information from a most recent bill to utility usage information from older bills. For instance, one sub-section may break down the current bill into power, energy and total cost areas and compare the current values to the same time period of the two previous years by value and percentage. Another sub-section may compare the current bill to similar facilities in the same state, the same region and nationally for the same period of time. This comparison may be made utilizing data only from other customers that want to participate, and the data may be structured such that no customer can see the data from any other customer. Numerous other types of analytical sections are envisioned as being usable or includable with the pushed email message. As an example, sections may be devoted to temperature analysis and comparison (e.g., number of days at the facility between 70 and 80 degrees Fahrenheit, number of days between 0 and 10 degrees Fahrenheit), cancellation instructions, help instructions and the like.

In some arrangements, each of the various regions may include an identifying aspect (e.g., distinct color, shading, pattern) to differentiate each region from other regions (e.g., navigation buttons from analysis area). Hyperlinks may be included in the email message at strategic locations to assist the reader with interpreting the message and/or gaining additional information regarding billing or utility usage in general. For instance, the marketing message sections may include hyperlinks operable to send the user to the website of the advertisement sponsor, and the help or cancellation sections may include hyperlinks operable to automatically create an email message directed to an appropriate support team. In other scenarios, the email message may include additional charting and analysis in the form of PDF attachments or even PDF files embedded into the email message. As an example, the email message may include a line graph of total utility usage cost over the past year in month increments with the high and low historical range of total utility usage cost for each month being illustrated as a shaded or patterned area over the line graph. Similar graphical depictions may be illustrated for energy consumption, power demand, billing days, cost/day, and the like. The email messages may be delivered in plain-text or HTML, for instance, and may include all of the most current utility usage information available. In this regard, decision makers need not access a website and can quickly scan the email message to understand relevant utility usage information, environmental information and the like.

The various utility usage data described herein may also be indicated or marked (e.g., shading, patterning, color-coding) in such a way as to provide an indication to a user that a particular piece of data needs attention, needs to be watched or is normal (e.g., ok). Logic associated with the server system may be operable to systematically process one or more pieces of utility usage data included in the email message or in the spreadsheet attachment. Each piece of data may, for instance, be associated with a red-yellow-green color-coding scheme (e.g., stop light color-coding scheme) to indicate whether and what type of action a particular piece of data requires. The logic may consider various inputs and the result of the logic may determine whether each piece of data is to be colored red (needs attention), yellow (needs to be watched) or green (is ok).

In one aspect, a system for analyzing utility usage data of at least one end user is provided. The system includes a computing device including a memory module, a first quantity of utility usage data that is stored in the memory module of the computing device, a processor on the computing device that is operable to provide an analysis of the utility usage data, a display module that is operable to provide an indication of the analysis of the utility usage data, and an executable program (e.g., an attention protocol) stored on the memory module that instructs the processor to modify the indication based at least in part on whether first and second inputs to the executable program are true or false. In one arrangement, the indication may be associated with a first color if the first and second inputs are true. For instance, the indication may be associated with a second color if the first and second inputs are false, the first and second colors being different. As another example, the indication may be associated with a second color if either the first and second input is false and the other of the first and second inputs is true, the first and second colors being different. In another arrangement, the first quantity of utility usage data may be associated with a current billing period. For instance, the first input may be true if the utility usage data is within a predetermined percentile of utility usage data from a previous time period (e.g., previous 13 months of data), and second input may be true if the utility usage data is greater than utility usage data from the same billing period from a previous year. In one scenario, the second input may be true if the utility usage data is greater than utility usage data from the same billing period from a previous year by a predetermined percentage (e.g., 80%).

Utility usage information in the systems and arrangements disclosed herein may be collected, stored and transferred in a variety of manners. In some embodiments, customer sites may be equipped with special meters (e.g., electric) such as interval data recorders (IDRs). Such IDRs typically measure and record utility usage information for discrete intervals (e.g., fifteen minutes). The server system may acquire the interval information in real-time or else after appropriate time periods (e.g., fifteen minutes, daily, monthly). Some IDRs may be interrogated by phone (e.g., by the utility or third parties that are granted permission) while others may be interrogated by way of any appropriate high speed communication network.

In one aspect, a method for use with utility usage data is provided that involves communicating with a plurality of utility usage recording devices, receiving utility usage data from each of the plurality of utility usage recording devices in a gateway device, storing the utility usage data of each of the plurality of utility usage recording devices in the gateway device, and sending the utility usage data of at least one of the plurality of utility usage recording devices to a server system, the server system being operable to manipulate the utility usage data for at least one end user. As will be appreciated, the gateway device receives and stores utility usage data for a plurality of recording devices which can be conveniently sent to the server system for subsequent processing, storage, and/or usage. As such, in some instances, the server system need not individually contact each recording device to obtain utility usage information.

In one arrangement, the communicating step further includes calling each of the plurality of utility usage recording devices. For instance, the calling may include establishing a connection with each of the plurality of utility usage recording devices over at least one telephone or other appropriate line. As another example, the calling may include establishing a connection with a different of the plurality of utility usage recording devices after each quantity of a predetermined period of time (e.g., one minute, five minutes, one hour). In another arrangement, the sending step further comprises utilizing file transfer protocol. The sending may occur multiple times per day (e.g., each hour, every 2 hours).

In other embodiments, the IDRs provided at the customer sites may measure and record pulsed outputs. Each pulse output may represent, for instance, a certain quantity of energy (e.g., kWh) per pulse. Such pulses can be appropriately counted, aggregated and logged and eventually forwarded to the server system for storage and/or transport to end users in various manners.

As IDRs may sometimes be supplied to larger entities, small and mid-size consumers may be equipped with other types of devices that allow such consumers to view and analyze their utility usage information in real-time or else in any desired intervals. In some embodiments, consumers or users can be equipped with a “shadow meter” (e.g., a current transducer) that may function in parallel with the consumers existing utility meter. Such shadow meters can measure and record amperage and voltage signals which may be converted to utility pulses (e.g., energy pulses in kWh) by any appropriate transducers. Again, such pulses may be counted, aggregated and logged and eventually forwarded to the server system for storage and/or transport to end users in various manners. Other types of devices (e.g., meters, recording devices) may be utilized with the disclosed method for measuring and recording various types of utility usage information.

As part of the acquisition process by the server system and after measuring and recording by the devices disclosed herein, the utility usage information may be appropriately stored in one or more of various types of storage or memory devices that may exist at intermediate server devices or else at the server system. In some embodiments, each utility supplier may include a database either located at the utility provider itself, at the consumer's facility, or else at other locations to record the utility usage information. In other embodiments, third parties may administer databases in any of various forms for storing and managing the utility usage information. In any event, the utility usage information may be made available to the server system by way of websites that have access to the storage devices (e.g., databases). The server system may be required to login to such websites on behalf of the user or customer with appropriate user information (e.g., login, password) to access such usage information. In some situations, the websites may be run or administered by the utility suppliers while in other situations the websites may be run by third parties (e.g., FTP sites). The utility usage information may also be made available to the server system in real time or substantially real time by way of pulse logging devices or power meters capable of transmitting the collected and aggregated usage information to the server system at intervals of various dimensions.

Other types of technology can be used in the method disclosed herein as part of the acquisition process by the server system. For instance, technologies such as handheld, mobile and network technologies based on telephony platforms (wired and wireless), radio frequency (RF), and power line transmission technologies can also be utilized. Fixed networks may be permanently installed to capture meter readings and may consist of any appropriate series of antennas, towers, collectors, repeaters, or other permanently installed infrastructure to collect transmissions of meter readings from meters and transmit the usage data to the server system without requiring a person in the field to collect the data.

In some embodiments disclosed herein, the utility usage information may be processed through any appropriate quality control procedure before being transmitted to the server system as usage data is often voluminous and prone to error. Some quality control procedures may be customized for each utility and may include steps such as checking for overdue data, customer validation, long or short billing periods, and the like. For instance, a gated quality control process may be used in which a predetermined set of conditions, when established, permits a second process to occur.

In some arrangements, the step of using the server system to acquire the utility usage data includes obtaining or otherwise receiving predetermined intervals of utility usage data, each predetermined interval of utility usage data comprising a first quantity of energy information collected over a first time period. For instance, the first quantity of energy information may include a plurality of energy pulses each including a second quantity of energy information. As an additional example, the obtaining step may include acquiring each predetermined interval of utility usage data at the end of each first time period.

The server system of the methods and systems disclosed herein may include any appropriate number of servers or other computing devices to receive, store and/or transmit utility usage information. For instance, the server system may include a central data server responsible for, among other items, providing a central location and/or database for storing utility usage data according to customer, location, date, and the like, and transmitting such data to other applications, servers and even end users and clients. The server system may also include a “real-time”, “inbox” or “email”, and/or “marketing” servers. The real-time server may be operable to receive substantially real-time data (e.g., pulsed) after any appropriate incremental time, pass such data to the central data server, and generate real-time or substantially real-time alerts regarding such utility usage information to entities such as customers and utility suppliers.

In one aspect a method for providing utility usage data to at least one end user is provided that includes using a server system (e.g., central data server, real-time server) to acquire utility usage data related to at least one utility consumer, determining, using a processor of the server system, whether the utility usage data has exceeded a pre-determined threshold level, and sending an alert message to the at least one end user responsive to determining that the utility usage data has exceeded the pre-determined threshold level. This method may advantageously inform building engineers, plant managers, and the like that one or more types of utility usage may need attention. Various arrangements contemplate that the sending may occur in time immediately after the determining step, the alert message may include a text message, and/or the using step may include obtaining predetermined intervals of utility usage data, each predetermined interval of utility usage data including a first quantity of utility usage information collected over a first time period (e.g., 5 minutes, 15 minutes). In one variation, the first quantity of energy information includes a plurality of energy pulses (e.g., fractions of seconds) each of which includes a second quantity of energy information. In another variation, the obtaining step includes acquiring each predetermined interval of utility usage data at the end of each first time period.

The inbox server may be operable to receive utility usage information from the central data server and transmit (e.g., via email) such information either alone or in combination with appropriate analysis applications to customers and other users for efficient analysis of utility usage. In one embodiment, the inbox server may be responsible for creating the aforementioned HTML page upon receipt of new utility usage data and transmitting a message to a user regarding such new data. The inbox server may also be responsible for attaching one or more spreadsheets to one or more messages that may be operable to analyze such data as previously discussed.

The marketing server may be responsible for targeting advertisements to customers and other users. For example, the marketing server may be responsible at least in part for the creation and/or selection of advertisements and other messaging customized for a specific user or users and may transmit such advertisements to customers in any appropriate manner (e.g., incorporating such advertisements into the transmission of the utility usage information to the end user, incorporating such advertisements into products or programs sent or pushed to end users). Other types of servers or other appropriate computing devices are contemplated as being part of the server system to facilitate such acquisition, storage and transmission of utility usage information.

Also disclosed herein are desktop and mobile modules operable on various types of user or customer computing devices (e.g., local computers, mobile devices) and platforms (e.g., Windows, Linux) that are capable of automatically downloading utility usage information (e.g., billing, interval) and program and product updates from the server system. At least some of such automatically downloaded information may be the most current utility usage information and program updates retrieved by the server system. Such information and program updates can then be stored locally on the user's computing device. As a result, for instance, the local client or computing device may advantageously be used for utility usage data analysis and charting instead of a remote server system to provide enhanced performance. In some embodiments, the user may be required to initially enter login credentials before the modules may be operable to retrieve information and updates. The desktop and mobile modules may also be operable to generate user customizable alerts based on the utility usage information. In some arrangements, the modules may be able to create “pop-up” messages on the desktop or other platform of the user's computing device (e.g., similar to the envelope icon used with Microsoft Outlook®) when new utility usage data has been received, a program update has been received, a power outage has occurred at a particular facility, power demand has exceeded a preset limit at a particular facility, etc. The user may be able to click on or otherwise manipulate the pop-up message to acquire additional information regarding the alert and/or take additional action regarding the alert. For instance, the user may be able to choose to download the newly available utility usage information or else postpone such download until a future time. As an additional example, the user may be able to choose to send an email or text message (e.g., SMS message) to any of a number of parties in a user customizable list of parties (e.g., facility manager) regarding power demand exceeding a preset limit at a particular facility by clicking the party's name in the list.

According to another aspect, a method of retrieving utility usage data for analysis is disclosed herein. The method includes providing a computing device that is in communication with a data synchronization module, the computing device including at least one storage module and at least one utility usage analysis tool. The computing device may be operated to retrieve utility usage data from a storage module of a server system using the data synchronization module, and the utility usage data may be stored in the memory module of the computing device. Moreover, the utility usage analysis tool may be run to analyze the utility usage data. The data synchronization module may be generally thought of as a communication bridge between the server system and a computing device of the end user or customer. As such, the above-described desktop and mobile retrieval modules may work in conjunction with the data synchronization module to obtain and process utility usage information.

In some arrangements, the data synchronization module may allow the customer or applications being operated by the customer to function as an occasionally connected internet client or to otherwise engage in occasionally connected computing (OCC). In this regard, data (e.g., utility usage information) retrieved by the data synchronization module may be utilized by the utility usage analysis tool even when the user is not connected to a network or the internet. The data synchronization module may retrieve the utility usage data at any appropriate time (e.g., according to a predetermined schedule, in response to transmission initiation by a user). In other arrangements, the utility usage information may be “sliced and diced” (e.g., parsed) either as part of the retrieval of the utility usage information from the server system by the data synchronization module or else after such retrieval. For instance, thirty days of energy and gas usage information may be allocated proportionately across a number of intervals. Such allocation may create a more accurate financial depiction of utility changes as operational demands may vary on various facilities based on weekends, holidays, special events, production schedules, and the like.

According to another aspect, a system for analyzing utility usage data of at least one end user is disclosed herein. The system includes a computing device including a memory module, a first quantity of utility usage data that is stored in the memory module of the computing device, a processor on the computing device that is operable to provide an analysis of the utility usage data, and a display module that is operable to provide an indication of the analysis of the utility usage data. The indication includes a number of regions each of which may be at least generally related to an analysis of the first quantity or other quantities of utility usage data. One region of the indication may include a plurality of navigation buttons or other appropriate user manipulable features that are operable to be manipulated by a user (e.g., by mouse, stylus, finger), each of the navigation buttons providing access to a tool that is operable to analyze utility usage data. For instance, one of the navigation buttons may provide access to an estimation tool allowing a customer to estimate future utility usage quantities and costs while another of the buttons may provide access to a comparison tool allowing the customer to compare various customizable time periods. Other types of tools are envisioned.

A second region of the indication may be operable to provide a display of the analysis of the utility usage data upon manipulation of at least one of the navigation buttons by the user. Stated otherwise, once the user clicks on the “comparison” button, the second region would provide a readout of the comparison. The second region may also include user interactive portions allowing the user to modify time periods, change rates, click on particular graphical portions for additional information, etc. Other regions of the indication may provide various other functions such as providing an indication of a summary of at least a portion of the analysis of the utility usage data from the second region, displaying a marketing message targeted to the user, and the like. Each of the various regions may include an identifying aspect (e.g., distinct color, shading, pattern) to differentiate each region from other regions (e.g., navigation buttons from analysis area). In some arrangements, the first quantity of utility usage data may include at least one of energy usage data, power demand data, natural gas usage data, environmental costs and total costs.

In some arrangements, the display module may be operable to provide first utility usage data from a number of time periods of a first year generally adjacent to the first utility usage data from a number of time periods of a second year, and/or provide a display of a first type of utility usage data over a plurality of time periods. In one variation, the indication includes another user manipulable feature that is operable to modify the display of the analysis of the utility usage data. For instance, the another user manipulable feature (e.g., slide bar) may be operable to selectively adjust the number of time periods displayed in the plurality of time periods. In other setups, the another user manipulable feature may be operable to selectively adjust the number of time periods utilized in the analysis of the utility usage data. In another variation, each of the plurality of time periods may be selected from the group of days, weeks, months and years.

In another arrangement, the second region may be operable to provide a display of first and second types of utility usage data over a plurality of time periods, the first and second types of utility usage data being different. In one variation, the output of the first type of utility usage data may be associated with a first color and the output of the second type of utility usage data may be associated with a second color. Other manners of distinguishing between different types of utility usage data in the second region are also contemplated. For instance, the second region may include a first axis with utility usage information related to the first type of utility usage data and a second axis with utility usage information related to the second type of utility usage data. In one variation, the first axis may be associated with the first color and the second axis may be associated with the second color.

The indication may include additional regions. For instance, a third region may be operable to provide an indication of a summary of at least a portion of the analysis of the utility usage data from the second region, and a fourth region may be operable to display a marketing message targeted to the user. The marketing server may be operable to manage the selection of a marketing message or advertisement in one or more of the regions of the indication.

In an even further arrangement, the display may include a plurality of graphical inputs and at least one graphical output. Such an arrangement may provide a user with a more complete understanding of how various components of a utility bill (e.g., utility usage, taxes, total cost) are determined. The display may also include a plurality of graphical intermediate values. For instance, at least one of the user manipulable features may include another user manipulable feature (e.g., hyperlink) that is operable to provide access to another indication of an analysis of the utility usage data. The another indication may include at least one graphical representation of at least one of the plurality of graphical inputs or at least one of the graphical intermediate values. In one variation, the at least one graphical representation of at least one of the plurality of graphical inputs or at least one of the graphical intermediate values may include a further user manipulable feature (e.g., hyperlink) that is operable to provide access to a further indication of an analysis of the at least one graphical representation of at least one of the plurality of graphical inputs or at least one of the graphical intermediate values. In other variations, the display may include at least one graphical operator that is operable to provide a visual indication of a mathematical relationship between at least one of the plurality of graphical inputs and another of the plurality of graphical inputs and/or the at least one graphical output may be associated with one of the user manipulable features.

It will be appreciated that the aforementioned system for analyzing utility usage data may be seamlessly integrated with other embodiments, systems and method disclosed herein. For example, the desktop and mobile modules may be operable to work in conjunction with the processor of the computer device to automatically update the regions on the display module when the computing device acquires new utility usage information. As an additional example, when the user or other device or module appropriately instructs the processor to provide the analysis of the utility usage data and the display module to correspondingly provide an indication of such analysis, the processor may utilize the most current utility usage information.

It will also be appreciated that all of the analysis tools, displays, various spreadsheets and systems disclosed herein may be implemented utilizing any appropriate module, logic, executable program, etc. Each respective piece of logic may be of any appropriate form and/or configuration, and may be, for instance software, hardware, firmware, and any combination thereof. It will be appreciated that the modules, logic, programs, etc. may be operable to instruct one or more microprocessors to perform one or more steps to carry out the functionalities disclosed herein. Moreover, all of such analysis tools and displays and various spreadsheets may be run, utilized or accessed by way of the desktop or mobile modules or by way of the body of an email message or an attachment thereof.

### BRIEF DESCRIPTION OF THE DRAWINGS

FIG. 1 illustrates a general overview of the distributing processing system according to one embodiment.

FIG. 2 illustrates a computing system architecture usable with the distributed processing system of FIG. 1.

FIG. 3 illustrates a general block diagram of an interval and billing data acquisition process.

FIG. 4a illustrates a more detailed block diagram view of the interval data acquisition process of the distributed processing system of FIG. 1.

FIG. 4b illustrates a gateway device that may be included with the distributed processing system to collect utility usage information from a plurality of utility meters.

FIG. 5 illustrates a user interface that may be used in conjunction with a UIDS gated quality control process.

FIG. 6 illustrates a user interface that may be used in conjunction with a UBDS gated quality control process.

FIG. 7 illustrates an alert text message that may be generated by a real-time server.

FIG. 8a illustrates a graph of energy consumption versus time in months.

FIG. 8b illustrates a graph of energy consumption versus time in days.

FIG. 9 illustrates one view of an overview screen of one embodiment of a user interface of an analyzer module.

FIG. 10 illustrates another view of the overview screen of FIG. 9.

FIG. 11 illustrates an estimator screen of the analyzer module of FIG. 9.

FIG. 12 illustrates a forecaster screen of the analyzer module of FIG. 9.

FIG. 13 illustrates a validator screen of the analyzer module of FIG. 9.

FIG. 14 illustrates a normalizer screen of the analyzer module of FIG. 9

FIG. 15 illustrates a comparison screen of the analyzer module of FIG. 9.

FIG. 16 illustrates an environment screen of the analyzer module of FIG. 9.

FIG. 17 illustrates one embodiment of a user interface of a report module.

FIG. 18 further illustrates the embodiment of FIG. 17.

FIG. 19 illustrates another embodiment of a user interface of the report module of FIG. 17.

FIG. 20 further illustrates the embodiment of FIG. 19.

FIG. 21a illustrates a chart of total cost versus time.

FIG. 21b illustrates a chart of energy consumption versus time.

FIG. 22a illustrates a chart of days per billing period versus time.

FIG. 22b illustrates a chart of cost per day versus time.

FIG. 23a illustrates a chart of power cost validation versus time.

FIG. 23b illustrates a chart of energy cost validation versus time.

FIG. 24a illustrates a chart of heating degree days versus time.

FIG. 24b illustrates a chart of cooling degree days versus time.

FIG. 25a illustrates a chart of average temperature versus time.

FIG. 25b illustrates a chart of total precipitation versus time.

FIG. 26 illustrates FIG. 17 in a color-coded format to show the source of data.

FIG. 27 further illustrates another view of FIG. 26.

FIG. 28 illustrates a data flow from the central data server to a spreadsheet

FIG. 29 illustrates a monthly e-mail report screen that may be sent to a user with a spreadsheet attachment.

FIG. 30 illustrates a splash page that may be presented on a user's display screen while an attachment is downloading.

FIG. 31 illustrates the overview screen of the user interface of a monthly spreadsheet report attachment.

FIG. 32 illustrates an estimator screen of the monthly spreadsheet report attachment of FIG. 31.

FIG. 33 illustrates a comparison screen of the monthly spreadsheet report attachment of FIG. 31.

FIG. 34 illustrates a year screen of the monthly spreadsheet report attachment of FIG. 31.

FIG. 35 illustrates a month screen of the monthly spreadsheet report attachment of FIG. 31.

FIG. 36 illustrates a week screen of the monthly spreadsheet report attachment of FIG. 31.

FIG. 37 illustrates a day screen of the monthly spreadsheet report attachment of FIG. 31.

FIG. 38 illustrates a data screen of the monthly spreadsheet report attachment of FIG. 31.

FIG. 39 illustrates a daily e-mail report screen that may be sent to a user with a spreadsheet attachment.

FIG. 40 illustrates a month to date chart screen of a user interface of a daily spreadsheet report attachment.

FIG. 41 illustrates a daily load profile screen of the daily spreadsheet report attachment of FIG. 40.

FIG. 42 illustrates a peak control profile screen of the daily spreadsheet report attachment of FIG. 40

FIG. 43 illustrates a text message that may be sent in parallel to the meter module spreadsheet report attachments.

FIG. 44 illustrates another text message that may be sent in parallel to the meter module spreadsheet report attachments.

FIG. 45 illustrates an e-mail report screen that may be generated by a bill module.

FIG. 46 illustrates an additional region that may be included with the e-mail report screen of FIG. 45.

FIG. 47 illustrates an additional region that may be included with the e-mail report screen of FIG. 45.

FIG. 48 illustrates a total cost screen of a user interface of a bill module spreadsheet report attachment.

FIG. 49 illustrates a total energy screen of the bill module spreadsheet report attachment of FIG. 48.

FIG. 50 illustrates an operations screen of the bill module spreadsheet report attachment of FIG. 48.

FIG. 51 illustrates a weather screen of the bill module spreadsheet report attachment of FIG. 48.

FIG. 52 illustrates an environment screen of the bill module spreadsheet report attachment of FIG. 48.

FIG. 53 illustrates a total cost overview screen of the bill module spreadsheet report attachment of FIG. 48.

FIG. 54 illustrates a total cost trend screen of the bill module spreadsheet report attachment of FIG. 48.

### DETAILED DESCRIPTION

Reference will now be made to the accompanying drawings, which assist in illustrating the various pertinent features of the present invention. Although the invention will now be discussed primarily in conjunction with a distributing processing or management system for delivering utility usage information (e.g., utility consumption and demand information) to consumers and other entities, it should be expressly understood that the invention is applicable to the receipt, delivery and use (e.g., analytical use) of other types of data and information and other settings. In this regard, the following description of system and methods for acquiring and delivering utility usage information to end users for storage and use is presented for purposes of illustration and is not intended to limit the invention to the form or applications disclosed herein. Consequently, variations and modifications consummate with the following teachings, and skill and knowledge of the relevant art, are within the scope of the present invention.

### System Overview:

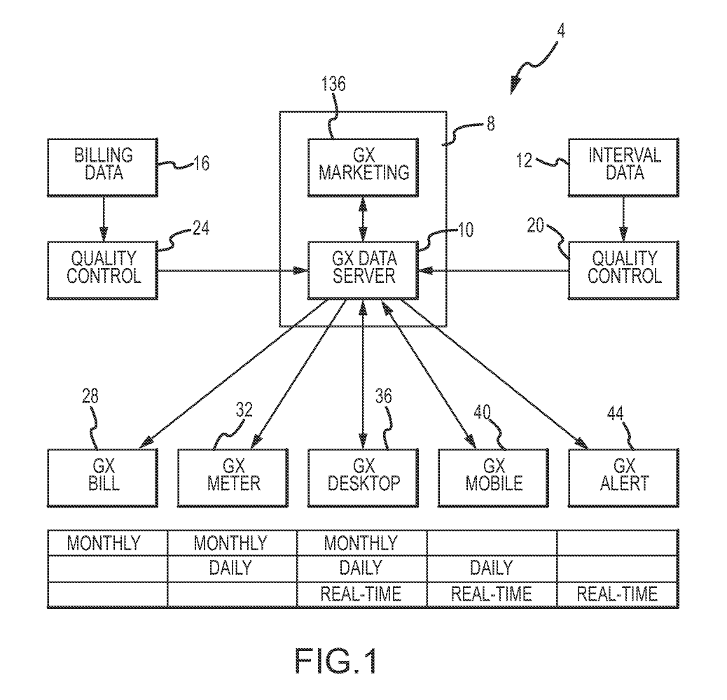

FIG. 1 illustrates a general overview of one embodiment of a distributing processing system 4 disclosed herein. A server system 8 may be at the heart of the distributed processing system 4 and may broadly be responsible for acquiring, storing, processing and transmitting utility usage information in various formats (e.g., raw, structured) and with various applications (e.g., programs) in various manners (e.g., email, web queries) to end users (e.g., computing devices) or other entities. The server system 8 may include any number of computing devices (e.g., servers) that may be appropriately linked (e.g., by networks) to implement the various functionalities described herein. For instance, the server system 8 may include a central data server 10 that may provide a central storage location or database for utility usage information and may appropriately process and transmit such utility usage information to other applications, servers and entities. The server system 8 may also include a marketing server 136 that may assist the central data server 10 in targeting advertisements to customers and other end users. The central data server 10 and the marketing server 136 in addition to other computing devices and servers usable with the server system 8 will be described in more detail below. In some embodiments, all the functionality of the various servers may be embodied within a single server device.

The server system 8 may be operable to acquire and process interval utility usage data 12 and billing utility usage data 16 although it is contemplated that the distributing processing system 4 may manage myriad other types of data and information. Broadly, interval data 12 may be thought of as discrete intervals (e.g., pulses, 15 minute intervals) of energy consumption (e.g., kWh), water consumption (e.g., gallons), and the like that may be collected and stored in the server system 4. Billing data 16 may be thought of as billing information submitted by a customer after receiving their bill or else collected and stored in the server system 4. In any case, the interval and billing data 12, 16 may be “cleaned” or otherwise scanned for errors by way of any appropriate quality control process before being received, stored and processed by the server system 4. The quality control processes may be performed by the server system 8 and may be operable to check for overdue (e.g., late) data, corrupt data and/or whether a total utility consumption usage has exceeded some predetermined limit, for instance. As an example, the interval data 12 may be appropriately processed through a utility interval data server (UIDS) gated quality control process 20 and the billing data may be appropriately processed through a utility billing data server (UBDS) gated quality control process 24.

The distributed processing system 4 may also include one or more applications or modules each of which may be operable to acquire and use utility usage information and other programs received, processed and/or generated by the server system 8 to facilitate efficient transfer of utility usage information to end users in easy to use formats and with inventive analytical tools to enable such end users to more appropriately exploit their utility usage. For instance, the distributed processing system 4 may include a Bill module 28 and/or a Meter module 32. The Bill module 28 may work in conjunction with the server system 8 to transmit (e.g., via email) billing data reports to customers on a regular (e.g., monthly) basis. The billing data reports may be delivered as spreadsheets built with any appropriate tool (e.g., Microsoft Excel), and may be designed for enterprise users with multiple meters for instance. The Meter module 32 may also function with the server system 8 to transmit interval data reports to customers in any appropriate time periods (e.g., monthly, daily). The reports may be delivered as spreadsheets and may include any number of billing periods of data per report (e.g., up to 18 billing periods and beyond).

The distributed processing system 4 may also include a Desktop module 36 and/or a Mobile module 40. The Desktop module 36 may work with the server system 8 to integrate billing and interval data in one or more desktop platforms (e.g., Windows, Mac, Linux). The Desktop module 36 may also be designed to update utility usage data from the server system 8 so the Desktop module 36 may be utilized off-line if an Internet connection is unavailable. The Mobile module 40 may be similar to the Desktop module 36 except it may be designed to work in cross-platform mobile environments including but not limited to Windows, Blackberry and iPhone. The Alert module 44 may be operable to create alert messages for customers and other entities. For instance, the server system 8 may be operable to generate a message (e.g., text, SMS, instant) when power demand at a particular facility has exceeded a threshold level previously set by the customer to inform the customer of the situation. Numerous other types of modules, programs and applications may be usable with the server system 8 and/or as part of the distributed processing system 4 as will be described in more detail below.

### Computing System Architecture:

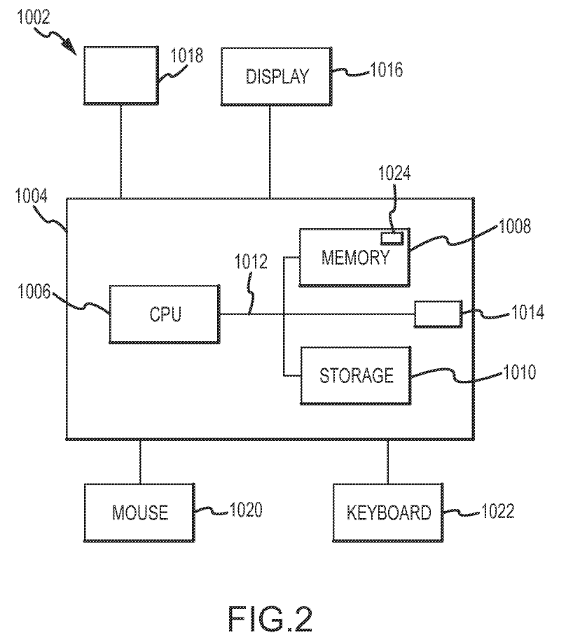

Before discussing and describing more specific features and elements of the distributed processing system 4, it may be useful to describe a representative computing system 1002 (e.g., desktop, laptop, mobile device, server) useable with any of the embodiments of the distributed processing system 4 described herein. FIG. 2 illustrates a block diagram of one architecture of such a computing system 1002.

The computing system 1002 may include a computing device 1004 which may be generally programmable and may include a processor (e.g., central processing unit) 1006 and a computer memory 1008 (e.g., RAM). The computer memory 1008 stores data and instructions and the processor 1006 executes instructions and processes data from the computer memory 1008. The processor 1006 may retrieve instructions and other data from storage device 1010 (e.g., hard drive, storage module) before loading such instructions and other data into the computer memory 1008. The processor 1006, computer memory 1008 and storage device 1010 may be connected by a bus 1012 in a conventional manner.

The computing device 1004 may include at least one computer communications interface 1014 which may be in the form of a Universal Serial Bus (USB) compliant port. The USB is a known standard for interconnection between various electronic devices. In other embodiments, the computer communications interface 1014 may also include serial ports, parallel ports, PS/2 ports or other interfaces suitable for connecting electronic devices to the computer. Further, the computer communications interface 1014 need not be a physical connection interface; it may be, for example, a BLUETOOTH interface, infrared or laser communication interface. Computer communications interface 1014 may also be connected to the processor 1006.

The computing system 1002 may also include one or more peripheral devices. For instance, the system 1002 may include a graphical user interface 1016 or GUI (e.g., display screen, LCD) and speakers 1018 for presenting content to the user. If the computer 1004 is a portable computing device, the GUI 1016 and speakers 1018 may be smaller or even integrated into each other. In some embodiments, the computing device 1004 may include a screen only (such as the case with most PDA's). The computing device 1004 should include or be connected to at least one interface for presenting content to a user as sensory data (e.g., sound, visuals, or both). Moreover, the computing system 1002 may include a mouse 1020 (e.g. wired, wireless) and/or a keyboard 1022 and/or a stylus (not shown) for allowing a user to interact with the computing system 1002 and/or cause the display of images on the GUI 1016. Furthermore, the computing device 1004 may also include many additional components, a network card for connecting the computing device 1004 to one or more networks, a CD drive, a DVD drive, a power supply, a mother board, video and sound controllers, etc. Such components have been omitted for the sake of brevity.

The computer memory 1008 may further include any appropriate operating system 1024 to manage the execution of programs as well as various input/output functions. The operating system 1024 may be one of the currently available operating systems, such as WINDOWS XP offered by Microsoft Corp., LINUX offered by various distributors, including Red Hat, Inc., or OS X offered by Apple Computer. The operating system 1024 may also be an operating system suited for portable or embedded computing devices, such as PALM OS offered by PalmSource, Inc.

The architecture of the computing system 1002 may be used in part or in whole for any of the various components (e.g., desktop and laptop computers, mobile devices, server) of the distributed processing system 4 disclosed herein.

### Data Acquisition:

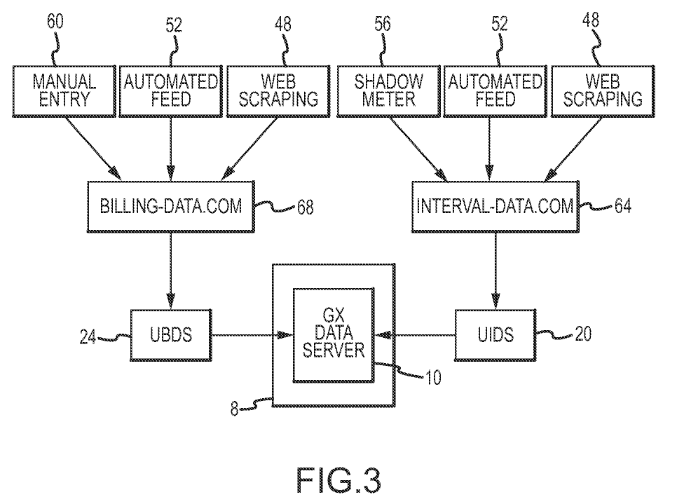

FIG. 3 presents a general a general block diagram of the interval and billing data acquisition process. The distributed processing system 4 may utilize numerous devices and processes to acquire utility usage information (e.g., interval, billing) from customer facilities and locations to be eventually transmitted or otherwise communicated to the server system 8. For instance, a “web scraping” process 48 may be utilized that allows the server system 8 to poll websites (e.g., a Utility supported website) on behalf of the customer for utility usage information. An “automated feed” process 52 may be used that transfers utility usage information directly from one location or entity (e.g., customer location, utility provider) to the server system 8. In some embodiments, shadow meters 56 may be utilized that serve to detect or otherwise measure pulses of utility output (e.g., energy pulses) at the customer's facility or home which may eventually be logged, counted and passed on to the server system 8. In other embodiments, the utility usage information may be manually provided from the customer to the server system 8 or other location. In any case, once the utility usage information has been collected, in some embodiments it may be made available on secure FTP sites or websites administered or otherwise accessible by the server system 8. As an example, interval data may be made available on “interval-data.com” 64 while billing data may be made available on “billing-data.com” 68. Each of such sites may be in the form of an FTP site or else work in conjunction with an FTP client to allow access to billing and interval data by the server system 8. As previously described, the utility usage information may pass through the UIDS and UBDS quality control processes 20, 24 before eventually being stored by the server system 8.

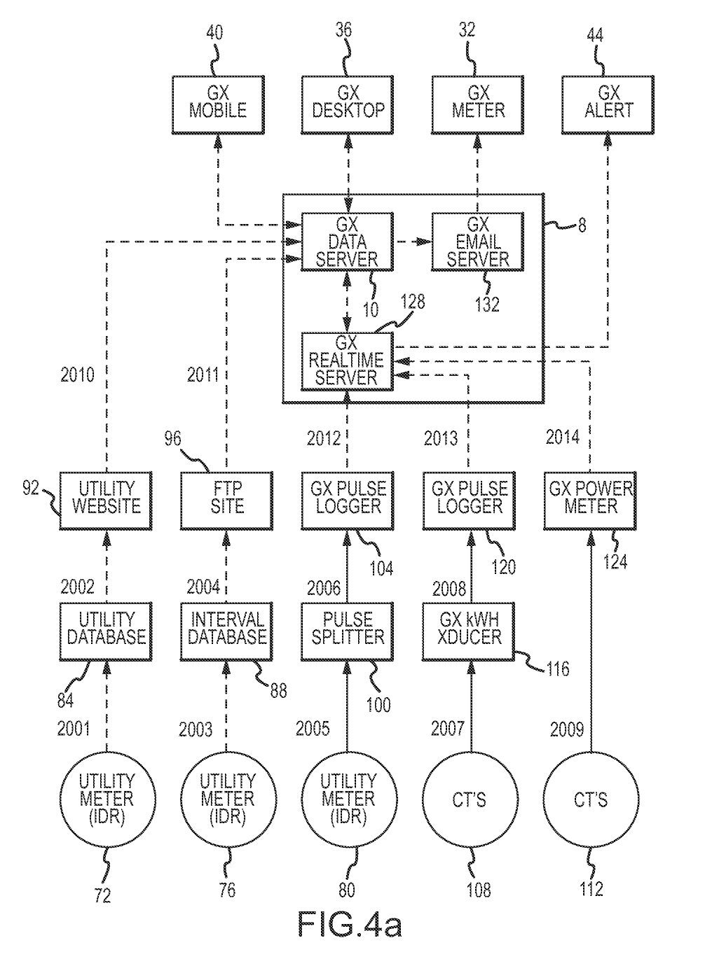

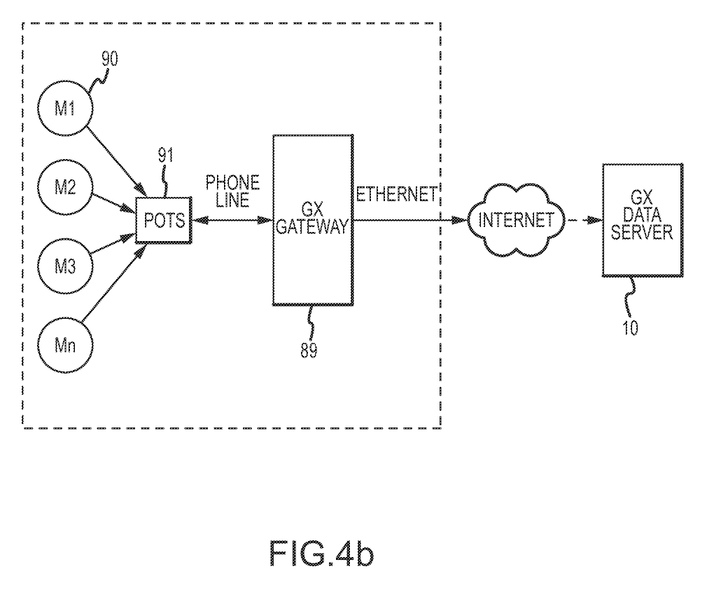

With reference to FIG. 4a, a more detailed block diagram view of the interval data acquisition process of the distributed processing system 4 is illustrated. As previously discussed, the distributed processing system is operable to acquire and process various the information of various types of utilities such as but not limited to electric energy (e.g., kWh, kW), water (e.g., gal), natural gas (e.g., therms), heating oil (e.g., BTUs), etc. The utility usage information may be collected in any appropriate intervals (e.g., minutes, hours, days, months) and can be forwarded or otherwise transmitted to the server system 8 or other intermediate websites and/or locations at the collection intervals or else different intervals. It will be appreciated that any appropriate technologies such as handheld, mobile and network technologies based on telephony platforms (wired and wireless), radio frequency (RF), power line transmission technologies, and/or fixed networks (e.g., Internet, WANs, LANs) may be utilized to capture meter readings and transmit such readings to websites, intermediate locations, the server system 8, and other locations. For instance, any appropriate series of antennas, towers, collectors, repeaters, or other permanently installed infrastructure can collect transmissions of meter readings from meters and transmit the usage data to the server system without requiring a person in the field to collect the data.

One or more utility meters 72, 76, 80 may be appropriately installed at each customer facility in which one or more utilities are being consumed or at least available. For instance, each utility meter 72, 76, 80 may be in the form of an interval data recorder (IDR) which may be any appropriate electric meter (e.g., an IDR manufactured by GE, Siemens) operable to measure and record energy consumption and power demand for various sized intervals (e.g., 5, min, 15 min). The distributed processing system 4 may incorporate numerous manners of transmitting utility usage data (e.g., interval data) from each customer facility to the server system 8. In one arrangement, utility usage data may be manually or automatically collected from the utility meter 72 in any appropriate intervals (e.g., daily, monthly) by the utility provider and appropriately stored in a utility database 84. In another arrangement, utility usage data may be collected from the utility meter 76 by the server system 8 or a third party via using one or more phone lines to “call” a modem of the utility meter 76 and then stored in an interval database 88. This collection process may occur on a daily or any other appropriate basis. For instance, the server system 8 or third party may include one or more servers with one or more modem banks, each of which may be operable to call one or more utility meters. In either arrangement, the utility and/or interval database 84, 88 may be associated with any appropriate computing device (e.g., server) which may be located either at the utility provider facility or else may be administered by one or more third parties.

In any event, utility usage information associated with either the utility or interval database 84, 88 may be made available to customers, utilities and other entities by way of one or more internet sites. For instance, the utility usage information stored in the utility database 84 may be made available via one or more utility provider websites 92. Specifically, customers may gain access to their utility usage information via a utility provider website 92 via any appropriate secure login (e.g., username and password, secure cookie set) as can the server system 8 as will be described below. As another example, utility usage information stored in the interval database 88 may be made available on other appropriate internet sites such as an FTP site 96.

The central data server 10 of the server system 8 or other appropriate devices or entities (e.g., 3^{rd} parties) may automatically poll one or more utility websites 92 or FTP sites 96 on any appropriate basis (e.g., daily) to check for new data. Stated otherwise, the central data server 10 may be operable to only acquire data regarding a particular customer or customer facility that it does not already have stored. In this regard, the server system 8 may avoid the acquisition of duplicate data. For instance, the central data server 10 may poll the one or more utility websites 92 by logging in with each customer's username and password to access their interval data. If new data is available, it may be collected utilizing any appropriate technology (e.g., web scraping), parsed into a structured format, processed through the UDS quality control process 20, and posted to a database associated with the central data server 10 for storage and/or distribution to other end users or features of the distributing processing system 4. As an additional example, the server system 8 may appropriately communicate with FTP site 96 (e.g., via FTP client) to acquire utility usage information. In some situations, the server system 8 may include associated internet sites (e.g., interval-data.com, billing-data.com) that may be operable to store the utility usage data received from the utility website 92 and/or FTP site 96 until such time that the server system 8 is ready to receive the utility usage data.

As illustrated in FIG. 4b, a gateway device 89 may be included with the distributed processing system 4. The gateway device 89 may include any appropriate arrangement of hardware and/or software to collect utility usage information from a plurality of utility meters. For instance, the gateway device 89 may be located at a customer facility and may be operable to call (e.g., via modem) each of a number of utility meters 90 (e.g., utility meters 76) using a communication system 91 (e.g., POTS) to collect utility usage information. Thereafter, the gateway device 89 may temporarily store such utility usage data within a database (not shown) that may be appropriately associated with the gateway device 89. In one arrangement, the gateway device 89 may be operable to call a new utility meter 90 once per minute to acquire data and in this regard may acquire new utility usage data from all associated utility meters 90 once all of such utility meters 90 have been called.

Thereafter, the central data server 10 of the server system 8 may be operable to acquire utility usage data of the plurality of utility meters 90 via the gateway device 89 (or conversely, the gateway device 89 may be operable to transmit such utility usage data to the central data server 10) by way of File Transfer Protocol (FTP). In one arrangement, the gateway device 89 may be associated with the internal database 88 (e.g., encompassed by, in communication with) and the central data server 10 may acquire the utility usage data of the utility meters 90 in manner described above. In another arrangement that may be used in conjunction with or separate from the above arrangement, the gateway device 89 may include any appropriate internal FTP client allowing the gateway device 89 to communicate with and transfer data to the central data server 10. The central data server 10 may acquire current utility usage information from a number of meters via the gateway device 89 at almost any time of the day (e.g., every hour, every 15 minutes). The gateway device 89 may utilize any appropriate IP addressing (e.g., dynamic, static) for communications with the server system 8. The distributed processing system 4 may also include a configuration module (not shown) that may be operable to remotely configure the gateway device 89. For instance, the configuration module may be associated with the server system 8 and may include a modem to communicate (e.g., via calling) with the gateway device 89 to configure any appropriate information (e.g., phone numbers).

In a further arrangement, utilities (e.g., electric) may make pulsed energy information available to their customers. For instance, the utility meter 80 may be appropriately designed to provide pulsed outputs from the utility meter 80 to a pulse splitter device 100. Each pulse may represent a predefined energy measurement by the meter (e.g., kWh/pulse), and as will be appreciated, the utility meter 80 may output many hundreds or even thousands of pulses per interval. The pulse splitter device 100 may serve to divide a pulsed energy signal into multiple signals or reassemble a number of pulsed energy signals into a single pulsed energy signal. In any case, the pulse splitter device 100 may then forward or otherwise appropriate transmit each pulse or set of pulses to a pulse logger 104. The pulse logger 104 may serve numerous functions, such as counting and aggregating the total number of pulses for a predefined interval (e.g., 15 minutes) or mini-interval (e.g. 5 minutes), logging the number of pulses for each interval for up to a predetermined time period (e.g., two months) in case of communication loss and/or data compromise, transmitting the number of pulses per interval to a real-time server (described in more detail below) of the server system 8 at the end of each interval (e.g., 15 minutes) or mini-interval (e.g., 5 minutes), and synchronizing with a time source (e.g., atomic clock) every appropriate time period (e.g., every hour) via, for instance, Internet time servers (e.g., SNTP). In some arrangements, the pulse logger 104 may transmit the counted and aggregated pulsed energy data to any appropriate website or other site (e.g., FTP site) for customer access.

In addition or as an alternative to the previously described utility meters 72, 76, 80, one or more current transducers 108, 112 (e.g., “shadow meters”) may be installed at each customer facility in which one or more utilities are being consumed or at least available. For instance, each current transducer 108, 112 may be installed in parallel with the on-site utility meter or for monitoring specific circuits (e.g., sub-metering) to measure amperage. The amperage signals along with voltage signals from the corresponding phases may be connected to a transducer 116 to generate pulses for each unit of energy (kWh). The generated pulses from the transducer 116 may be connected to a pulse logger 120, which may be the same as or different than the pulse logger 104, and which may perform at least similar functions to the pulse logger 104. Thus, the counted and aggregated pulsed data may be appropriately forwarded to the server system 8 (e.g., the below described real-time server) or else a website or FTP site.

In another arrangement, amperage and voltage signals may be measured by the current transducer 112 and may be appropriately transmitted to a Power meter 124. The Power meter 124 may be operable to measure and record various types of information instantaneously, every mini-interval (e.g., 5 minutes), every interval (e.g., 5 minutes), etc. For instance, the Power meter 124 may be operable to measure and record a) kW, kWh, kVARh, voltage, current, power factor, VA, frequency, and/or b) kWh and kVARh (Delivered, Received, Sum, Net). Furthermore, the Power meter 124 may also be operable to automatically send or otherwise transmit the information to the below described real-time server of the server system 8 at, for instance, every mini-interval or interval in any appropriate format such as XML format.

Described below is a summary of some of the utility usage information (e.g., interval data 12) acquisition process processes or techniques disclosed herein although numerous other techniques are contemplated as being within the scope of the embodiments:

1) “Web Scraping”—See numbers 2001, 2002 and 2010 in FIG. 4.

2) “Utility Meter IDR Polling”—See numbers 2003, 2004 and 2011 in FIG. 4.

3) “Utility Meter Pulses”—See numbers 2005, 2006 and 2012 in FIG. 4.

4) “Shadow Meter Pulses”—See number 2007, 2008 and 2013 in FIG. 4.

5) “Power Meter”—See numbers 2009 and 2014 in FIG. 4.

Other types of utility usage data (e.g., billing data) may be acquired in similar or different manners from those used to acquire interval data 12. For instance, billing data 16 may be acquired by way of web scraping (e.g., allowing the server system 8 to login to a secure customer site on behalf of the customer with login information to check for new billing information) and/or automated data feeds (e.g., automatic data feeds sent from the utility provider to the server system 8 on a regular basis. As an example, the billing data 16 may be uploaded to any appropriate website (e.g., billing-data.com 68) where it may be accessed by the server system 8. Billing data 16 acquired in any appropriate manner may be processed through the UBDS gated quality control process 24 before being stored in a database of the central data server 10.

The inventor recognizes that the technology currently used in some utility usage data communication (e.g., phone lines) may be modified in the coming years or that new standards or protocols may be developed or implemented. However, the inventor believes that the breadth of the description will cover such changes and advances and that the examples used throughout are not meant to limit scope of the inventor's contribution.

### Quality Control:

As discussed briefly above, the interval and billing data 12, 16 may be respectively “cleaned” by way of the utility interval data server (UIDS) gated quality control process 20 and the utility billing data server (UBDS) gated quality control process 24. The UIDS and UBDS gated quality control processes 20, 24 may be customized for each utility and each may be in the form of any appropriate application (e.g., software) with appropriate logic to implement the below described processes. Each application may be run and the data processed either within the server system 8 or else at other locations. Each of the UIDS and UBDS gated quality control processes 20, 24 may include steps such as checking for overdue data, customer validation, multiple meters in one file or multiple files for the same meter, long or short billing periods, number of intervals, total energy validation, statistical validation and/or interval alignment. In some arrangements, data not meeting the requirements of the processes may be submitted to a “trouble ticket” system for tracking and returning the data to the data vendor (e.g., utility provider) for correction.

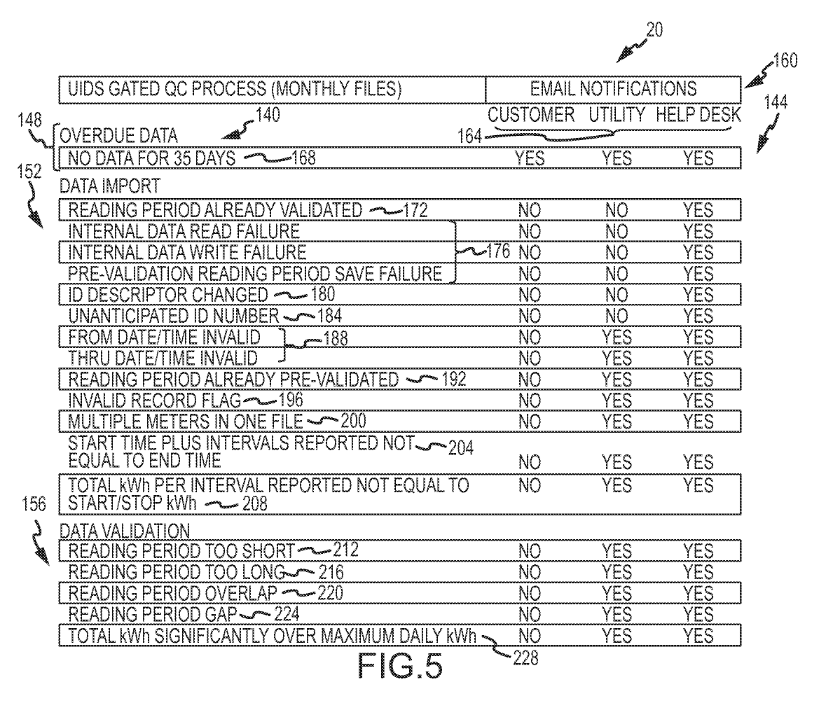

FIG. 5 illustrates a user interface that may be used in conjunction with the UIDS gated quality control process 20. The UIDS gated quality control process 20 may generally operate on interval data 12 received in increments (e.g., monthly basis, daily basis) for overdue data, data import and data validation. The process 20 may comprise one or more gates 140 (e.g., questions) that it performs on one or more inputs (e.g., pieces of interval data) and produces one or more outputs 144 (e.g., “yes,” “no”). The process 20 may include any number of sections such as an overdue data section 148, a data import section 152 and a data validation section 156, each of such sections including one or more gates 140. Moreover, a result of one of the outputs 144 may be any appropriate action 160 (e.g., email notification), and the action may be applied to any appropriate number of entities 164 (e.g., customer, utility, help desk). For example, logic associated with the process 20 or other user inputs may decide whether the action applied to each entity is “yes” or “no”. The overdue data section 148, data import section 152 and data validation section 156 will now be described in turn.

As utilities often read meters approximately once a month, the first gate 168 of the overdue data section 148 may check for new data for one or more customer meters once a day (e.g., may check the server system 8 or other databases or storage devices) and cause the generation of an alert (e.g., via the server system 8) if there has been no new data for a predetermined time period (e.g., just over the past month or 35 days). However, the number of days may be configurable for each data provider (e.g., utility provider, interval database). For instance, those data providers taking part in the distributing processing system 4 may appropriately communicate their billing cycles to the server system 8 or else any location accessible by the process 20. Emails may be sent to the entities 164 (e.g., customer, utility, internal help desk) if the interval data 12 is overdue.

The first gate 172 of the data import section 152 may ensure that the interval data 12 has not already been validated. If the interval data 12 has been validated then the interval data 12 may be rejected and an email may be sent to the internal help desk. The next three gates 176 relate to internal reads and writes to a database on which the interval data 12 is stored at least temporarily located. The help desk may be notified (e.g., via email) if the process 20 or other application detects one or more failures. The next gate 180 may determine if the identification descriptor has changed since the last time the data was received and the internal help desk may be notified if the descriptor has changed. The next gate 184 may determine if the interval data 12 has an ID number that is not in the server system 8 and the internal help desk is notified and the interval data 12 is rejected if this error occurs. The next two gates 188 may determine if the “from” and “through” dates and times are in a valid format. If either of these gates 188 generates an error, the interval data 12 is returned to the utility (e.g., via email) and the internal help desk is notified. The next gate 192 may determine if the meter reading period has already been through the pre-validation process. If this gate 192 generates an error, then the interval data 12 may be returned to the utility and the internal help desk notified. The next gate 196 may determine if an invalid record flag is set in the file. If this gate 196 generates an error, then the data may be returned to the utility and the internal help desk notified. The next gate 200 may determine whether there is data for multiple meters in one file; if so, then this gate 200 may generate an error, the interval data 12 may be returned to the utility, and the internal help desk may be notified. The next gate 204 may determine if the start time in the file header plus the number of intervals in the file equals the end time in the file header. If this gate 204 generates an error, then the interval data 12 may be returned to the utility and the internal help desk may be notified. The next gate 208 may determines if the total kWh in the file equals the reported kWh in the file header, for instance. If this gate 208 generates an error, then the data may be returned to the utility and the internal help desk may be notified.

The first gate 212 of the data validation section 156 may determine if the meter reading period is too short. For instance, this variable may be configurable for each utility and in one embodiment may be 25 days. If this gate 212 generates an error, then the interval data 12 may be returned to the utility and the internal help desk may be notified. The next gate 216 may determine whether the meter reading period is too long. For instance, this variable may be configurable for each utility and in one arrangement may be 35 days. If this gate 216 generates an error, then the interval data 12 may be returned to the utility and the internal help desk may be notified. The next gate 220 may determine if the beginning of the current meter reading period (e.g., for a particular facility) overlaps with the end of the previous meter reading period. If this gate 220 generates an error, then the interval data 12 may be returned to the utility and the internal help desk may be notified. The next gate 224 may determine if there is a gap between the beginning of the current meter reading period and the end of the previous meter reading period. If this gate 224 generates an error, then the interval data 12 may be returned to the utility and the internal help desk may be notified. The next gate 228 may calculate the maximum energy (e.g., kWh) for all available historical data and may determine if the maximum kWh for the current meter reading period is more than any appropriate amount greater (e.g., 50%) than a historical maximum. If this gate 228 generates an error, then the interval data 12 may be returned to the utility and the internal help desk may be notified.

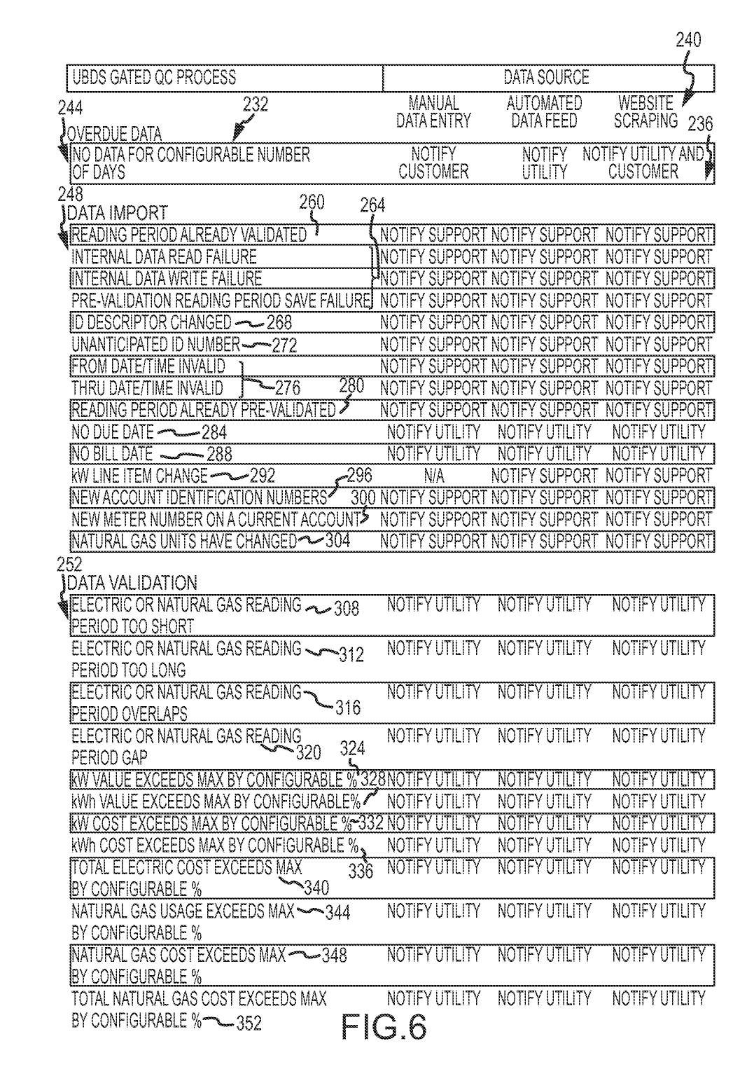

FIG. 6 illustrates a user interface that may be used in conjunction with the UBDS gated quality control process 24. The UIDS gated quality control process 20 may generally operate on billing data 12 received in increments (e.g., monthly basis, daily basis) for overdue data, data import and data validation. The process 24 may comprise one or more gates 140 (e.g., questions) that it performs on one or more inputs (e.g., pieces of billing data) and produces one or more actions 236 (e.g., notify customer, notify support, notify utility, notify utility and support) for one or more billing data sources 240 (e.g., manual data entry, automated data feed, web site scraping). Stated otherwise, if the answer to each gate is “yes”, then one or more of the actions 236 may be taken but the one or more actions 236 may not be taken if the answer to the gate is “no”. The process 24 may include any number of sections such as an overdue data section 244, a data import section 248 and a data validation section 252, each of such sections including one or more gates 232. Logic associated with the process 20 or other user inputs may decide the answer to each gate and the action taken.

As utilities often read meters approximately once a month, the first gate 256 of the overdue data section 244 may check for new data for one or more customer meters once a day (e.g., may check the server system 8 or other databases or storage devices) and cause the generation of an alert (e.g., via the server system 8) if data there has been no new data for a predetermined time period (e.g., just over the past month or 35 days). However, the number of days may be configurable for each data provider (e.g., utility provider, interval database). For instance, those data providers taking part in the distributing processing system 4 may appropriately communicate their billing cycles to the server system 8 or else any location accessible by the process 24. Appropriate messages (e.g., emails) may be sent to the customer, a support team, the utility provider, and/or utility and support if the billing data 16 is overdue.

The first gate 260 of the data import section 248 may ensure that the billing data 16 has not already been validated. If the billing data 16 has been validated then the billing data 16 may be rejected and an email may be sent to the internal help desk. The next three gates 264 relate to internal reads and writes to a database on which the billing data 16 is stored at least temporarily located. The help desk may be notified (e.g., via email) if the process 24 or other application detects one or more failures. The next gate 268 may determine if the identification descriptor has changed since the last time the billing data 16 was received and the internal help desk may be notified if the descriptor has changed. The next gate 272 may determine if the billing data 16 has an ID number that is not in the server system 8 and the internal help desk is notified and the billing data 16 is rejected if this error occurs. The next two gates 276 may determine if the “from” and “through” dates and times are in a valid format. If either of these gates 276 generates an error, the billing data 16 is returned to the utility (e.g., via email) and the internal help desk is notified. The next gate 280 may determine if the meter reading period has already been through the pre-validation process. If this gate 280 generates an error, then the billing data 16 may be returned to the utility and the internal help desk notified. The next gate 284 determines if a due date is present and the billing data 16 may be returned to the utility if this gate 284 generates an error. The next gate 288 determines if a bill date is present and the billing data 16 may be returned to the utility if this gate 288 generates an error. The next gate 292 determines if the kW line item has changed and internal support may be notified and the billing data 16 may be rejected if this error occurs. The next gate 296 determines if there are new account ID numbers. If this error occurs, the billing data 16 may be rejected and internal support may be notified. The next gate 300 may determine if there is a new meter on a current account. If this error occurs, the billing data 16 may be rejected and internal support may be notified. The next gate 304 may determine if any natural gas units have changed. If this error occurs the data may be rejected and internal support may be notified.

The first gate 308 of the data validation section 252 may determine if the electric or natural gas meter reading period is too short. For instance, this variable may be configurable for each utility and in one embodiment may be 25 days. If this gate 308 generates an error, then the billing data 16 may be returned to the utility and the internal help desk or support may be notified. The next gate 312 may determine whether the electric or natural gas meter reading period is too long. For instance, this variable may be configurable for each utility and in one arrangement may be 35 days. If this gate 312 generates an error, then the billing data 16 may be returned to the utility and the internal help desk or support may be notified. The next gate 316 may determine if the beginning of the current electric or natural gas meter reading period (e.g., for a particular facility) overlaps with the end of the previous meter reading period. If this gate 316 generates an error, then the billing data 16 may be returned to the utility and the internal help desk or support may be notified. The next gate 320 may determine if there is a gap between the beginning of the current electric or natural gas meter reading period and the end of the previous meter reading period. If this gate 320 generates an error, then the billing data 16 may be returned to the utility and the internal help desk or support may be notified. The next gate 324 may calculate the maximum power (e.g., kW) for all available historical data and may determine if the maximum kW for the current meter reading period is more than any appropriate amount greater (e.g., 50%) than a historical maximum. If this gate 324 generates an error, then the billing data 16 may be returned to the utility and the internal help desk or support may be notified. The next gate 328 may calculate the maximum energy (e.g., kWh) for all available historical data and may determine if the maximum kWh for the current meter reading period is more than any appropriate amount greater (e.g., 50%) than a historical maximum. If this gate 328 generates an error, then the interval data 12 may be returned to the utility and the internal help desk or support may be notified. The next gate 332 may determine the maximum power cost for all available historical data and may determine if the maximum power cost for the current meter reading period is more than any appropriate amount greater (e.g., 50%) than a historical maximum. If this gate 332 generates an error, then the billing data 16 may be returned to the utility and internal support may be notified. The next gate 336 may determined the maximum energy cost for all available historical data and may determine if the maximum energy cost for the current meter reading period is more than any appropriate amount greater (e.g., 50%) than a historical maximum. If this gate 336 generates an error, then the billing data 16 may be returned to the utility and internal support may be notified. The next gate 340 may determined the total energy cost for all available historical data and may determine if the maximum total energy cost for the current meter reading period is more than any appropriate amount greater (e.g., 50%) than a historical maximum. If this gate 340 generates an error, then the billing data 16 may be returned to the utility and internal support may be notified. The next gate 344 may determine any natural gas usage (e.g., therms, btu, ccf) for all available historical data and may determine if the maximum natural gas usage for the current meter reading period is more than any appropriate amount greater (e.g., 50%) than a historical maximum. If this gate 344 generates an error, then the billing data 16 may be returned to the utility and internal support may be notified. The next gate 348 may determine the natural gas cost for all available historical data and may determine if the maximum natural gas cost for the current meter reading period is more than any appropriate amount greater (e.g., 50%) than a historical maximum. If this gate 348 generates an error, then the billing data 16 may be returned to the utility and internal support may be notified. The next gate 352 may determine the total natural gas cost for all available historical data and may determines if the maximum total natural gas cost for the current meter reading period is more than any appropriate amount greater (e.g., 50%) than a historical maximum. If this gate 352 generates an error then the billing data 16 may be returned to the utility and internal support may be notified.

### Server System:

The server system 8 of the methods and systems disclosed herein may include any appropriate number of servers or other computing devices which may be composed of any number of appropriate components (e.g., hardware, software, firmware) and which may operate in association with any appropriate platforms or operating systems (e.g., Windows XP and Vista, FreeBSD, Solaris, Linux) to receive, store and transmit utility usage information. For instance, one or more of the servers of the server system 8 may include one or more processor modules (e.g., CPUs), increased high-performance RAM, and one or more memory modules (e.g., high capacity hard drives). Also see the representative computing system of FIG. 2 and associated discussion. The servers, computing devices or other components may be physically or virtually located at any location (e.g., same location, different location) allowing for efficient transfer of information between facility locations, end users and/or utility providers.

It will be appreciated that the server system 8 may be operable to seamlessly manage utility usage data from all types of utility usage customers such as homeowners, businesses, governmental entities and the like. Moreover, as the server system 8 may be operable to manage and control the storage and processing of utility usage data for various number and types of facilities, one or more common protocols or formats may be utilized for such storage and processing of data. In this regard, end users need not learn multiple different languages or processing formats when analyzing or interpreting utility usage data from multiple facilities. Moreover, the servers and other computing devices of the server system 8 (and distributing processing system 4 in generally) may in some embodiments perform their tasks (e.g., data acquisition, quality control, storage) in a synchronous mode that coincides with utility interval periods and pre-defined user access needs. For instance, data processing occurring in or by the server system 8 may be designed to run during “off-peak” hours (e.g., between midnight and 6 a.m. on weekdays, anytime on weekends). Performing data processing during such off-peak hours may serve to highly leverage server resources and make the servers available exclusively for serving the data during “on-peak” hours.

With reference to FIGS. 1, 3 and 4, the server system 8 may include the previously mentioned central data server 10 responsible for, among other items, providing a central location and/or database for storing utility usage data according to customer identification information (e.g., location, date) and transmission of such data. The central data server 10 may poll or otherwise retrieve utility usage information for any number of customer facilities using one or more of the above-described acquisition techniques after every desired interval. For instance, the central data server 10 may retrieve such utility usage information daily or in other desired time increments. In some arrangements, the billing data and interval data 16, 12 may be aligned in a database of the central data server 10 and validated to ensure energy (e.g., kWh) values correspond for each customer account or meter. The central data server 10 may appropriately “clean” the utility usage data as previously discussed, and the central data server may also appropriately perform “high-resolution allocation” of the data as will be described below.

The central data server 10 may also serve to transmit utility usage information, applications and other tools to other applications, servers and even end users and clients. As an example, the central data server 10 may appropriately transmit utility usage data in one or more various structured formats to desktop or mobile computing devices as soon as it is received by the central data server 10 or else after any desired time increment. As another example, the central data server 10 may appropriately transmit such utility usage data to an inbox server 128 which may be responsible for generating emails for transmission to end user and/or other entities as will be described more fully below.

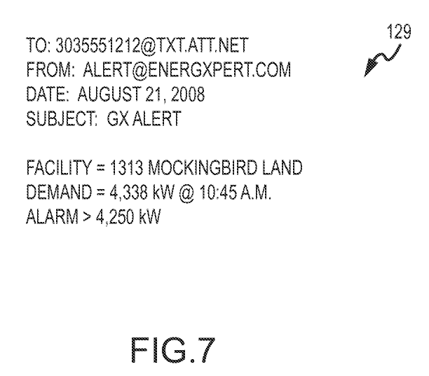

The server system 10 may also include a “real-time” server 128 operable to receive substantially real-time utility usage data and then appropriately process and transmit such utility usage data to other applications. For instance, the real-time server 128 may receive pulsed utility usage data (e.g., from the pulse loggers 104, 120 or power meter 124) after each mini-interval (e.g., 5 min) or interval (e.g., 15 min) and monitor the mini-intervals and/or intervals for utility usage (e.g., electricity consumption, power demand, pseudo-power demand limits) that exceeds pre-determined thresholds. If any utility usage exceeds one or more of the pre-determined thresholds, the real-time server 128 may be operable to automatically transmit a notification of such event to end-users, the utility provider, etc. For instance, the real-time server 128 may be operable to generate an alert message regarding such event with customer identification information, facility location, date, time, etc., and transmit such message to any party (e.g., customer) by way of email, text (e.g., SMS message). An exemplary text message 129 is illustrated in FIG. 7 and may include any appropriate summary statistical information such as facility information (e.g., address), power demand maximum level and time of such level, and a power demand alarm level limit. Such alert text messages 129 may continue to be sent once an interval (e.g., 5 min, 15 min) as long as the demand exceeds the alarm limit. The user may appropriately configure the maximum number of times a message will be sent per excursion.

In some embodiments, customers may be able to appropriately communicate with the server system 8 or else administrator of the server system 8 to manually arrange which entities are to receive such alert messages, predetermined thresholds, etc. In this regard, customer and other entities may be able to receive at least substantially real-time indications of utility usage at one or more facilities. Furthermore, the real-time server 128 may be operable to pass utility usage data to the central data server 10 or other servers or computing devices. As such, the real-time server 128 may appropriately duplicate such data and store copies in a storage device associated with the real-time server 128 and send other copies to the other servers and computing devices.

The server system 10 may also include an inbox or email server 132 that may be operable to retrieve or otherwise receive utility usage information from the central data server 10. In one arrangement, a “flag” may be set in the central data server 10 signifying that new data has arrived that has passed a quality control process. After the email server 132 has retrieved the new data from the central data server 10, the flag may be reset until the time that new data which has passed the quality control process has again been received. The email server 132 may also be operable to transmit (e.g., via email) such information either alone or in combination with appropriate analysis applications and/or modules (described more fully below) to customers and other users for efficient analysis of utility usage. The analysis applications may be attached to the email or other type of transmission from the email server 132 to the user and be synched to utility usage information (e.g., monthly, daily, real-time, substantially real-time) in the server system 8 (e.g., from the central data server 10) such that the user can efficiently analyze the information without the need to install new software and/or manually access utility usage data. For instance, utility usage information may be automatically downloaded from the server system via the interne to the user's computing device upon opening the attachment (e.g., a spreadsheet attachment in Microsoft Excel). Thus, the user's utility usage information may be always stored securely on a remote server and thus always available. The customers may be able to appropriately communicate with the server system 8 to arrange which email accounts are to receive messages from the email server 132 regarding one or more facilities, the frequency of the sent email messages, etc.

In some embodiments, the server system 8 may include a marketing server 136 (see FIG. 1) that may be responsible for targeting advertisements to customers and other users. Broadly, the marketing server 136 may use any appropriate logic to create and/or select targeted advertisements and other messaging customized for one or more specific users and may transmit such advertisements to customers in any appropriate manner (e.g., incorporating such advertisements into the transmission of the utility usage information to the end user, incorporating such advertisements into products or programs sent or pushed to end users via, for instance, email). Such marketing advertisements may serve numerous purposes for utility consumers as well as utility suppliers and other related entities. For instance, targeted advertisements may provide opportunities such as increasing business customer awareness of opportunities to reduce energy use and lower costs, and taking advantage of rebates and tax credits available from utilities and local, state and federal governments. Moreover, such advertisements may facilitate marketing by energy utilities of demand and supply side rebates to small, medium and large business customers, and by energy-related contractors, consultants and vendors to new and existing business customers.

Advertisement selection and pricing may be determined before products and/or utility usage information is distributed to end users, and may be determined based on demographics, geographic location, seasonal information, and the like. There may be a profile for one or more user locations with information such as the type and age of the building or facility, the age of equipment (e.g., lighting, water pipes). For example, if a building has an older vintage lighting, the customer or other entity occupying the building may be a candidate for a lighting retrofit advertisement. Moreover, as some service providers only cover specific geographic areas while other vendors or manufacturers (e.g., larger entities) might have nationwide coverage, the geographic areas targeted by such service providers may provide an input into any logic used by the marketing server 136 to target advertisements. Another input to the marketing server 136 may be seasonal information. As an example, the marketing server 136 may account for the desire of some HVAC providers to advertise during summer months. An even further input to the marketing server 136 logic may be the actual utility usage data of the recipient of the email message from the server system 8. For instance, an energy reduction advertisement may be sent to a customer when the customer has exceeded a predetermined energy threshold.

Appropriate statistics may be collected or tracked in any appropriate intervals (e.g., real-time, daily) regarding advertisements shown to users (e.g., “impressions”), the number of times users have “clicked” on an advertisement on their computing device for more information regarding the advertisement (e.g., “clicks”), etc. Pricing for advertisements may be arranged in any appropriate manner. For instance, pricing may be based on a bidding process that rewards higher bidders with more impressions than lower bidders. As another example, pricing may be based on prices charged to similar types of providers. As a further example, the provider may be required to pay a premium once the number of clicks has reached some pre-determined level. Other pricing arrangements are envisioned as being within the scope of the embodiments. The marketing server 136 may present any statistics to advertisers in real-time via a web site that may require unique login credentials. The advertisers may see impressions, click numbers, click through rates over time, and which specific users clicked on their ads and when they clicked on them. Furthermore, advertisers or utility providers may order and submit advertisements (e.g., logos, potential savings) through the website or in other appropriate manners.

Other types of servers or other appropriate computing devices are contemplated as being part of the server system 8 to facilitate such acquisition, storage and transmission of utility usage information. It is also contemplated that the various functionalities of the above-discussed servers may additionally or alternatively be embodied in a single server or in more than a single server.

### Applications:

Desktop and Mobile Modules:

With reference to FIGS. 1 and 4, the distributed processing system 4 may include the Desktop module 36 and/or a Mobile module 40. The Desktop module 36 may be an application in any appropriate form (e.g., software with any appropriate logic to implement the below described functionalities) operable in one or more desktop platforms (e.g., Windows, Mac, Linux) to serve numerous purposes that will be described herein. The Mobile module 40 may be similar to the Desktop module 36 except it may be designed to work in cross-platform mobile environments including but not limited to Windows, Blackberry and iPhone. For purposes of avoiding some redundancy, only the Desktop module 36 will be described with the understanding that one or more (e.g., all) of such features may be equally applicable to the Mobile module 40.

The Desktop module 36 may be operable to run (e.g., by the processor 1006 of FIG. 2) on a user's local computer (e.g. desktop, laptop, server) to download billing and interval data when available (or at any other appropriate time) for which a user is authorized. Stated otherwise, a user may be required to submit appropriate credentials (e.g., username and password) before downloads are available. The Desktop module 36 may also be operable to download and install program updates (including new features) for one or more programs running on the user's local computer (e.g., the Desktop or Mobile modules 36, 40, Analyzer and Report modules, other utility usage tools, programs and applications discussed herein). The Desktop module 36 may use local computing resources to analyze and chart energy information to advantageously provide increased performance and an enhanced user experience.

More particularly, the Desktop module 36 may be in communication with a data synchronization module (not shown) that may allow the Desktop module 36 to access and retrieve utility usage data from a storage module of the server system 4 and store such utility usage data on a storage module of the user's local computer. The data synchronization module may be generally thought of as a communication bridge between the server system 8 and a computing device of the end user or customer. The data synchronization module may be in any appropriate form (e.g., software with logic to implement at least the functionalities described herein) and may be appropriately implemented on the user's local computer, server system 8, and the like.

In some arrangements, the data synchronization module may allow the customer or applications being operated by the customer to function as an occasionally connected internet client or to otherwise engage in occasionally connected computing (OCC). In this regard, data (e.g., utility usage information) retrieved by the data synchronization module may be utilized by the utility usage analysis tool even when the user is not connected to a network or the internet. The data synchronization module may retrieve the utility usage data at any appropriate time (e.g., according to a predetermined schedule, in response to transmission initiation by a user), and may perform at least some of its functionality by accessing locally saved data (e.g., saved in a storage module of the user's local computer) and on a scheduled basis receiving updated data from the server system 8 (e.g., central data server 10) via web services. For instance, the data synchronization module may update locally saved data (e.g., only storing utility usage data on the storage module of the user's local computer when the retrieved data from the server system 8 is different from that already stored on the storage module of the user's local computer system) using the Microsoft Outlook email transmission notion of “Send/Receive” on a regular configurable schedule, but may also function whenever the user initiates data transmission by manipulating (e.g., by mouse, finger, stylus, eye gaze) a “Send/Receive”-type button.

The Desktop module 36 may also include appropriate logic to “slice and dice” (e.g., parse) utility usage information (e.g., billing and/or interval data) either as part of the retrieval of the utility usage information from the server system 8 by the data synchronization module or else after such retrieval. The Desktop module may, for example, transform billing and interval data from billing periods into time periods (e.g., calendar periods), and/or utilize interval data to allocate financial data. For instance, assuming each interval of a quantity of interval data is 15 minutes, and knowing that there are 96 intervals per day, that equates to 2,880 intervals for 30 days (e.g., 30×96). Thus, instead of allocating the 30 day period equally across 30 days, it may be allocated proportionally across 2,880 intervals. Energy (e.g., kWh) may be used for allocation of electrical charges and consumption (e.g., therms) may be used for the allocation of natural gas charges. The above-described allocation may create a more accurate financial depiction of utility changes as operational demands may vary on various facilities based on weekends, holidays, special events, production schedules, and the like.

The slice and dice functionality of the Desktop module 36 may provide the ability to pre-summarize some or all possible time slice views a customer may want to see, and there may be one or more sets of slice and dice objects (e.g., pieces, groups or sets of utility usage data that has been sliced and diced) for each meter in a customer account. When the slice and dice of the data is complete, the slice and dice software objects may be saved to a disk locally (e.g., the storage module on the user's local computer) and the user may then be notified that new data is available. If the user opts to view the new data, the slice and diced data (e.g., objects) may be loaded into the Desktop module 36 from the local slice and diced files (e.g., objects), and any open windows may be refreshed with the new sliced and diced data.

In one embodiment, the Desktop module 36 may be configured to be associated with interval data 12, interval and billing data 12, 16, or billing data 16, and the functionality of these three configurations as well as the order in which such data may be downloaded and sliced and diced will now be described. If the Desktop module 36 is configured as an interval data only client, then when the interval data 36 is downloaded, power (e.g., kW) and energy (e.g., kWh) interval data may be sliced and diced. If the Desktop module 36 is configured as an interval and utility bill client, then the functionality depends upon whether interval data 12 or billing data 16 is downloaded first. More specifically, if interval data is downloaded first, then power and energy may be sliced and diced. Thereafter, when the billing data 16 is subsequently downloaded, power cost, energy cost, and total cost may be sliced and diced using interval data 12. Moreover, for reading period to billing period allocation purposes, it may be assumed that a billing period is from noon to noon regardless of when the meter is actually read because it may not be possible to always know when billing periods match reading periods. However, if the billing data 16 is downloaded first, then no data may be sliced and diced. Thereafter, when the interval data 12 is subsequently downloaded power, energy, power cost, energy cost and total cost may be Sliced and Diced using interval data 12. If the Desktop module 36 is configured as a utility bill only client, then power, energy, power cost, energy cost and total cost may be slice and diced on a calendar basis.

The Desktop module 36 may also be operable to cause the display of at least one appropriate alert message (e.g., pop-up message, toaster message) on any appropriate screen (e.g., desktop, other programs) of the user's local computing system. For instance, the one or more alerts may inform a user of new data that has been received such as interval or billing data 12, 16 that is ready for review (e.g., has been sliced and diced), utility information such as outage notification or rate changes, demand or supply side management program updates, and/or advertising messages from utilities and other product and service providers. The one or more alert messages may be in any appropriate form with any appropriate functionality. In one arrangement, an alert message may be in a customizable window with a close button, a push pin to keep the message displayed until the user decides to release it, and/or the ability to click on the message as if it were a hyperlink to get more information. As an example, an alert message indicating that new interval data 12 has been received may include a hyperlink that when manipulated (e.g., clicked) may direct the user to the specific directory within the storage module of the user's local computing system in which the interval data 12 is located. In other arrangements, the alert message may have images (e.g., logos, graphics), one or more drop-down lists of commands (e.g., more information, close), and one or more miniature sets of action buttons that may be specific to Desktop module 36 commands. The Desktop module 36 may appropriately operate in conjunction with other components of the user's local computing system to generate such alert messages.

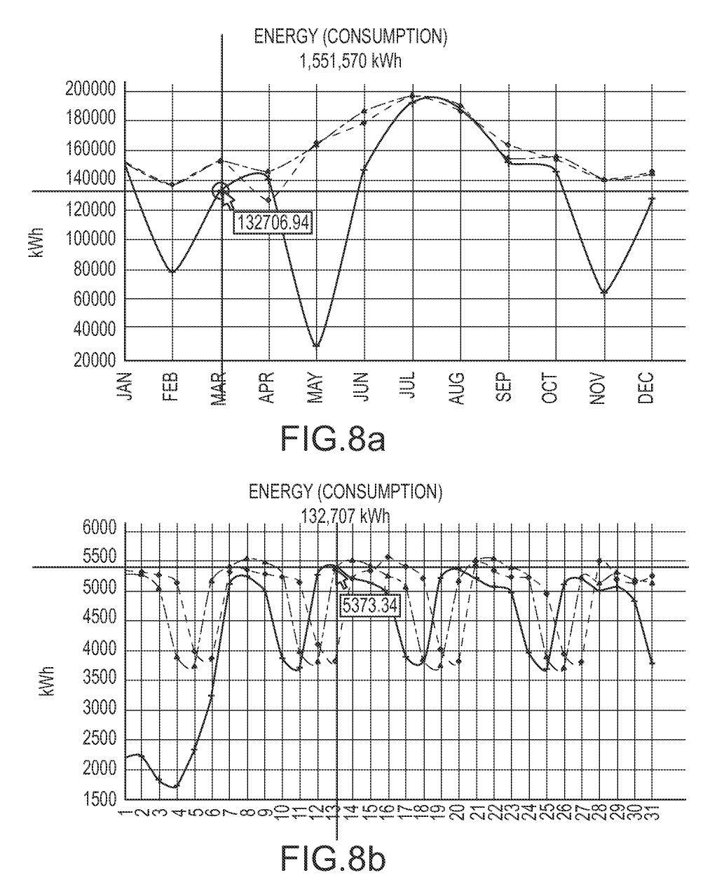

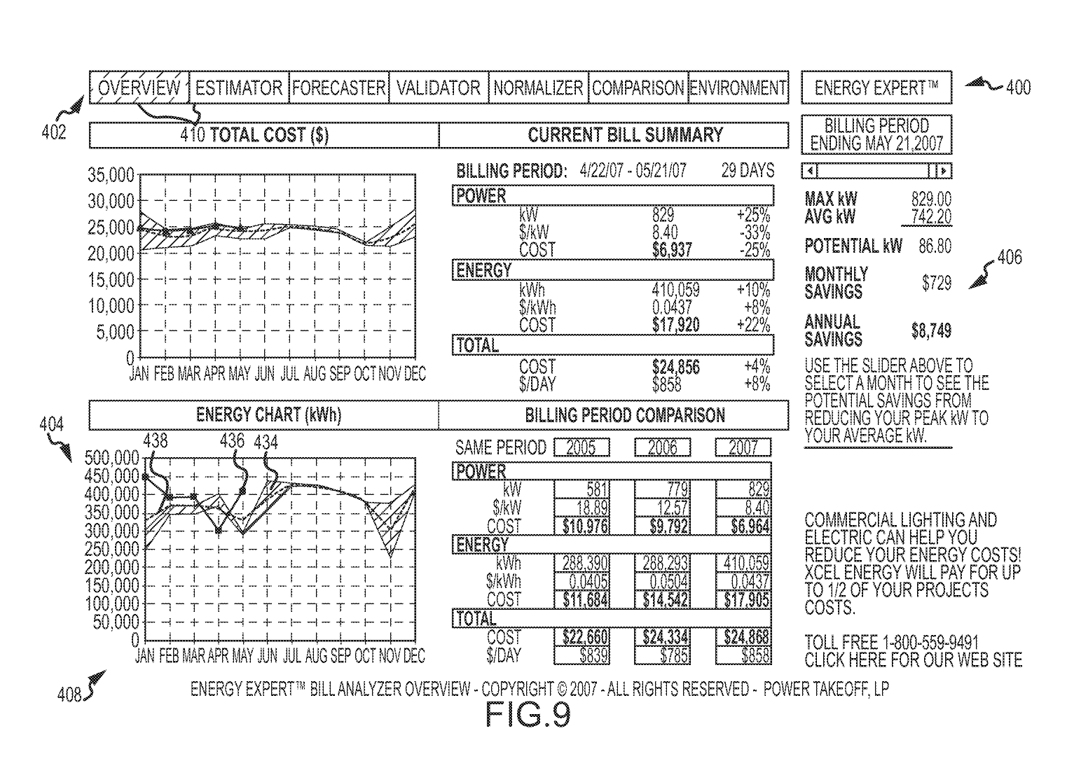

Furthermore, the Desktop module 36 may feature an ability to quickly analyze and navigate large volumes of data from or created by the distributed processing system 4. For instance, the Desktop module 36 may allow a user to drill down to a more detailed level in one or more charts and graphs (discussed in more detail in following sections) of the distributed processing system 4. With reference to FIG. 8a, one exemplary graph of energy consumption (e.g., kWh) versus time (e.g. months) is illustrated and shows a number of curves or lines. If a user desired to view more detailed energy consumption information from the month of March, the user may position a user positionable device (e.g., cursor, not labeled) over an area (e.g., data point corresponding to 132706.94 kWh) where one of the curves passes month of March and appropriately manipulate such data point (e.g., with a mouse, finger, stylus, eye gaze). Thereafter, the more detailed view of energy consumption in March illustrated in FIG. 8b may be displayed. It will be appreciated that the user may further “drill-down” into one or more specific days of each month, one or more specific hours of each day, etc.

Introduction for the Following Modules:

Each of the following modules may be in the form of any appropriate application (e.g., software) with any appropriate computer readable instructions (e.g., code) operable to analyze and present, inter alia, billing and interval data 16, 12. The display 1016 (e.g., GUI) of FIG. 2 of the user's local computing system and other components of the local computing system may be in the form of a “user interface module” operable to provide one or more graphical representations or other indications to a user. As will be described below, the display 16 may be operable to present information regarding the analysis of the billing and interval data 16, 12 in various forms (e.g., graphs, charts) in a manner that may be user interactive (e.g., by way of stylus, mouse, finger, eye gaze). As such, the user interface module serves to advantageously allow utility consumers (e.g., businesses, homeowners, government) to use the following modules to view and analyze (e.g., interactively) their utility usage information to more efficiently exploit such utility usage.

Analyzer Module:

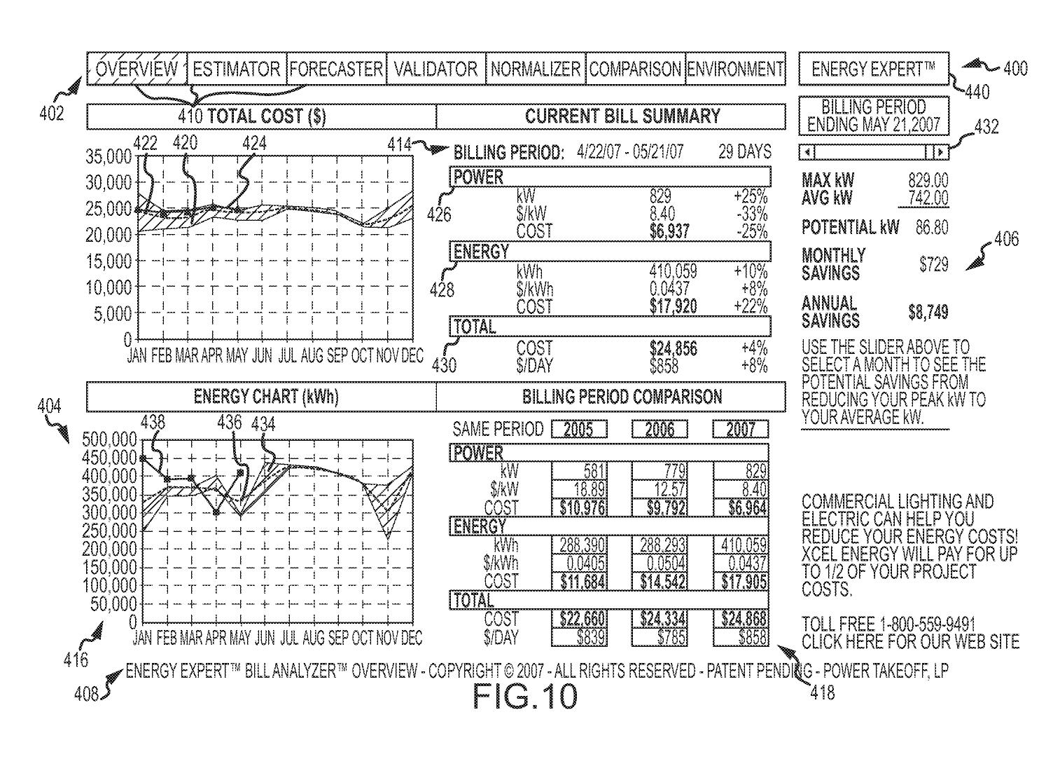

With reference to FIGS. 9 and 10, an “overview” screen of a user interface 400 of the analyzer module is illustrated. While the analyzer module will be discussed in conjunction with billing data 16, it will be appreciated that the analyzer module may also appropriately analyze interval data 12. In this example, the data input into the analyzer module may be billing data 16 that is updated monthly and may include “required” data and “optional” data, although it should be appreciated that numerous other arrangements are contemplated. The required data may include energy consumption in kWh, energy cost and total cost. The optional data may include power demand in kW, power cost, reactive power in kVAR, reactive power costs, other costs (e.g., environmental), and taxes and fees. The billing data 16 may be acquired from the server system 4 (e.g., the central data server 10) in any appropriate manner. For instance, a user may acquire the billing data 16 using the web query function in Microsoft Excel.

The user interface 400 may include any appropriate number of menus, icons, pointing devices (e.g., cursors) and/or windows, for instance. Moreover, the user interface 400 may be manipulated in any appropriate manner including without limitation stylus, mouse, a user's appendage (e.g., finger), voice or eyes, etc. The user interface 400 may include one or more screens (e.g., Overview screen, Estimator screen), each of which may include any appropriate number of regions (e.g., graphical display regions). Moreover, each of the graphical display regions may be operable to convey various types of information to a user and/or allow the user to manipulate the user interface 400. For instance, the user interface 400 may include first, second, third and fourth graphical display regions 402, 404, 406, 408, each of which may include any appropriate number of cells, sections, tables, graphs, etc.

The first graphical display region 402 may be in the form of a “navigation area” including one or more navigation tabs or buttons 410. Each of the navigation buttons 410 may be appropriately manipulable or selectable and may direct a user to a different analysis tool on a different page or sheet. As shown, the navigation buttons 410 may be located at the top of each page so that a “length” of each page may extend below an initial screen area although the navigation buttons 410 may be located in other regions. Moreover, when a user selects a navigation button 410, the selected button 410 may be appropriately indicated and/or differentiated from the other buttons 410 to indicate the selection. For instance, the selected button 410 may acquire a background of one color (e.g., green) while the remaining buttons may all acquire a background of a different color (e.g., green or white).

The second graphical display region 404 may be in the form of an “analysis area” which may provide the primary analysis area on each page, and may include one or more graphical representations (e.g., line graphs, pie charts, spreadsheets, matrices). The various utility usage information analysis tools in the second graphical display region 404 may change based on the type of analysis that is selected with the navigation buttons 410. The third graphical display region 406 may be in the form of a “marketing area” that integrates marketing and environmental messages. For instance, one or more messages in the third graphical display region 406 may be sponsored by utilities, contractors, consultants, vendors or other organizations. The fourth graphical display region 408 may be in the form of an “intellectual property area” that presents intellectual property notifications (e.g., patent, trademark and copyright protection notifications) regarding, for instance, one or more aspects of the distributed processing system 4 and/or the various modules disclosed herein. In some embodiments, each of the first, second, third and fourth graphical display regions 402, 404, 406, 408 may include a feature to easily distinguish one region from another region. For instance, each of the first, second, third and fourth graphical display regions 402, 404, 406, 408 may include a different background color such as the first graphical display region 402 including a yellow background, the second graphical display region 404 including a green background, the third graphical display region 406 including a blue background, and the fourth graphical display region 408 including a pink background.

With continued reference to FIG. 10, the second graphical display region 404 may include one or more regions, sections, quadrants, and the like. For instance, the second graphical display region 404 may include first, second third and fourth quadrants 412, 414, 416, 418 each of which may be operable to provide a different type of analysis of the billing data 16. It will be appreciated that the use of the term “quadrant” disclosed herein does not necessarily connote exactly or even close to one-quarter of some larger area. The first quadrant 412 may provide a month-by-month trend of the total cost of a meter (e.g., electric) at a customer's facility which may incorporate various colors, shapes and lines to convey various types of information. As an example, the background area 420 (e.g., having a light green color) may represent the historical cost range each month of previous years (e.g., two previous years), the dashed line 422 may represent the average cost by month, and the dark or solid line 424 with the triangular markers may represent the cost each month for the current year. The customer or user may also appropriately configure the year(s) to be included in the trend analysis by way of a manual entry cell, a drop down menu, and the like (not shown).

The second quadrant 414 may be in the form of a table or the like that provides a breakdown of the utility bill (e.g., electric) for the current billing period. As can be seen, the beginning and ending dates of the current billing period as well as the number of days in the billing period may be displayed. Information in the second quadrant 414 may be arranged in any number of sections, regions or the like. For instance, the second quadrant 414 may include a power region 426 with the maximum kilowatt (demand) for the current billing period in kW, the cost per kilowatt for the current billing period in $/kW, and the kilowatt cost for the current billing period in dollars. The second quadrant 414 may also include an energy region 428 with total energy (consumption) for the current billing period in kWh, cost per kilowatt-hour for the current billing period in $/kWh, and kilowatt-hour cost for the current billing period in dollars. The second quadrant 414 may also include a total region 430 with total cost for the current billing period in dollars and the cost per day which is the total cost divided by the number of days in the current billing period. A portion of one or more of the power, energy and total regions 426, 428 and 430 may include a representation of the values for the current billing period relative to the average of the values previous periods or years. In one embodiment, the representation may be a percentage difference of the current billing period value relative to the values for the previous two years. The “current billing period” of the second quadrant 414 may be controlled in any appropriate manner, and in one embodiment is controlled and changed by a slider bar 432 situated within the third graphical display region 406. A region or cell (not labeled) above or otherwise near the slider bar 432 may be reserved for indicating the currently selected time period. In other arrangements, the current billing period may be changed via drop down menus, “up” and “down” arrows, manual entry, etc.

The third quadrant 416 may be in the form of a utility usage chart (e.g., “Energy Chart (kWh)”) which may provide a month-by-month trend of the total energy consumption of a utility (e.g., electric) meter. A background area 434 (e.g., having a light green color) may represent the historical energy consumption range each month of previous years (e.g., two previous years), the dashed line 436 may represent the average energy consumption by month, and the dark or solid line 438 with the triangular markers may represent the energy consumption each month for the current year. The customer or user may also appropriately configure the year(s) to be included in the trend analysis by way of a manual entry cell, a drop down menu, and the like (not shown).

The fourth quadrant 418 may be in the form of a billing period comparison that may be similar to the current bill summary in the second quadrant 414 except that it may be organized by year for the current year and previous years (e.g., two previous years). Stated otherwise, the information displayed in the second quadrant 414 for the current billing period may be displayed in the fourth quadrant 418 as well as similar information for the same billing period of each of the past two years. As previously discussed, the billing period may be controlled and changed by the slider bar 432 located at the top of the third graphical display region 406 (e.g., marketing area) on the right side of the page.

The third graphical display region 406 may be in the form of a “marketing area” which may be on any appropriate portion of the page (e.g., right side as illustrated) that may serve numerous purposes. In some embodiments, the third graphical display region 406 may highlight potential energy savings between the maximum and average demands for the current billing period. For instance, the power demand for the current billing period as well as the average power demand for the same period from previous years may be displayed, as well as the difference between the two values to illustrate possible power demand savings in kW as well as in dollars. The dollar savings may also be extrapolated out from a monthly to a yearly savings. Such values may be automatically updated for each billing period as the slider bar 432 is moved. Other types of utility information (e.g., energy, natural gas) may be included in the third graphical display region 406 to illustrate possible savings thereof. Other portions of the third graphical display region 406 (e.g., bottom) may include advertising (e.g., “Commercial Lighting & Electric”) for the sponsor of the module or for other entities. In some embodiments, the analyzer module may be in appropriate communication with the marketing server 136 to determine advertisement selection and pricing as well as to collect statistics (e.g., clicks) for future advertisement placement. Furthermore, the third graphical display region 406 may also include a button or tab 440 that when manipulated is operable to open or display a “pop-up” browser window that provides detailed help customized for the overview page. In some embodiments, such pop-up browser window may include screen capture videos.

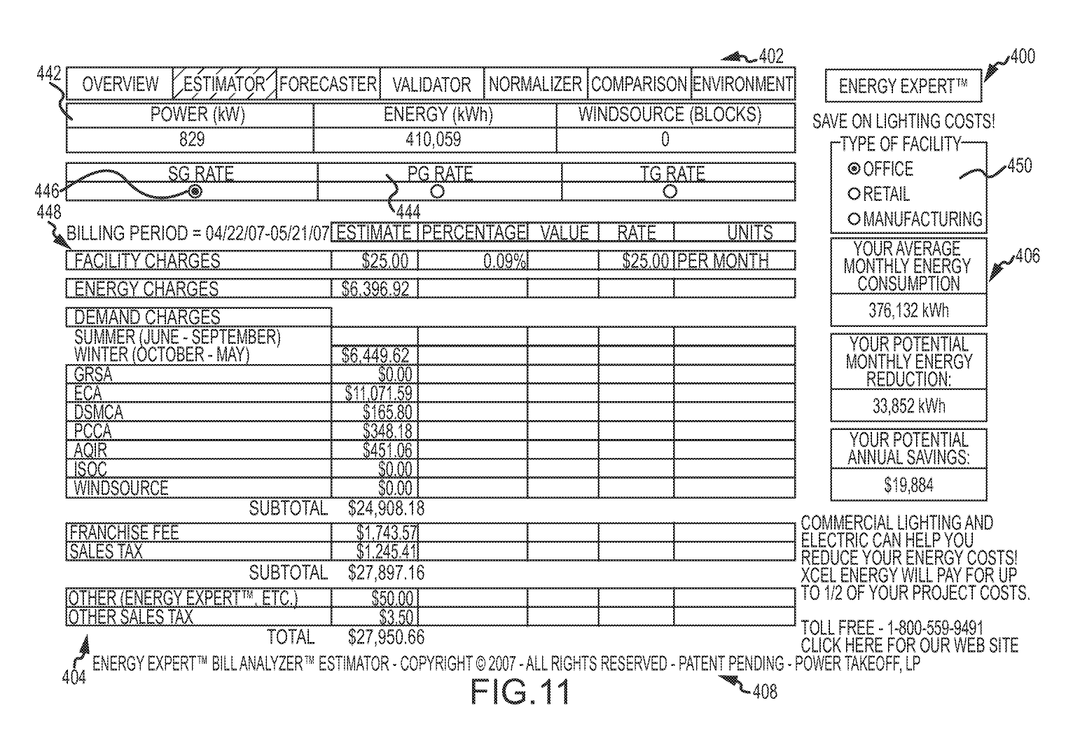

With reference to FIG. 11, an “estimator” screen of the user interface 400 of the analyzer module is illustrated. As can be appreciated, a user may access the estimator screen by way of appropriate manipulation of the “estimator” navigation button 410 in the first graphical display region 402. In this screen, the second graphical display region 404 may be generally organized to illustrate a detailed breakdown of each line in a customer's utility bill. It will be appreciated that the presentation in the illustrated second graphical display region 404 may vary due to different tariff structures and the like. A first section 442 of the second graphical display region 404 may list the power, energy and other variables used as input to the estimator computations. Such variables may be in bold, dark colors denoting that the customer may appropriately change the variables to conduct “what-if” scenarios. A second section 444 of the second graphical display region 404 may allow a user or customer to select their electric utility rate (e.g., SG Rate, PG Rate, TG Rate) or otherwise view what their costs would be on a different rate structure. For instance, the second section 444 may include “radio selector buttons” 446 that when manipulated allow the user to select a particular utility rate. A third section 448 may list the row or line items specific to the selected rate with a number of columns for each line item. For instance, each line item may include an “Estimate” column that provides a total calculated estimate in dollars for each line item, a “Percentage” column that provides a percentage of total bill for each line item, a “Value” column that provides an input value (e.g., kW, kWh) used to calculate each line item, a “Rates” column that provides a rate multiplier for each line item, and a “Units” column that provides engineering or financial units for each rate variable. The variable in the Rates column may be in a bold, dark color denoting that the customer can change the variables to conduct “what-if” scenarios. Moreover, as utility providers may change these variables regularly, such variables may be updated automatically in the Analyzer module software as part of a monthly update service (e.g., conducted in association with the Desktop and/or Mobile modules 36, 40).

The third graphical display region 406 (e.g., marketing area) of the Estimator screen may include a series of selector buttons 450 that allow the customer or user to select their type of facility (e.g., office, retail, manufacturing). Moreover, the third graphical display region 406 may include calculated estimates of potential utility usage (e.g., energy, natural gas) savings that are presented to encourage the customer to save energy and money. This illustrates one example of interactive savings calculators designed to educate customers and encourage such customer to participate in utility Demand Side Management (DSM) programs.

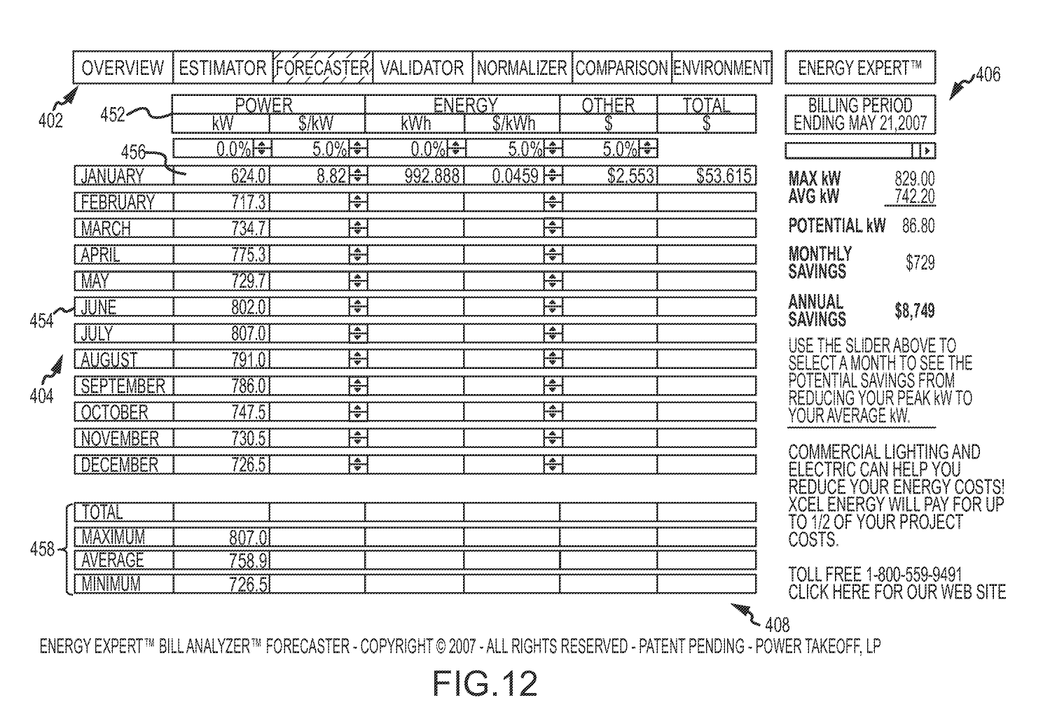

A “forecaster” screen of the user interface 400 of the analyzer module is illustrated in FIG. 12. In this screen, the second graphical display region 404 may be generally organized to enable customers to predict future utility bills (e.g., electric) based on historical power and energy values multiplied by future rate predictions. For instance, the second graphical display region 404 may include a number of columns 452 representing, for instance, kW, $/kW, kWh, $/kWh, Other $, and Total $ fields for each of the twelve months. The twelve months may be represented by a number of rows 454. The intersection of each column and row 452, 454 may include a cell 456 which may be populated with utility data. For instance, the average of the current year and two previous years of data may be automatically entered into each cell 456 of the kW, $/kW, kWh and $/kWh columns when a user first opens the analyzer module. In other embodiments, the year to be compared can be manually configured instead of using all years of historical data. The cells 456 of the Other $ column may be used for taxes, fees, etc.

The top or other portion of each column 452 may include one or more sets of “up and down” arrows (e.g., spinner buttons). For instance, one set of up and down arrows located at the top of each column may be operable to adjust each of the cells in the entire column. Another set of up and down arrows associated with one or more cells 456 of the $/kW and $/kWh columns may be operable to adjust the values in each of such cells 456. It will be appreciated that the up and down arrows may be used to quickly make “what-if” estimates. One algorithm to compute the value for the cell 456 at the intersection of the Total column and each month may be ((kW×$/kW)+(kWh×$/kWh))×(1+Other Percentage). Another algorithm may be (kW×$/kW)+(kWh×$/kWh)+(Other amount). In any case, another portion 458 of the second graphical display region 404 (e.g., a bottom portion) may include maximum, minimum and average calculations for each of the columns 452. The portion 458 may also include columnar totals for the kWh, Other and Total columns.

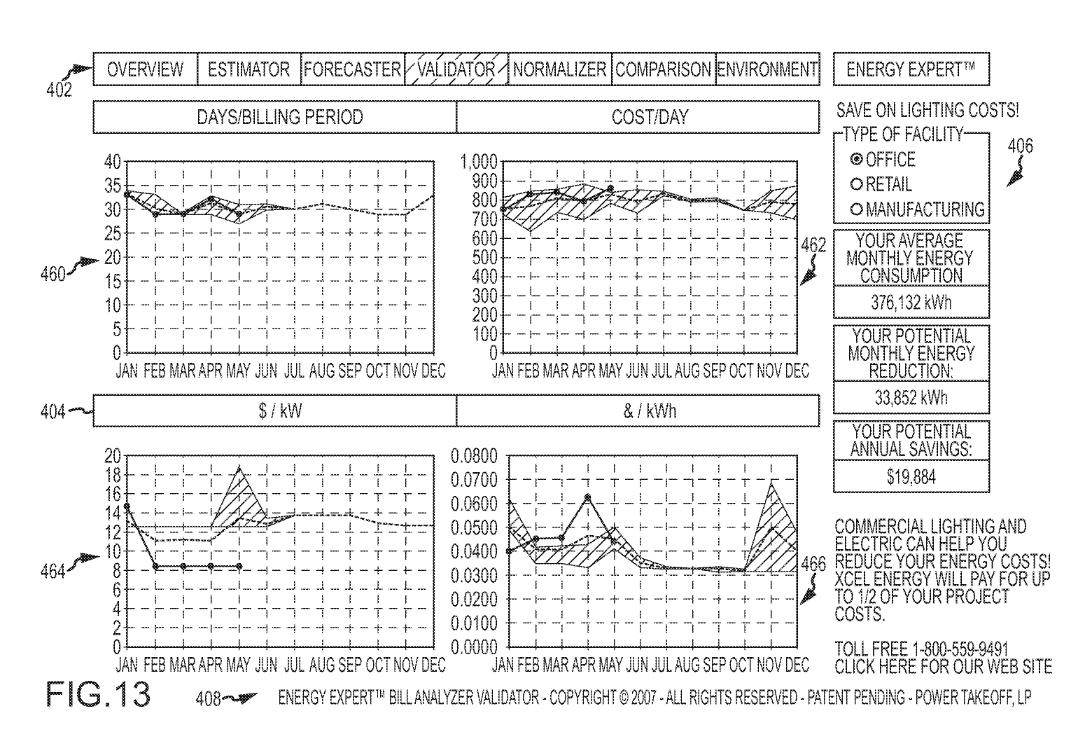

A “validator” screen of the user interface 400 of the analyzer module is illustrated in FIG. 13. In this screen, the second graphical display region 404 may be generally organized to provide customers an efficient manner of viewing long term trends of key variables that make up their utility (e.g. electric) bill. For example, the second graphical display region 404 may include one or more regions, sections, quadrants, and the like, and may include first, second, third and fourth quadrants 460, 462, 464, 466 each of which may be operable to provide a different type of analysis of the billing data 16.

The first quadrant 460 may provide a graphical representation of days per billing period for a number of time periods (e.g., months). As utility bills may be higher or lower depending on the number of days in a cycle, the information in the first quadrant may be useful in assisting a user in determining why a particular utility bill was higher or lower than other utility bills, for instance. The second quadrant 462 may provide a graphical representation of the cost per day for a number of time periods. The second quadrant 462 also factors in the total cost with the number of days in the billing period. The third quadrant 464 may provide a graphical representation of dollars per kW, or in other words, the cost of power for each time period. The fourth quadrant 466 may provide a graphical representation of dollars per kWh, or in other words, the cost of energy for each time period. The light green (or other colored or other patterned) background area of each of the first, second third and fourth quadrants 460, 462, 464, 466 may represents the historical range of previous years (e.g., two years), the dashed line may represent the average by month, and the dark line with the circular markers may represent the current year.

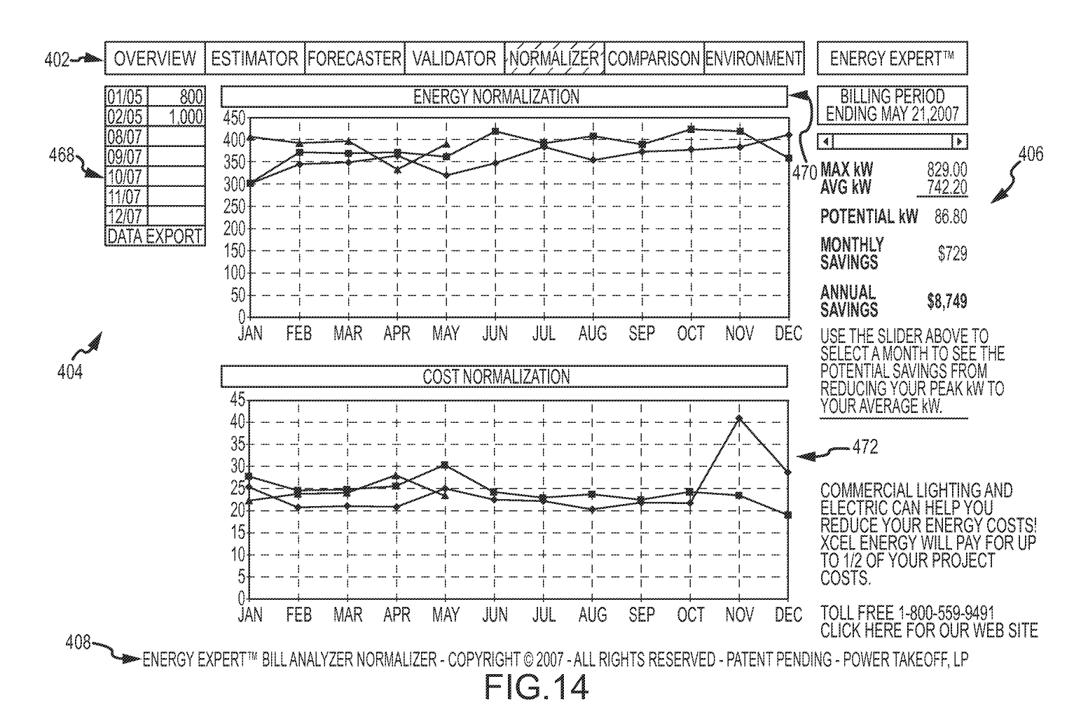

A “normalizer” screen of the user interface 400 of the analyzer module is illustrated in FIG. 14. In this screen, the second graphical display region 404 may be generally organized to provide the customer with a tool to highlight abnormal energy or cost trends. For example, the second graphical display region 404 may include one or more regions, sections, quadrants, and the like, and may include first, second and third regions 468, 470, 472 each of which may be operable to allow for data input and/or provide a different type of analysis of the billing data 16.

The first region 468 may be in the form of a spreadsheet or a series of columns and rows of cells (not labeled). The cells of one column may correspond to a number of time periods (e.g., months) while the cells of an adjacent column may correspond to some value that correlates with utility (e.g., energy) usage. In one embodiment, such a value may be square footage of the facility or production units. In any case, the customer or user may appropriately enter or input a value for each month, and the data may be stored on the user's local computing system by way of a user manipulable feature such as the “data export” button in the first region 468 shown in FIG. 14.

Each of the second and third regions 470, 472 may provide one or more graphical representations of an analysis of the billing data 16. For instance, the second region 470 may be in the form of an “energy normalization chart” with a number of data points, each data point being the quotient of energy consumption for the current year and the two previous years (e.g., an average of the current year and two previous years for each month) and the normalization unit from the first region 468 for each month. The data points may then be displayed to illustrate the trend for each month and ultimately for the current year and previous years. The third region 472 may be in the form of a “cost normalization chart” with a number of data points, each data point being the quotient of electrical energy cost for the current year and the two previous years (e.g., an average of the current year and two previous years for each month) and the normalization unit from the first region 468 for each month. The data points may then be displayed to illustrate the trend for each month and ultimately for the current year and previous years. As shown, each of the yearly plots of the second and third regions 470, 472 may be in a different color that may correspond to colors from the first region 468. It will also be appreciated that a user may appropriately configure the year or years the user may desire to trend rather than using all years of historical data by way of any appropriate slider bar, manual entry cell, etc. (not shown).

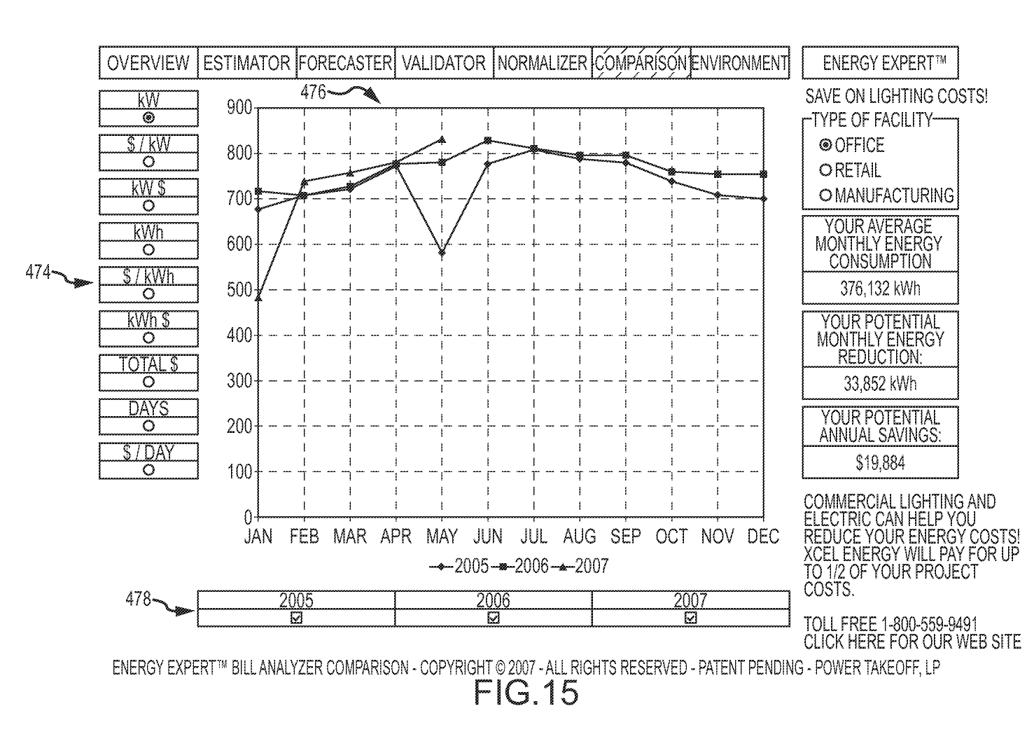

With reference to FIG. 15, a “comparison” screen of the user interface 400 of the analyzer module is illustrated. In this screen, the second graphical display region 404 may be generally organized to allow the customer to compare a variable over time. The second graphical display region may include a number of sections, regions or areas such as first, second and third regions 474, 476, 478, each of which may be operable to allow for data input and/or provide a different type of analysis of the billing data 16.

The first region 474 may include a number of selection devices (e.g., selector buttons, check boxes) each of which corresponds to a particular variable (e.g., kW, $/kW) that may be trended or otherwise displayed over time in the second region 476. The second region 476 may provide one or more graphical representations of an analysis of the billing data 16. For instance, the second region 476 may provide a plot including a number of data points, each data point corresponding to the particular variable selected by a user in the first region 474 at each month of each of one or more years (e.g., 2005, 2006, 2007). The third region 478 may also have a number of selection devices (e.g., selector buttons, check boxes) each of which corresponds to a particular year. Upon selection of one or more of such years, the trend selected in the first region 474 for such selected year will be displayed.

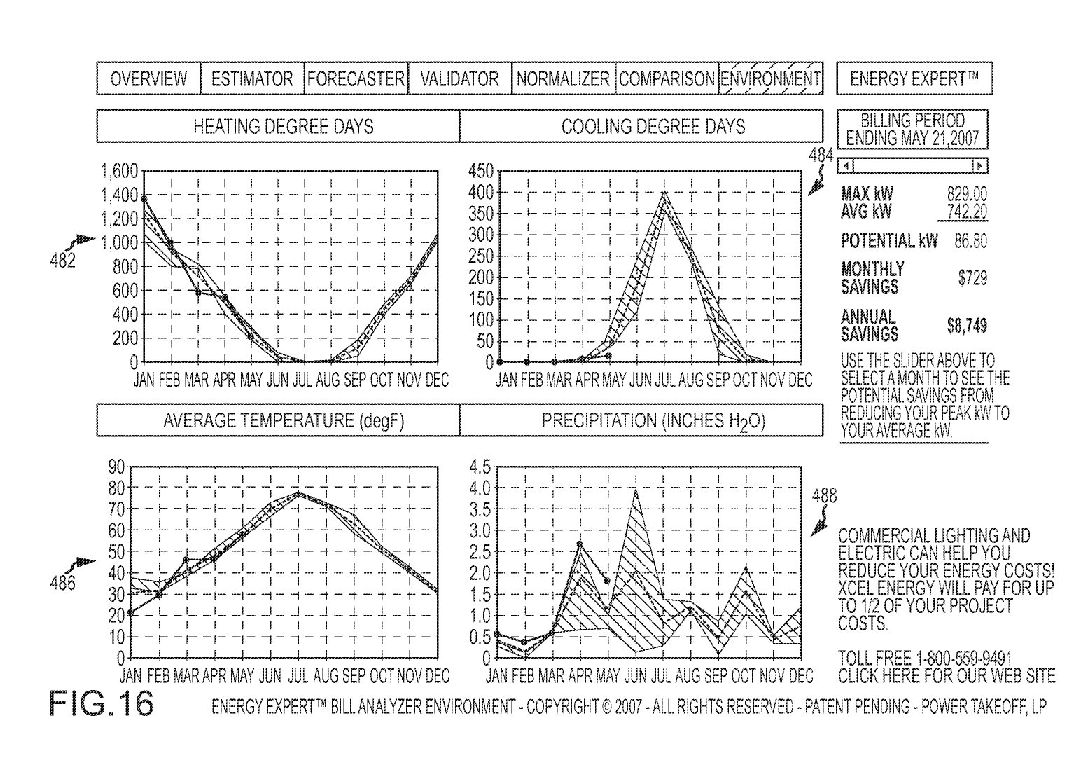

With reference to FIG. 16, an “environment” screen of the user interface 400 of the analyzer module is illustrated. In this screen, the second graphical display region 404 may be generally organized to provide information to the customer about the environment and the potential impact the environment could have on their utility (e.g., electrical, natural gas) costs. The environmental data utilized in the environment screen may be for any appropriate region (e.g., customer's nearest metro area, state, region). The second graphical display region 404 may include one or more regions, sections, quadrants, and the like, and may include first, second, third and fourth quadrants 480, 482, 484, 486 each of which may be operable to provide a different type of analysis of the billing data 16.

The first quadrant 480 may provide a graphical representation of heating degree days or stated otherwise, an indication of how cold it is over the various months of the winter and/or other seasons of the year. Data points in the first quadrant may generally represent the difference between a “balance point” temperature (e.g., 18° C., 65° F.) above which the building is assumed not to need any heating and each day's mean daily temperature. The second quadrant 482 may provide a graphical representation of cooling degree days or stated otherwise, an indication of how hot it is over the various months of the summer and/or other seasons of the year. Data points in the first quadrant may generally represent the difference between each day's mean daily temperature and a “balance point” temperature (e.g., 18° C., 65° F.) above which the building is assumed not to need any cooling. The third region 484 may provide a graphical representation of the average temperature by month over one or more years while the fourth region 486 may provide an average snow or rainfall by month. Other types of environmental factors, elements and the like may also be appropriately plotted in the first through fourth regions 480, 482, 484, 486 or else in additional regions.

The background area (e.g., having a light green color) may represent the historical range of previous years (e.g., two previous years), the dashed (or other patterned) line may represent the average by month, and the dark or solid line with the markers (e.g., circular) may represent the current year. Thus, regarding the dashed line in the first region 482 for instance, the difference between the balance point temperature and each day's mean daily temperature may be added up for all days in each month, and then the average of such month over a number of years may be taken and plotted. The same process may be performed for a number of months and such data points may be connected by the dashed line.

It will be appreciated that one or more of the various features disclosed in the various screens of the user interface 400 of the analyzer module may be utilized with other screens or embodiments of the analyzer module. For instance, the third graphical display regions 406 of FIGS. 10 and 11 may be interchangeably used throughout the various screens. As an additional example, the various manners of selecting or inputting data into the various screens (e.g., up and down arrows, check boxes, scroll bars, selector buttons) may also be interchangeably used throughout the various screens.

The analyzer module advantageously provides numerous benefits to customers, utility providers and other entities. For instance, the analyzer module may function in conjunction with any appropriate software (e.g., Microsoft Excel), and removes conjecture from utility usage analysis by utilizing current and historical billing and interval data. Users are provided with answers, environmental information and advertisements in easy to understand formats. Moreover, users may keep and store raw data to create individual, customized analyses. It will be appreciated that many other advantages flow from the embodiments disclosed herein.

Report Module:

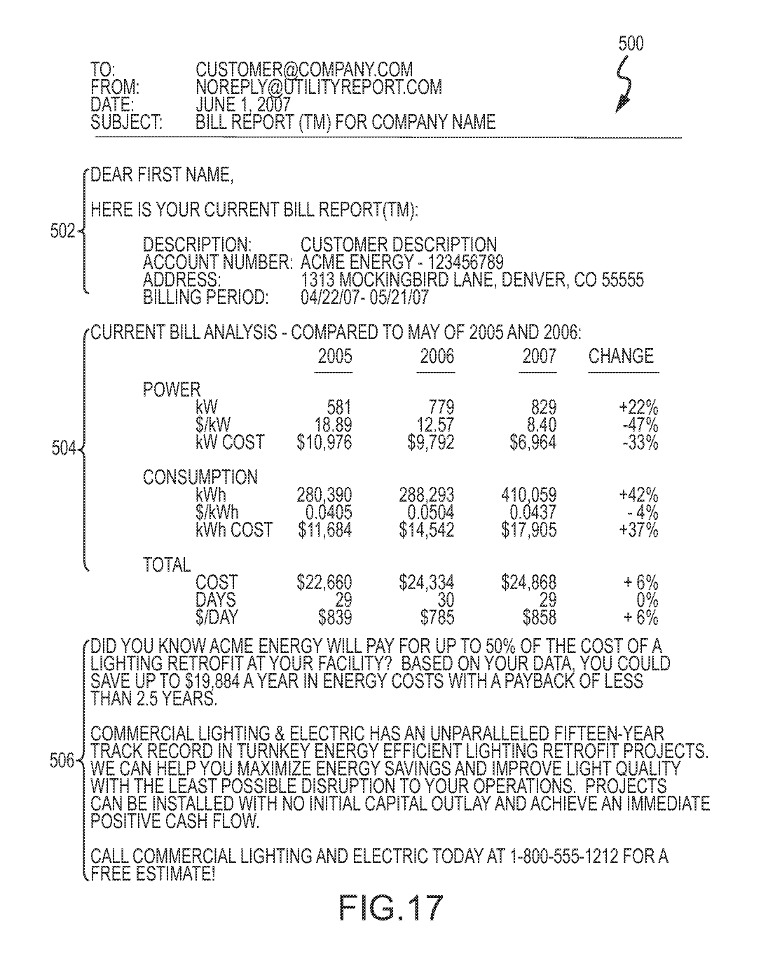

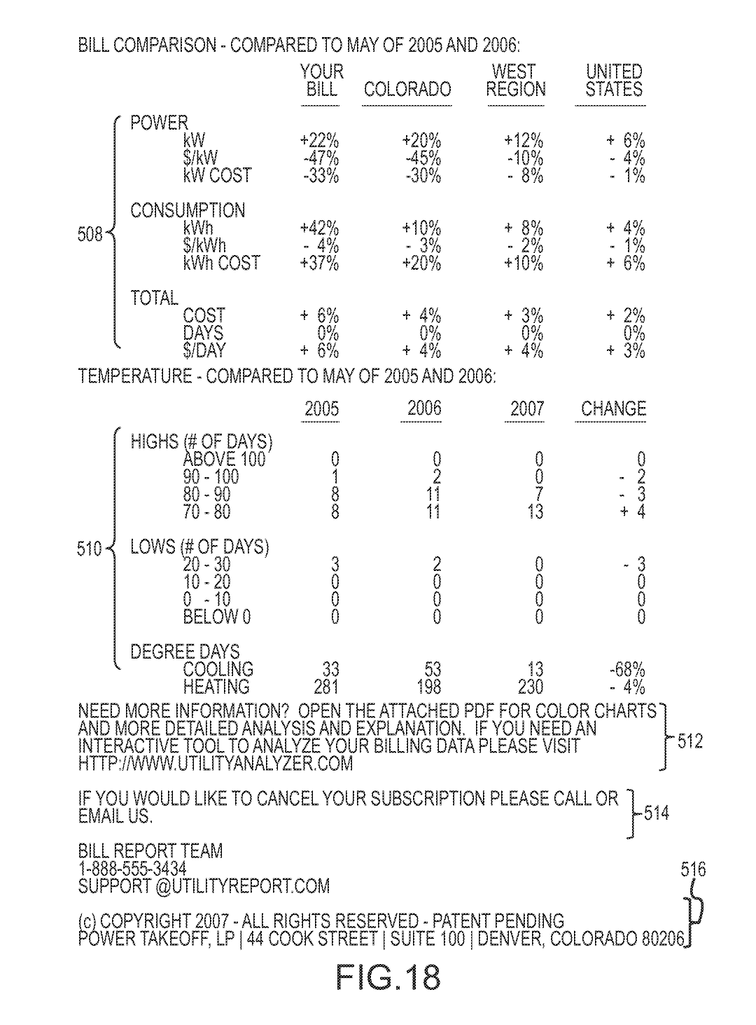

Referring to FIGS. 17 and 18, a first embodiment of a user interface 500 (e.g., email message) of the report module is illustrated. While the report module will be discussed in conjunction with billing data 16, it will be appreciated that the report module may also appropriately analyze interval data 12. The data inputted into the report module may be similar to that in the analyzer module and thus will not be further described. The report module may work in conjunction with the email server 132 (see FIG. 4) to acquire data from the central data server 10 and/or real-time server 128 and create email messages that include a number of data analyses as will be described below.

The first embodiment of the user interface 500 may be in the form of an email message (e.g., plain text) which may utilize any appropriate number of columns (e.g., 72 columns). The email message may be sent to a user's email address for retrieval by the user on their local computing device (e.g., mobile, desktop). The email message may include any appropriate number of regions, sections, areas and the like, and each of such regions may be operable to convey various types of information to a user and/or allow the user to manipulate the user interface 500. For instance, the user interface 500 may include first through eighth display regions 502, 504, 506, 508, 510, 512, 514, 516, each of which may convey various types of utility information to the email recipient or other user.

The first region 502 may be in the form of an introduction that may greet the customer by name (e.g., first name) and may list any amount of customer identificatory information. For instance, the first region 502 may include a unique description by the customer (e.g. Building #3), the utility and unique account number, the physical location of the utility meter (e.g., address), and the beginning and ending dates of the current billing period. The second region 504 may be in the form of a “current bill analysis” that may break down the customer's current utility bill into a number of areas and in this regard may be considered “dynamic benchmarking”. For instance, the second region 504 may break down the bill into power demand, energy consumption, and total cost areas for the current time period as well as the same time period for previous years (e.g., two previous years). Moreover, the second region 504 may include a percentage change of the current time period from the average of the same time period for previous years. As an example, the second region may include line items such as power (e.g., kW, $/kW, kW cost), energy (e.g., kWh, $/kWh, kWh cost), and total (e.g., total cost, number of days in the billing period, total cost in $/day). However, other types of current bill analyses and other types of utilities may also be displayed in the second region 504.

The third region 506 may be in the form of an “external” marketing message, or in other words, a marketing message that is customizable by the report or email sponsor (e.g., utilities, contractors, vendors, consultants, etc.) and may include customizable calculations based on the customer's actual historical data. The fourth region 508 may be in the form of a bill comparison that utilizes the same as or similar line items to the second region 504, but that may compare the current bill to similar facilities in one or more areas (e.g., state, region, nationwide) for the same period of time. This comparison may be made by utilizing data from other customers that want to participate, and the data may be structured such that no customer may see the data from other customers.

The fifth region 510 may be in the form of a temperature comparison that may present temperature related data relative to the customer site (e.g., facility). For instance, the fifth region 510 may include any number of line items for the current billing month compared to the same period for previous years (e.g., 2) such as high temperature days, low temperature days, and cooling and heating degree days. Moreover, the fifth region 510 may include a column for “change” which may represent the change in number of days from the current time period to the average from previous years. The “highs” line item may have a number of sub-line items such as the number of days between 70 and 80 (° F.), the number of days between 80 and 90, the number of days between 90 and 100, and the number of days above 100. The “lows” line item may have a number of sub-line items such as the number of days between 20 and 30, the number of days between 10 and 20, the number of days between 0 and 10, and the number of days below 0. The “degree days” line item may have a number of sub-line items such as cooling degree days and heating degree days. Cooling degree days may be calculated over a period of time by adding up the differences between each day's mean daily temperature and a “balance point” temperature (e.g., 18° C., 65° F.) and heating degree days may be calculated over a period of time by adding up the differences between each day's mean daily temperature and the “balance point” temperature.

The sixth region 512 may be in the form of an “internal” marketing message to announce or cross sell products complementary to utility usage analysis, the seventh region 514 may be in the form of cancellation information which provides information (e.g., phone number, email addresses) to cancel the product (e.g., stop receiving such emails) and provide compliance such as that in accordance with the CAN-SPAM Act of 2003, and the eighth region 516 may be in the form of an intellectual property protection message (e.g., highlighting patent, trademark and copyright information to protect intellectual property rights). It will be appreciated that the various regions disclosed herein may be arranged in numerous other positions other how such regions have been described herein. Moreover, in some embodiments, users can request that some regions be deleted from such email messages while other regions are added to the email messages.

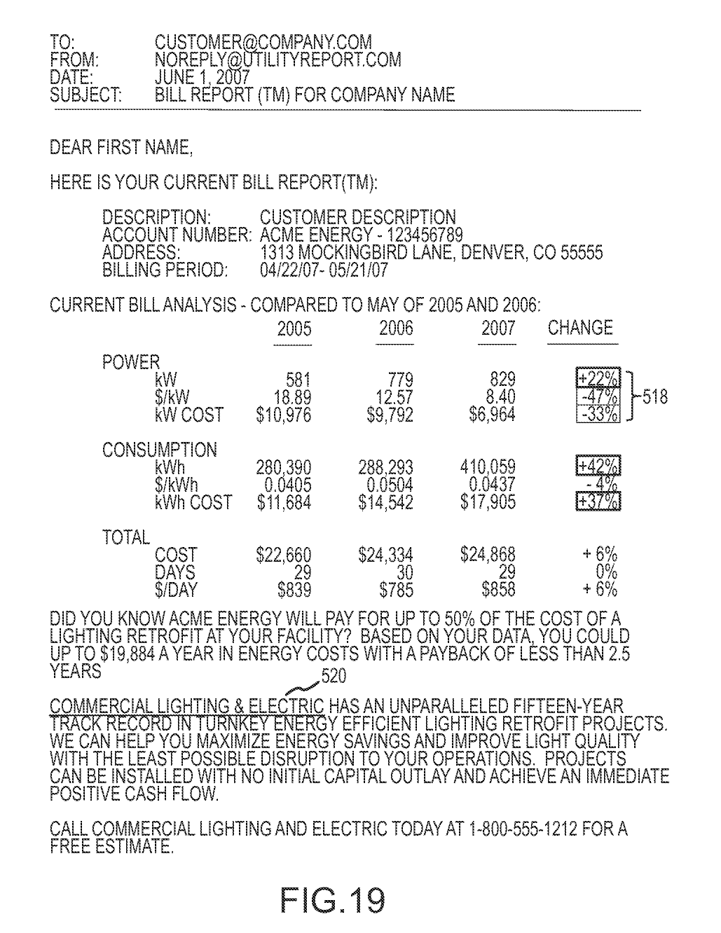

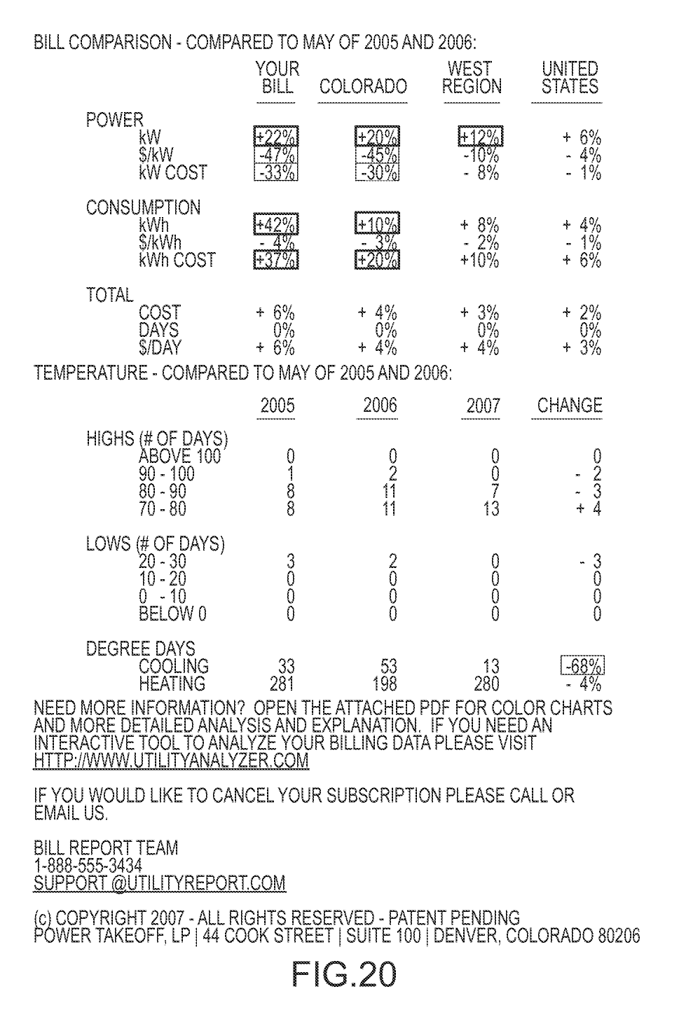

A second embodiment of the user interface 500 is illustrated in FIGS. 19 and 20 and similar features are indicated with similar reference numerals. The second embodiment may be in the form of an email message which may utilize any appropriate number of columns (e.g., 72 columns). The email message may be delivered to a customer's email address in a MIME (Multipurpose Internet Mail Extensions) format that includes HTML email and as well as plain-text versions. While most customers may view the HTML version, others may see the plain-text version if their email client is not capable of reading HTML emails. In some situations, the plain text version may continue to be sent to the customer's mobile device.

Some portions of the second embodiment of the user interface 500 may include any appropriate formatting for highlights. For instance, one or more regions (e.g., second region 504) may include at least one highlighted background 518 that may serve to indicate whether a value is above, equal to or below a reference value. As seen in FIG. 19, one form of highlighted background 518 may be in any appropriate first color (e.g., red) and another form of highlighted background 518 may be in any appropriate second color (e.g., green). The red color may indicate that the value is more than the reference value while the green color may indicate that the value is less than the reference value. The user may be able to adjust the reference value either manually within the email or else by way of contacting the email sender. Some portions of the second embodiment may include any appropriate hyperlinks 520 that may be operable to quickly link the user to the website of an advertisement host, a cancellation website, and the like by way of any appropriate user manipulable device (e.g., cursor).

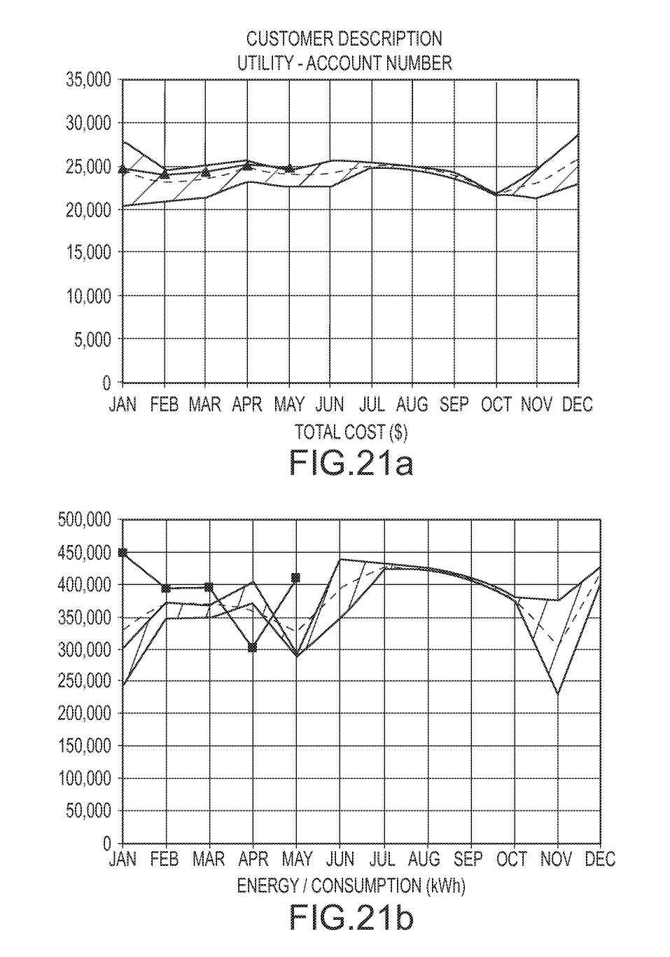

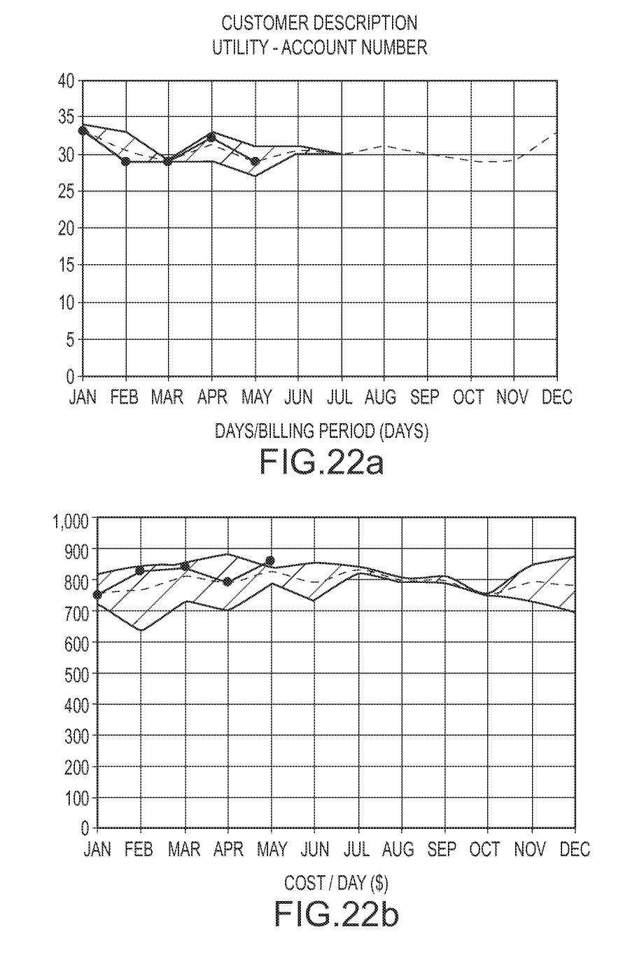

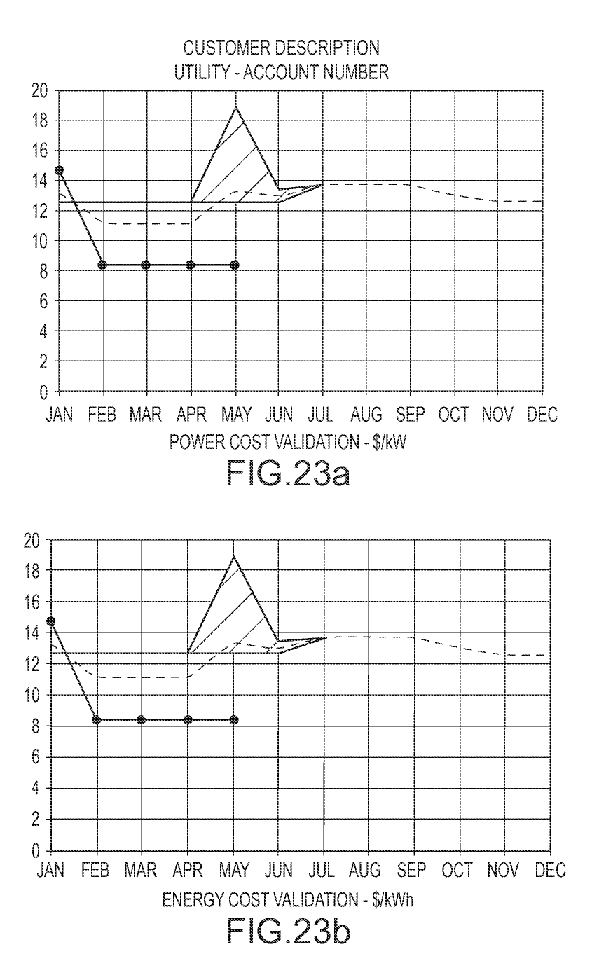

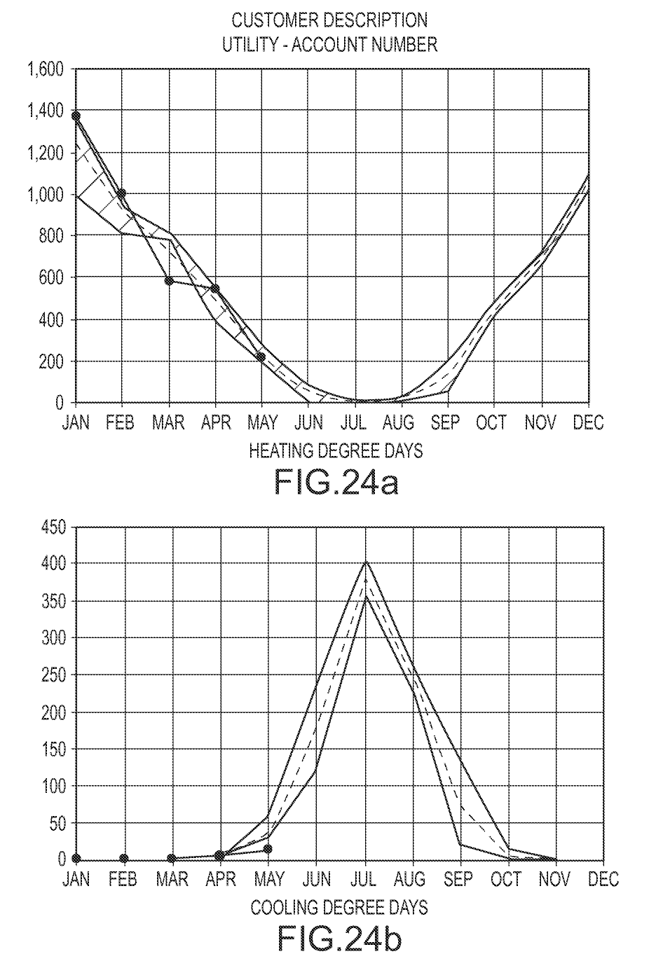

A third embodiment of the user interface 500 may be either of the first and second embodiments in combination with one or more PDF attachments each of which may include color charts (e.g., non-interactive) that may display historical trend information among other information. The PDF format advantageously may provide a uniform printing capability for many customers. With reference to FIGS. 21-25, a PDF attachment to the plain-text and/or HTML email may provide a customer with a historical plot, chart or graph of one or more variables such as Total Cost ($), Energy/Consumption (kWh), Days/Billing Period (Days), Cost/Day ($), Power Cost Validation ($/kW), Energy Cost Validation ($/kWh), Heating Degree Days, Cooling Degree Days, Average Temperature (° F.) and Total Precipitation (inches H2O).

Each chart may provide “two plus” years of data, the current year-to-date trend and the two previous years as a historical reference, although other numbers of previous years may be used as a historical reference. With respect to FIGS. 21-25, a portion of the background of the chart (e.g. the light green area) may represent the high and low historical range for the previous two years for the given variable, the solid, dark line with markers is the year-to-date trend for the current calendar year, and the dashed line (or other patterned line) is the average of the previous two calendar years and the year-to date values of the current year. The above-described design consolidates up to three years of data (or additional years of data) into a chart that can be understood at a glance for any variable.

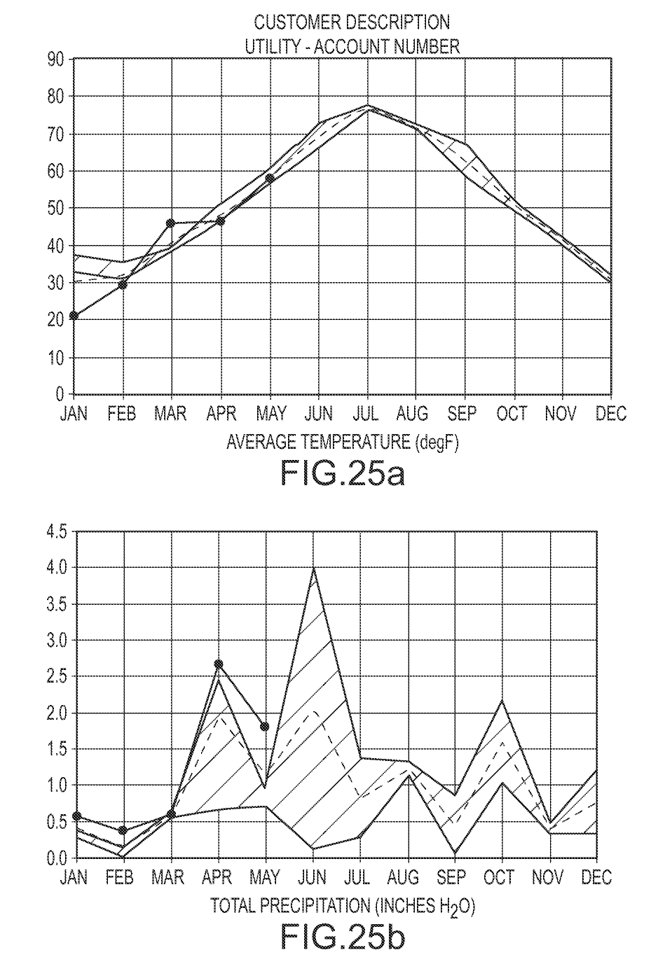

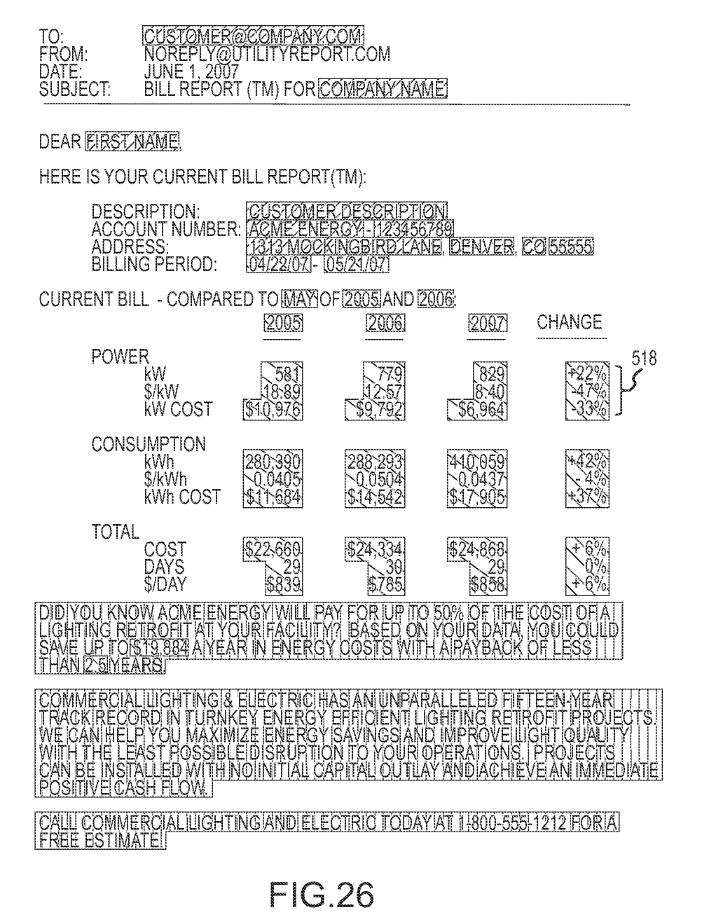

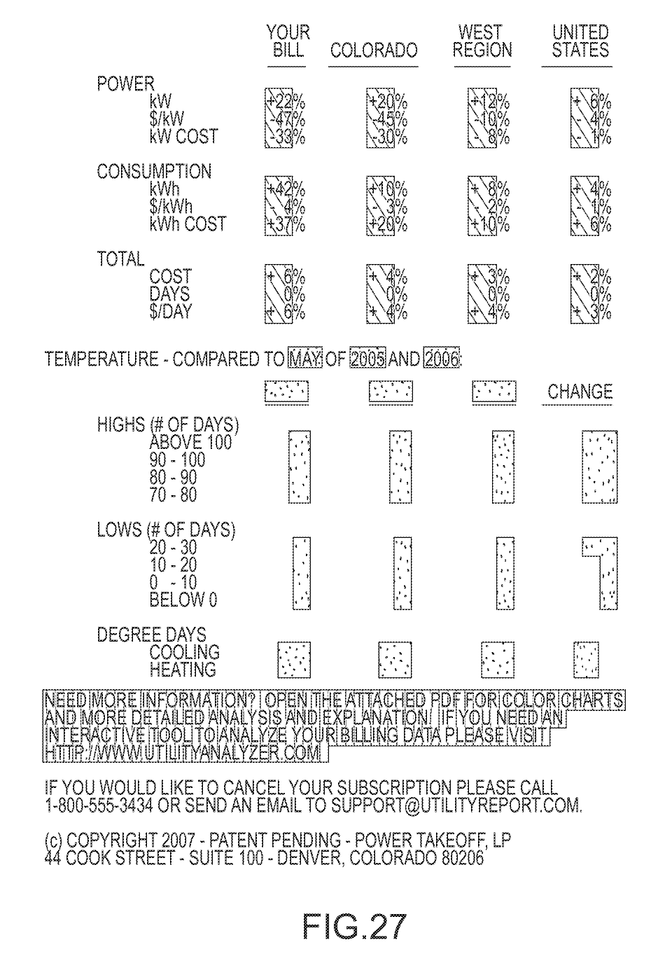

As previously discussed, the report module may work in conjunction with or otherwise access the email server 132 for the creation of the email messages. FIGS. 26 and 27 illustrate the type and location of various pieces of data in each email message. Specifically, the email messages created by the report module may be created from several different sources of data as illustrated in FIGS. 25 and 26. The green color represents information retrieved from a customer database, the yellow color represents information retrieved from historical and current billing data, the purple color represents information retrieved from historical weather data, the blue color represents information retrieved from marketing data, and the gray color represents a 72 column ruler for a plain-text email message. The report module disclosed herein advantageously assists in delivering clean and unintimidating utility usage analysis to decision-makers who often only have minutes to scan information. As the emails are sent to a customer's inbox, the customer need not remember any usernames or passwords.

Meter Module:

The meter module generally operates to create and send utility usage analysis tools and/or other messages (e.g., text, SMS, instant) to users (e.g., customers) regarding utility usage. For instance, the tools may be appropriately attached to one or more Email messages. The tools and messages may be sent according to any user configurable schedule (e.g., daily, monthly), any billing schedule (e.g., monthly) or even when new data (e.g., interval and/or billing data 12, 16) has been received in the server system 8. For instance, one utility usage analysis tool may be in the form of a spreadsheet report that may be written on a ubiquitous software platform (e.g., Microsoft Excel) so that must users need not download and/or install any other software to view and interact with the report. The spreadsheet report may also be designed to be compatible with various versions of the platform (e.g., “classic” version including Excel 2000, 2002 (XP) and 2003, “new” version including Excel 2007). The meter module may take advantage of the processing power of the user's local computing system for optimum performance. In one embodiment, an Excel spreadsheet may utilize Visual Basic for Applications (VBA) to improve the user experience and minimize the size of the spreadsheet report. As will be described below, data for each spreadsheet report may be automatically downloaded and acquired from the server system 8 (e.g., central data server 10) via the Internet upon opening the spreadsheet attachment. As the data is acquired via the Internet, it may generally be available for downloading at any time.

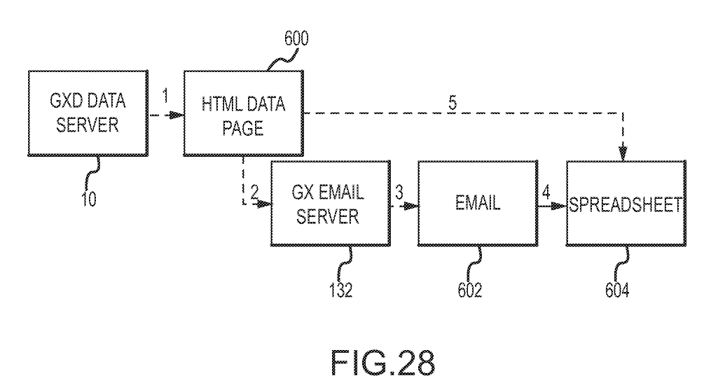

FIG. 28 illustrates a data flow from the central data server 10 of the server system 8 eventually into the spreadsheet on the user's local computing system. When new data (e.g., interval, billing) is received (or according to some user configurable schedule) in the central data server 10 for a particular user or customer, the central data server 10 or other component of the server system 8 may perform a number of functions on the new data. As previously discussed, the new data may be appropriately cleaned through the UIDS and/or UBDS. Moreover, the server system 8 may also “slice and dice” (e.g., parse) or otherwise perform “high-resolution allocation” on the new data. For instance, the server system 8 may transform billing data from billing periods into time periods (e.g., calendar periods), and/or utilize interval data to allocate financial data. As an example, assuming each interval of a quantity of interval data is 15 minutes, and knowing that there are 96 intervals per day, that equates to 2,880 intervals for 30 days (e.g., 30×96). Thus, instead of allocating the 30 day billing period equally across 30 days, it may be allocated proportionally across 2,880 intervals. The above-described allocation may create a more accurate financial depiction of utility changes as operational demands may vary on various facilities based on weekends, holidays, special events, production schedules, and the like.

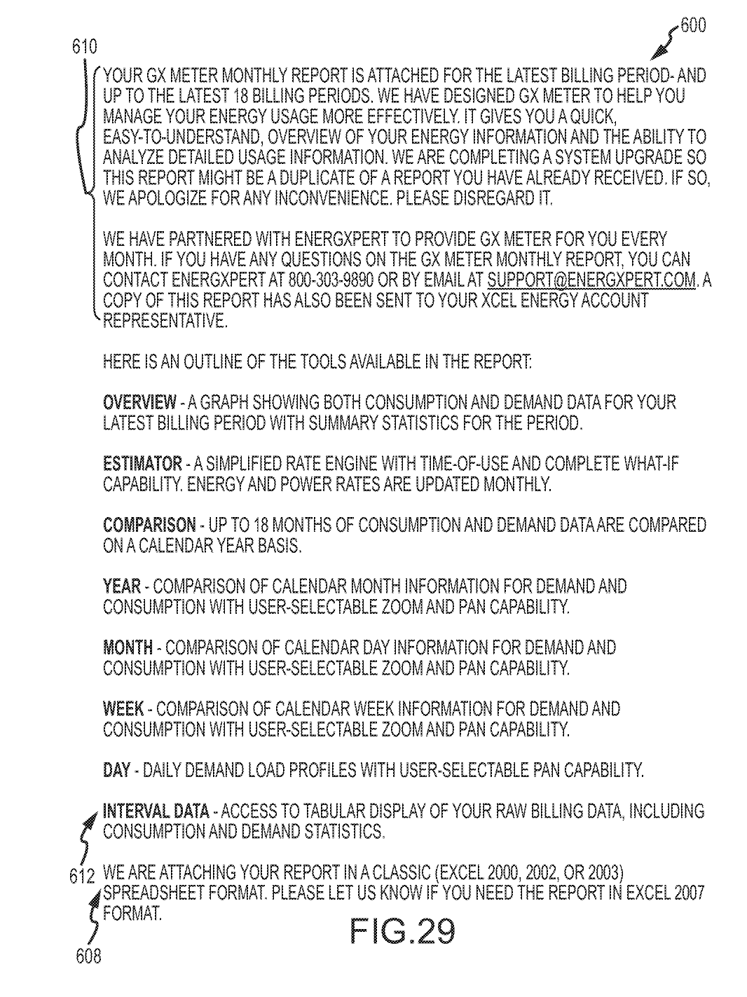

After the server system 8 has performed such functions, the central data server 10 may appropriately create a web-based data page (e.g., HTML data page) including, for instance, the newly received data that may include a unique URL (e.g., web address) for the customer. Upon or after creation of the HTML data page, a trigger may be sent to the email server 132 (by the central data server 10 or other component) alerting the email server 132 to create and transmit an email to one or more users. Specifically, the email server 132 may create and send one or more emails 602 with one or more utility usage analysis tools (e.g., spreadsheet attachment 604) to one or more users for a meter of a facility or other structure. In some embodiments, some users may receive individual emails 602 (as opposed to mass emails) in case they require different spreadsheet attachment 604 versions for their local computing system. Each email may have a spreadsheet attachment 604 with the unique URL for the HTML page embedded into the spreadsheet attachment 604. Upon opening the spreadsheet attachment 604, a “web query” function may be used to import data into the spreadsheet attachment 604 from the HTML page via the unique URL. As the spreadsheet attachment 604 is not a web-based program, the customer or user only needs Internet access the first time the customer or user opens the spreadsheet attachment 604 in order to retrieve data. However, assuming the customer has at least somewhat continuous Internet access, the web query function may be appropriately configured to automatically check for new data using the unique URL every predetermined time period (e.g., 15 minutes). Such newly acquired data may be appropriately incorporated into the various analyses of the spreadsheet attachment 604 (e.g., the spreadsheet attachment 604 may be “refreshed”). It should be appreciated that as the server system 8 or email server 132 does not transmit the data as part of the email message or spreadsheet attachment 604, file sizes can be kept within acceptable limits and system functionality can be increased. Furthermore, the meter module takes advantage of push technology which appropriately transmits data to users as soon as it is received in the central data server 10. FIG. 29 presents an email report screen 606 that may be appropriately sent to a user or customer with a spreadsheet attachment 604 according to a monthly schedule. A body 608 of the screen 606 may include one or more sections each conveying different types of information and as shown, may include first and second sections 610, 612. The first section 610 may be in the form of an introduction informing the recipient that the spreadsheet attachment 604 is attached and providing contact information for usage concerns. The second section 612 may be in the form of an outline of tools available in the spreadsheet attachment 604 (e.g., overview, estimator). The body 608 may include other types of information as well such as instructions on how to use the spreadsheet attachment 604, updates from the utility and marketing information. The body 608 may be in the form of a plain-text or HTML type email including images, hyperlinks and/or text.

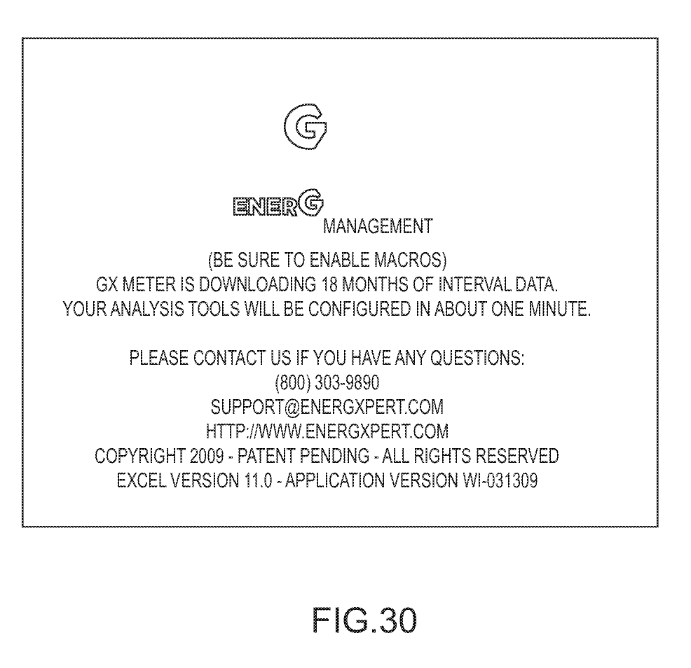

After receipt of the message (e.g., email), the new data (e.g., billing and/or interval) may begin downloading from the server system 8 (e.g., central data server 10) onto the user's local computing system upon opening the spreadsheet attachment (e.g., via the web query function). In some embodiments, the spreadsheet attachment 604 may include embedded macros (e.g., instructions represented in an abbreviated format) and thus a user may need to enable macros on the local computing system. In other embodiments, the user may be required to adjust security settings to any appropriate level (e.g., medium). Upon opening the spreadsheet attachment 604, any appropriate splash page (e.g., the splash page of FIG. 30) may be displayed on the display 1016 (see FIG. 2) of the user's local computing system. The splash page may inform the user that, inter alia, data is downloading in the background and of version and support information.

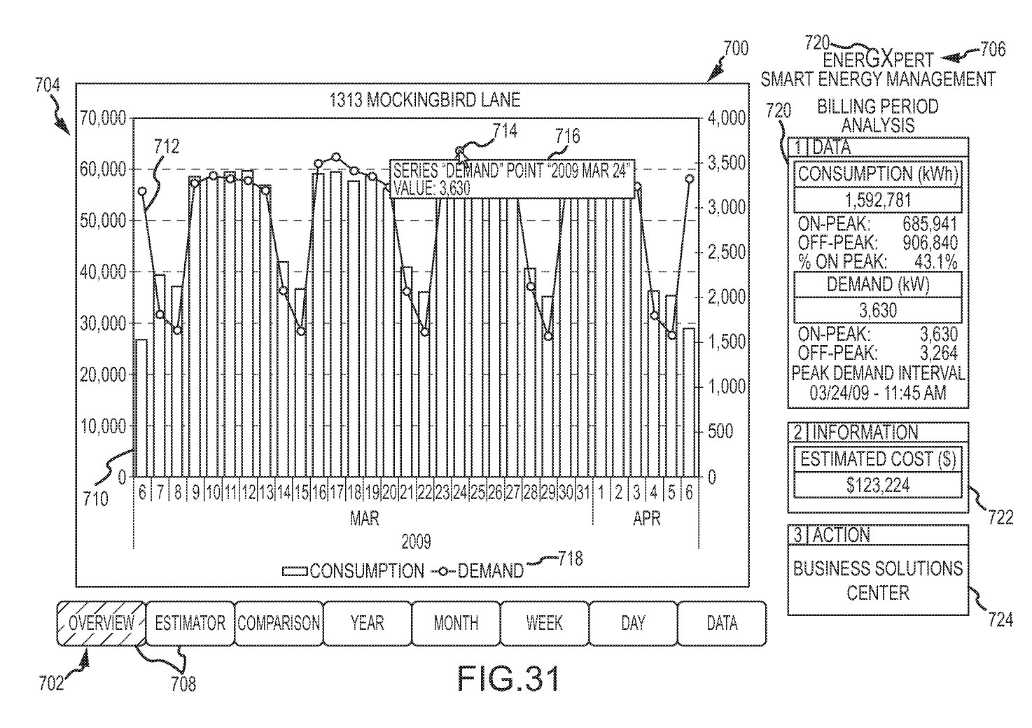

With reference to FIG. 31, an “overview” screen of a user interface 700 of the spreadsheet attachment 604 (e.g., monthly) may be presented once the data (e.g., billing, interval) has finished downloading from the server system 8. The user interface 700 may include any appropriate number of menus, icons, pointing devices (e.g., cursors) and/or windows, for instance. Moreover, the user interface 700 may be manipulated in any appropriate manner including without limitation stylus, mouse, a user's appendage (e.g., finger), voice or eyes, etc. The user interface 700 may include one or more screens (e.g., Overview screen, Estimator screen), each of which may include any appropriate number of regions (e.g., graphical display regions). Moreover, each of the graphical display regions may be operable to convey various types of information to a user and/or allow the user to manipulate the user interface 700. For instance, the user interface 700 may include first, second and third graphical display regions 702, 704, 706, each of which may include any appropriate number of boxes, cells, sections, tables, graphs, etc.

The first graphical display region 702 may be in the form of a “navigation area” including one or more navigation tabs or buttons 708. Each of the navigation buttons 410 may be appropriately manipulable or selectable and may direct a user to a different analysis tool on a different page or sheet. When a user appropriately selects a navigation button 708, the selected button 708 may be appropriately indicated and/or differentiated from the other buttons 708 to indicate the selection. For instance, the selected button 708 may acquire a background of one color (e.g., dark grey) while the remaining buttons may all acquire a background of a different color (e.g., light grey).

The second graphical display region 704 may be in the form of an “analysis area” which may provide the primary analysis area on each page depending upon the selected navigation button 708, and in this regard may include one or more graphical representations (e.g., line graphs, pie charts, spreadsheets, matrices). The second graphical display region 704 may include one or more regions, sections, quadrants, and the like. As illustrated, the second graphical display region 704 may be in the form of a graphical representation that may represent utility usage over one or more time periods (e.g., the current time period). For instance, energy consumption in kWh may be represented with bars 710 while power demand in kW may be represented with a line 712. The downloaded data includes utility usage data for each day of the current time period and in this regard, the bars 710 and lines 712 include a number of data points each of which represents the utility usage on such days. As shown, the bars and scale (e.g. left y-axis) for energy consumption may be similarly patterned or colored (e.g., in blue) to facilitate interpretation of the graphical representation by the user. Similarly, the lines and scale (e.g., right y-axis for power demand may be similarly patterned or colored (e.g., in red). A user may utilize any appropriate user manipulable feature 714 (e.g., cursor) using any user manipulable device (e.g., mouse, finger, eye gaze) to obtain additional information regarding the graphical representation. For instance, the user may move the user manipulable feature 714 over one or more data points to cause the display of a pop-up window 716 with information such as the date and value of the data point. Any appropriate legend 718 may also be included. While energy consumption and power demand are discussed in this embodiment, it will be appreciated that data from other forms of utilities such as natural gas consumption, water consumption and the like may also be utilized as part of the meter module.

The third graphical display region 706 may integrate summary utility usage data as well as marketing and environmental messages and other functionality. As shown, the third graphical display region 706 may include first, second and third sections 720, 722, 724 that will be described in course. The first section 720 may include summary statistics for energy consumption and power demand including on-peak (e.g., weekdays) and off-peak (e.g., weeknights and weekends) information and the date and time of the peak interval. The energy consumption and power demand information may include coordinated patterning and/or coloring (e.g., blue and red) to portions of the second graphical display region 704. The second section 722 may include an estimated cost for the current billing period based on the total from the “Estimator” page (described in more detail below). The third section 724 may include one or more marketing messages that may be customized for the specific user. In this regard, the meter module may work in conjunction with the marketing server 136 to customize one or more marketing messages or advertisements based on profile and demographic information of the user or recipient of the spreadsheet report attachment. One or more graphics or logos 726 may also be included in the user interface 700.

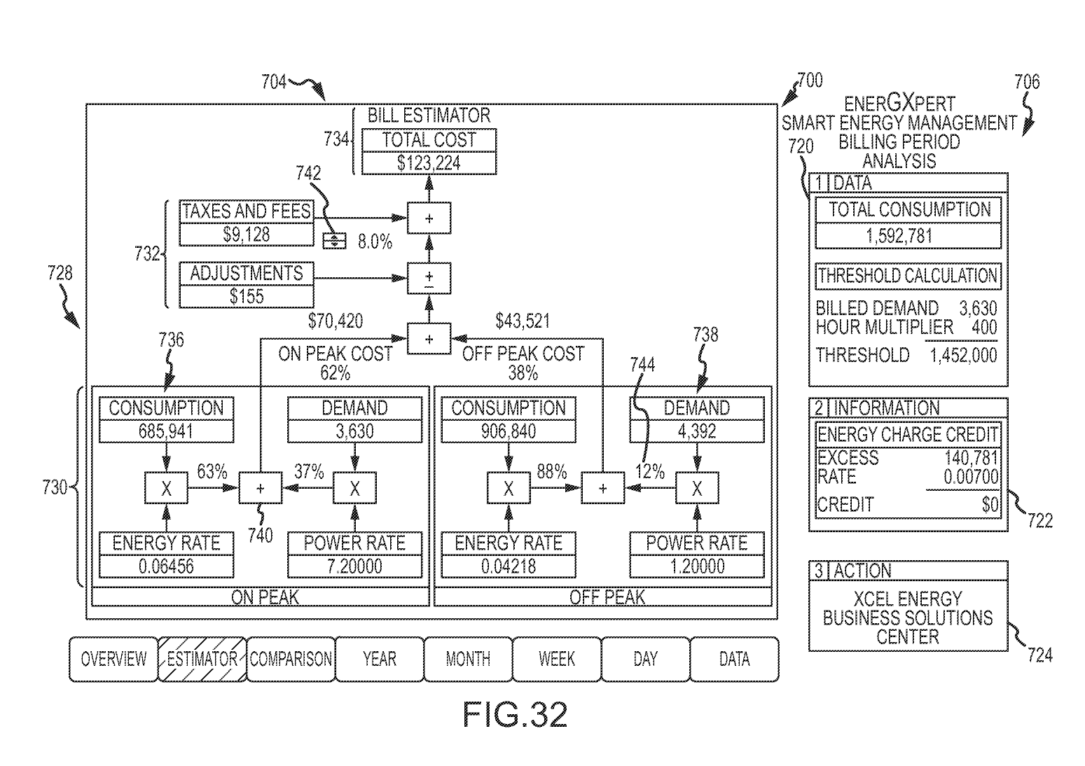

An “estimator” screen of the user interface 700 of the spreadsheet attachment 604 is illustrated in FIG. 32. In this screen, the second graphical display region 704 may be generally organized to present the user with a simplified estimate of their current bill and more specifically, with a graphical step-by-step calculation 728 of the current bill. The estimator screen may be useful for assisting a customer in understanding and anticipating the various components of a bill before the bill is sent or otherwise transmitted to the customer. For instance, the graphical step-by-step calculation 728 may include any number of inputs such as first and second regions 730, 732 and an output such as third region 734 (e.g., total cost).

The first region 730 may provide a graphical representation (e.g., numerical, textual) of energy consumption and power demand respectively multiplied by an energy rate and a power rate (which may be appropriately periodically updated by the utility provider), and the resultant values being added together. The first region 730 may include one or more sub-regions such as first and second sub-regions 736, 738, the first sub-region operable to display calculations for on-peak energy consumption and power demand cost and the second sub-region 738 operable to display calculations for off-peak energy consumption and power demand cost. The second region 732 may include one or more sub-regions with graphical representations of adjustments (e.g., past due bills) as well as taxes and fees. The third region 734 may provide a graphical representation of the total cost, or in other words, the sum of the value from the calculations displayed in the first region 730 and the value from the calculations in the second region 732.

One or more calculation or operator symbols 740 may be interspersed throughout the graphical step-by-step calculation 728 to facilitate a user's understanding of the various calculations making up the customer's bill. Also, one or more user manipulable features 742 (e.g., up and down arrows, drop down menus) may be used to modify one or more values in the graphical step-by-step calculation 728 by way of a cursor or the like. Moreover, the “blue/red” color scheme (or other scheme) discussed as part of the overview screen may also be utilized in the estimator screen, and one or more percentage graphics 744 may be illustrated in the graphical step-by-step calculation 728 where appropriate. It will be appreciated that the structure of the rate calculations may vary for each utility and each jurisdiction within each utility.

The first and second sections 720, 722 of the third graphical display region 706 may include summary information such as graphical representations of total consumption as well as a power demand threshold calculations and any energy charge credits. Stated otherwise, such representations may illustrate adjustment calculations for high load factor customers.

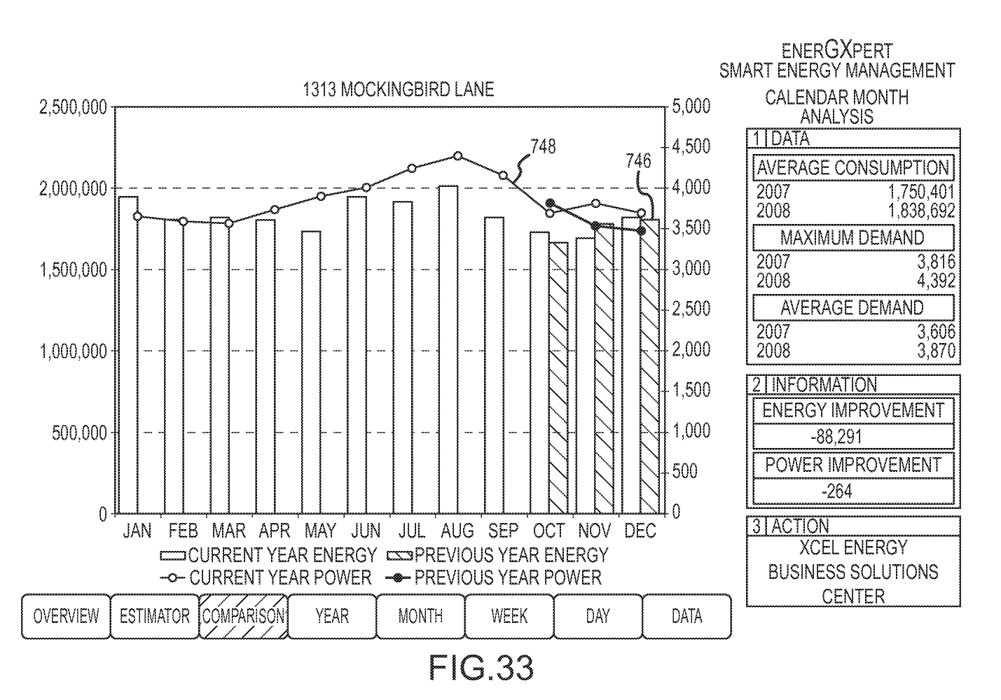

A “comparison” screen of the user interface 700 of the spreadsheet attachment 604 is illustrated in FIG. 33. In this screen, the second graphical display region 704 may be similar to that of the overview screen of FIG. 31 except that the energy consumption and power demand information may be displayed in a monthly format from January-December with the current and previous years side by side or otherwise generally near each other. For instance, additional bars 746 and lines 748 may be displayed within the second graphical display region near the bars and lines 710, 712 to represent the data of one or more previous years. The first section 720 of the third graphical display region 706 may include any appropriate summary statistics for the time periods (e.g., years) displayed in the second graphical display region 704 such as average consumption, maximum demand and average demand. The third section 722 may include energy improvement and power improvement (if any) which may be determined by subtracting current year average energy consumption and power demand from the previous year's average energy consumption and power demand or in other appropriate manners.

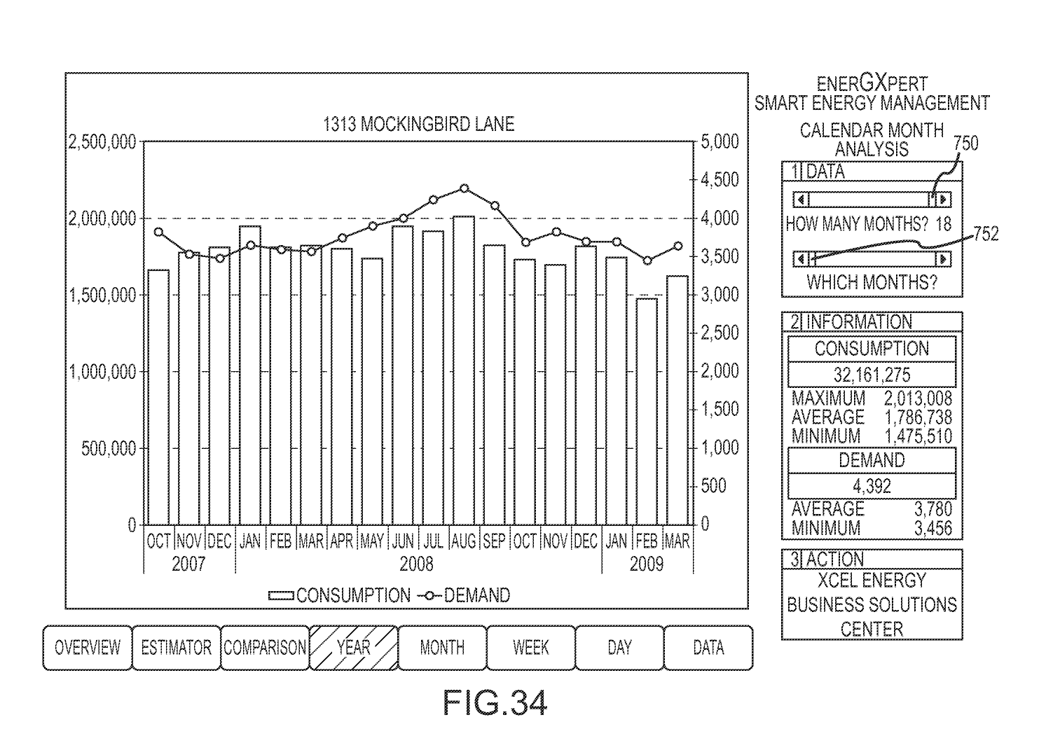

A “year” screen of the user interface 700 of the spreadsheet attachment 604 is illustrated in FIG. 34. In this screen, the second graphical display region 704 may be similar to that of the overview and comparison screens of FIGS. 31 and 33 except that energy consumption and power demand information may be displayed for up to 18 months (and in some embodiments more than 18 months of data). Stated otherwise, a user may appropriately interact with the user interface 700 to selectively display from one month up to 18 months of data (e.g., energy consumption and power demand information). The first section 720 of the third graphical display region 706 may include one or more user manipulable features each of which may be operable to adjust a portion of the graphical representation (e.g., chart) in the second graphical display region 704. For instance, the first section 720 may include a first scroll bar 750 that when “slid” may allow a user to zoom into the chart or otherwise modify the number of months of data that is displayed. The first section 720 may also include a second scroll bar 752 that when slid may allow a user to “pan” left or right or otherwise modify which specific months are presented in the second graphical display region 704. Other forms of user manipulable features may also be presented in the first section 720. The second section 722 of the third graphical display region 706 may include any appropriate summary statistics regarding the data displayed in the second graphical display region 704. Thus, a user may select custom time periods such as quarters or year to date (e.g., via the scroll bar 750) for summary statistics information.

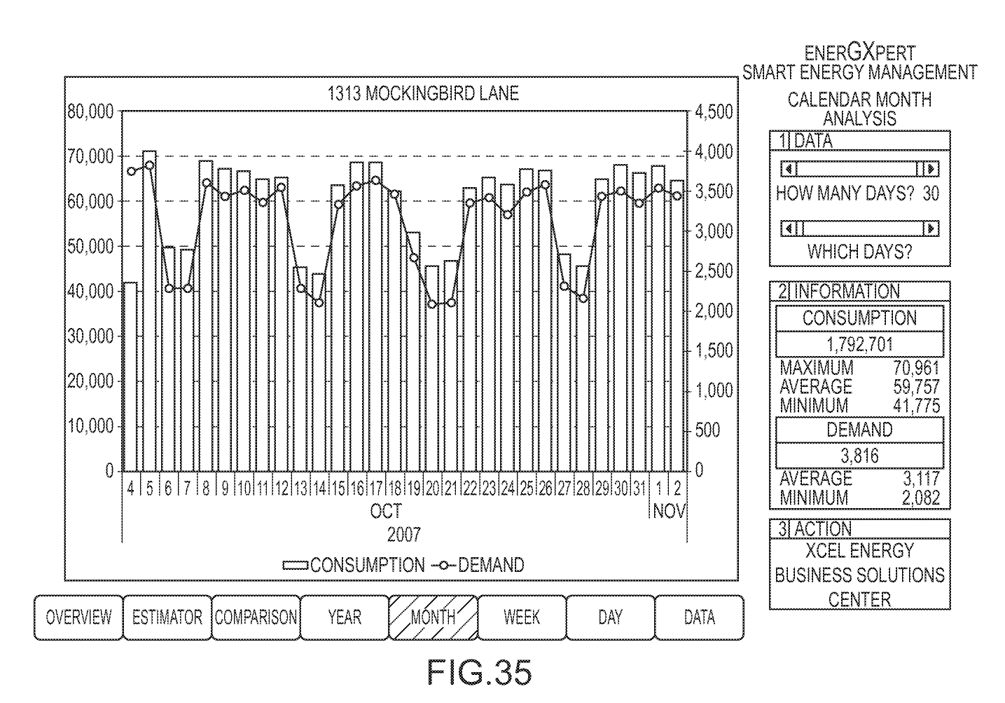

A “month” screen of the user interface 700 of the spreadsheet attachment 604 is illustrated in FIG. 35. In this screen, the second graphical display region 704 may be similar to that of the year screen of FIG. 34 except that energy consumption and power demand information may be displayed for up to 32 consecutive days (and in some embodiments more than 32 consecutive days). This screen may assist users in understanding the energy consumed on production runs.

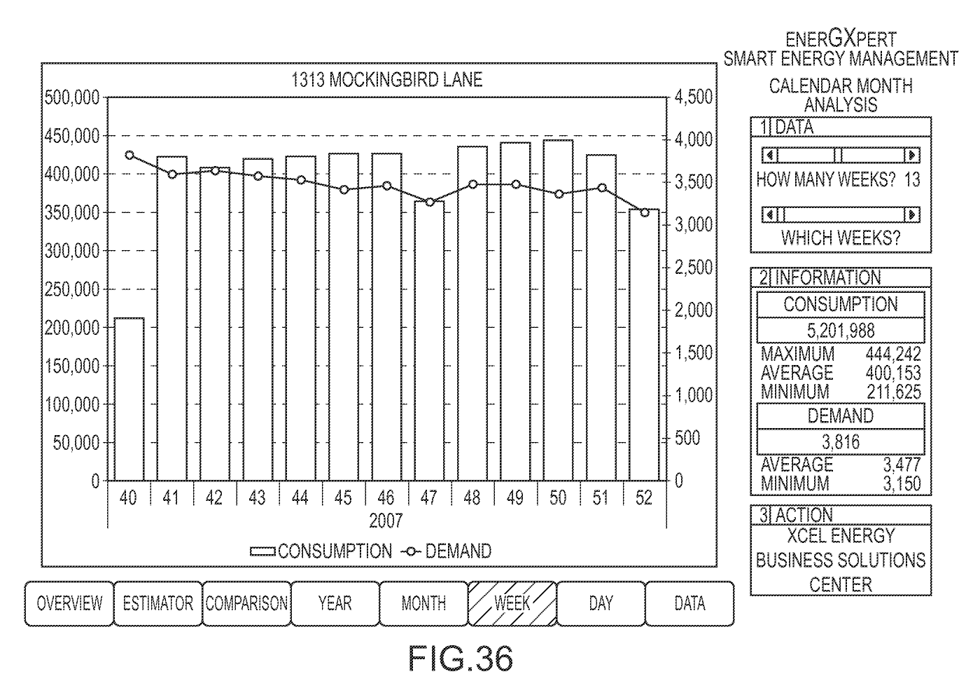

A “week” screen of the user interface 700 of the spreadsheet attachment 604 is illustrated in FIG. 36. In this screen, the second graphical display region 704 may be similar to that of the month screen of FIG. 35 except that energy consumption and power demand information may be displayed for up to 26 consecutive weeks (and in some embodiments more than 26 consecutive weeks). This screen may assist users in appropriately grouping week periods (e.g., 13 week periods) for accounting and financial analysis.

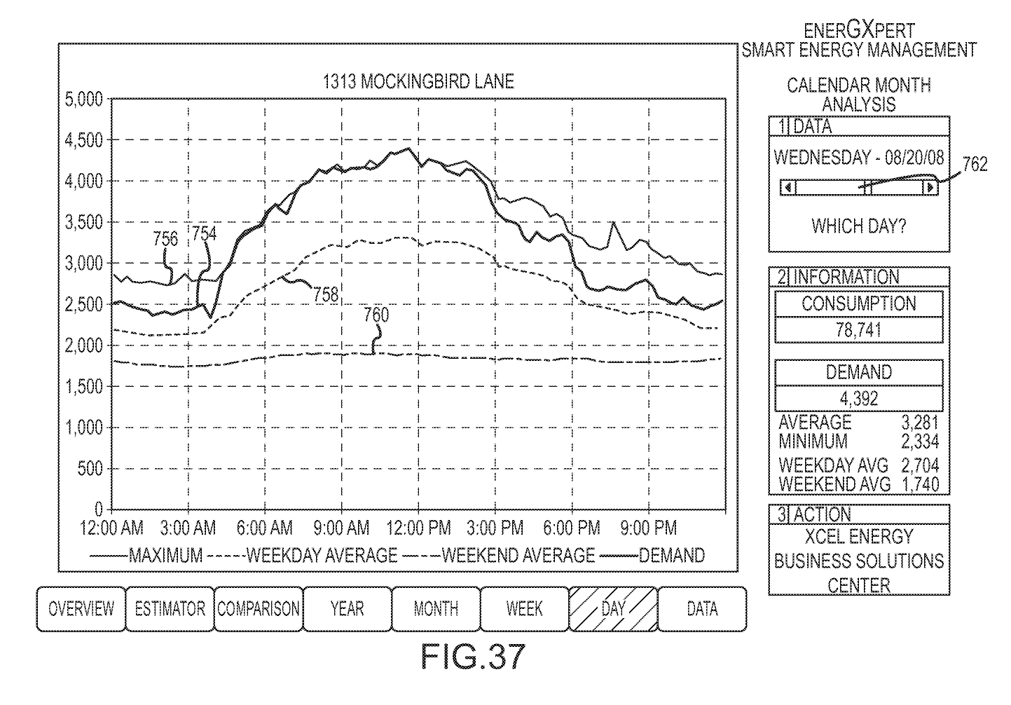

A “day” screen of the user interface 700 of the spreadsheet attachment 604 is illustrated in FIG. 37. In this screen, the second graphical display region 704 may present a kW load profile of power information for one or more days. The second graphical display region 704 may be in the form of a line graph with a number of lines representing various aspects of power. For instance, the second graphical display region 704 may include a first line 754 (e.g., a solid red line) representing the power along with the correspondingly colored scale or axis. A second line 756 (e.g., a thick solid dark green line) may represent the maximum for each interval (e.g., 5 min, 15 minute) for all days. A third line 758 (e.g., a thick dashed green line) may represent the weekday average and a fourth line 760 (e.g., a thin dashed green line) may represents the weekend average for all days. It will be appreciated that other aspects of power as well as other forms of utility usage may be displayed in the second graphical display region 704.

The first section 720 of the third graphical display region 706 may include a scroll bar 762 that when slid may allow a user to “pan” left or right or otherwise modify which specific day is presented in the second graphical display region 704. Users may advantageously be able to determine when and how much equipment was operated during each utility interval. Any appropriate statistics may be displayed in the second section 722 of the third graphical display region 706.

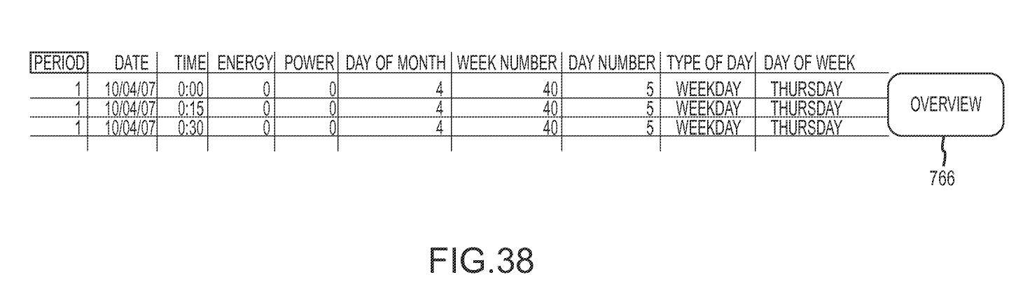

A “data” screen of the user interface 700 of the spreadsheet attachment 604 is illustrated in FIG. 38. In this screen, the first, second and third graphical display regions 702, 704, 706 have been replaced with a single display region 764 that may present all of the raw data used for computations, analysis and charting in the spreadsheet attachment of the meter module. The single display region 764 may be in the form of a grid or matrix that contains the above-mentioned raw data. For instance, there may be any appropriate number of rows of data, each row representing any appropriate interval of utility usage data. For instance, in one embodiment there may be approximately 54,000 rows of data contained in the spreadsheet representing 18 billing periods (one billing period equates to approximately one month). As the display region 764 is already in grid or spreadsheet form, the data may be copied and pasted to another spreadsheet (e.g., Excel) if a user desires to perform additional analyses. The display region 764 may have one or more user manipulable features such as button 766 that when manipulated will return the user to the “overview” screen or other appropriate screens.

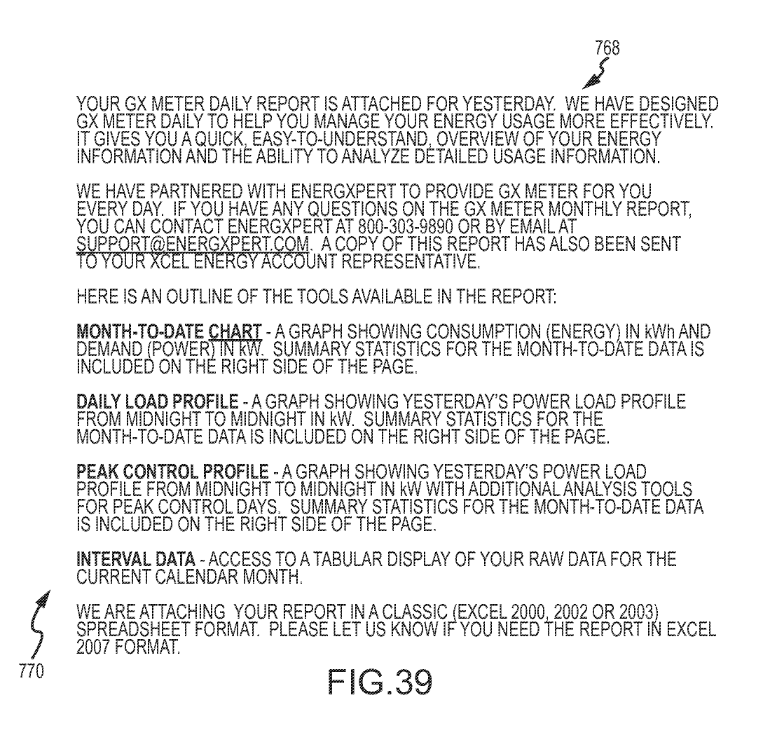

FIG. 39 presents an email report screen 768 that may be appropriately sent to a user or customer with a spreadsheet attachment 604 according to a daily schedule. The daily email report screen 768 may include a body 770 with one or more sections each conveying different types of information. As the body 770 may include similar types of information as the monthly email report screen 606 of FIG. 29 (e.g., introduction, outline of available tools), the daily email report screen 768 will not be further discussed. Moreover, any appropriate “splash” page may be displayed while the user is waiting for utility usage data to download from the server system.

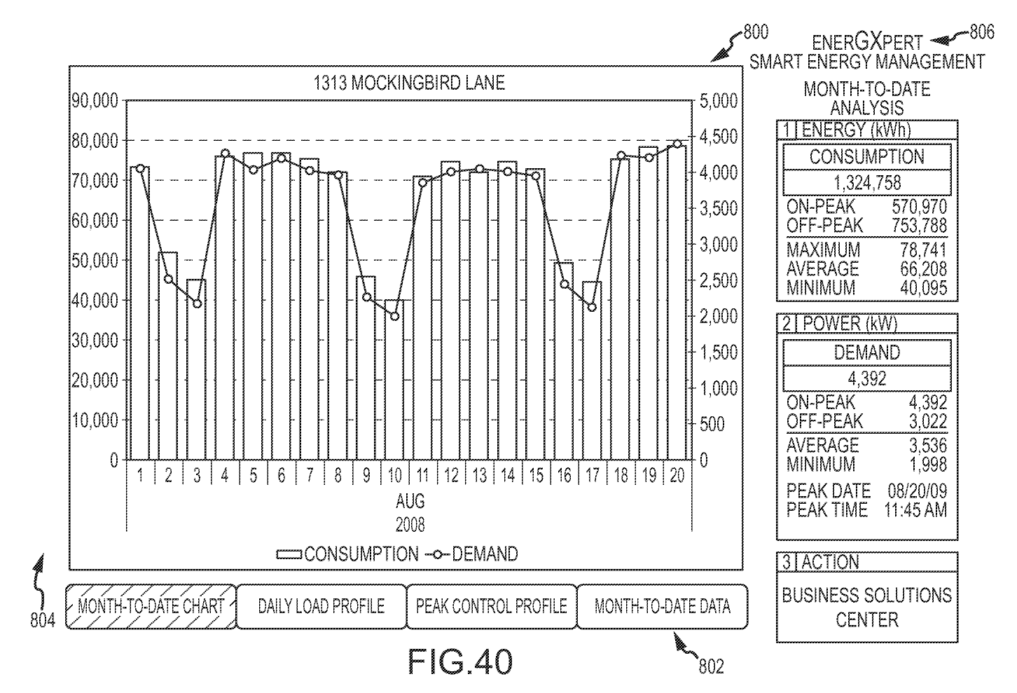

With reference to FIG. 40, a “month-to-date chart” screen of a user interface 800 of a spreadsheet attachment 604 sent daily to one or more users may be presented once the data (e.g., billing, interval) has finished downloading from the server system 8. The user interface 800 may include any appropriate number of menus, icons, pointing devices (e.g., cursors) and/or windows, for instance. Moreover, the user interface 700 may be manipulated in any appropriate manner including without limitation stylus, mouse, a user's appendage (e.g., finger), voice or eyes, etc. The user interface 700 may include one or more screens, each of which may include any appropriate number of regions (e.g., graphical display regions). As with the user interface 700 of FIG. 31, the user interface 800 may include a first graphical display region 802 in the form of a “navigation area”, a second graphical display region 804 in the form of an “analysis” area, and a third graphical display region 806 with summary statistics, user manipulable features (e.g., drop down menus, scroll bars), marketing messages and the like.

The second graphical display region 704 may include one or more graphical representations (e.g., line graphs, pie charts, spreadsheets, matrices) representing any appropriate utility usage information such as energy consumption in kWh and power demand in kW for the current month. As with the user interface 700 of FIG. 31, energy consumption may be represented with blue bars and a blue scale on the left side of the chart and power demand may be represented with a red line and a red scale on the right side of the chart. Moreover, the user may move any user manipulable feature (e.g., cursor) over any point on the chart and reveal the values via a pop-up menu (not shown). However, as the user interface 800 is received as an email attachment daily, each utility usage data points corresponds to each day of the current month up to the day just before or the day that the attachment was sent. As illustrated, the user interface 800 of FIG. 40 may represent a spreadsheet report received by a user on Aug. 21, 2008.

The third graphical display region 806 may include summary statistics for energy consumption including on-peak and off-peak information as well as maximum, minimum and average consumption, and power demand including on-peak and off-peak information and the date and time of the peak interval as well as maximum, minimum and average consumption.

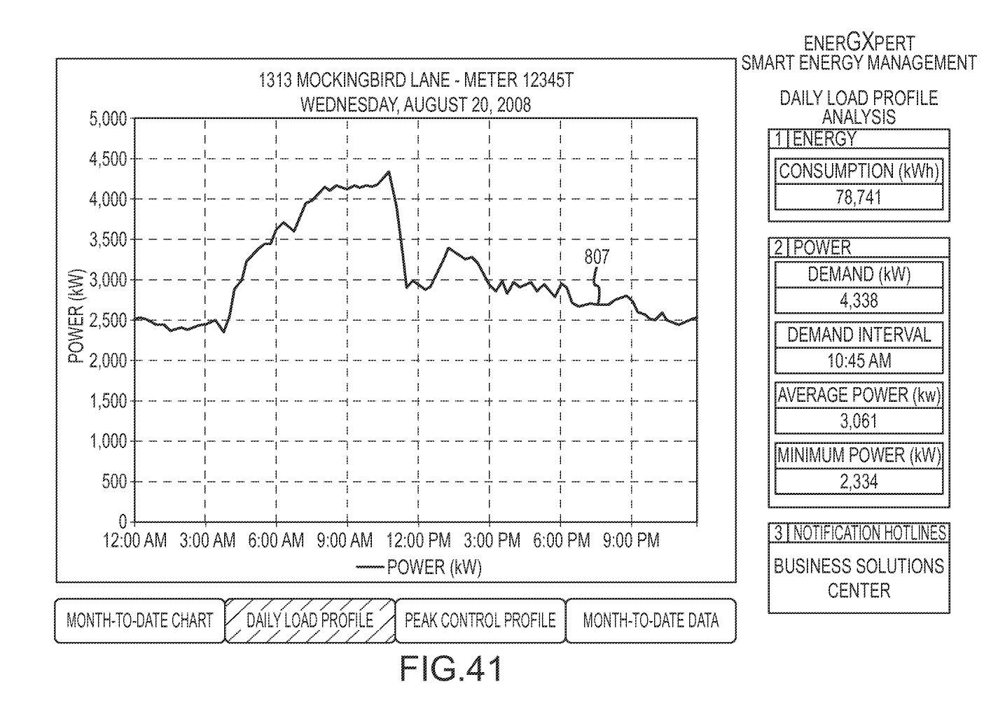

A “daily load profile” screen of the user interface 800 of the spreadsheet attachment 604 is illustrated in FIG. 41. In this screen, the second graphical display region 804 may be similar to that of the day screen of FIG. 37 except that the kW load profile of power information is for the previous day (e.g., the day immediately before the email server 132 sent the email with daily spreadsheet report attachment). The load profile may be represented by line 807. The third graphical display region 806 may include any appropriate summary statistics regarding utility usage information such as energy consumed in kWh, the demand in kW, the time of the peak demand interval, the average power in kW and the minimum power in kW.

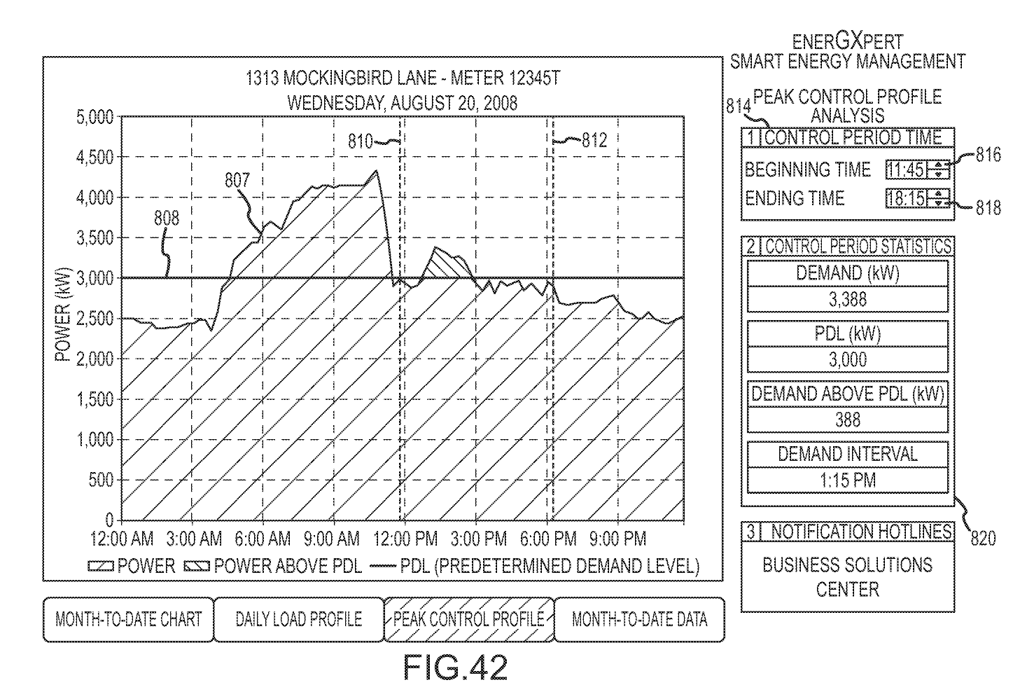

A “peak control profile” screen of the user interface 800 of the spreadsheet attachment 604 is illustrated in FIG. 42. In this screen, the second graphical display region 804 may be similar to that of the daily load profile of FIG. 41 except that the peak control profile screen allows a user to automatically highlight or otherwise indicate any portion of the profile that exceeds a predetermined demand level (PDL) between a beginning and ending time. For instance, the second graphical display region 804 may include a PDL line 808 which may correspond to some user defined or default demand threshold. The PDL line 808 may be of any appropriate patterns (e.g., solid) and in some embodiments may be manipulated by way of any appropriate user manipulable device (e.g., drop down menu, up and down arrows). The second graphical display region 804 may also include a beginning time line 810 and an ending time line 812 which may correspond to user defined beginning and ending times within which to measure for power demand exceeding the demand threshold. As can be seen in FIG. 41, any portion of the profile below the power demand line 807, above the PDL line 808 and between the beginning and ending time lines 810, 812 may be appropriately indicated in one manner (e.g., highlighted in red) while the rest of the profile may be appropriately indicated in another manner (e.g., highlighted in green).

A first section 814 of the third graphical display region 814 may include any appropriate user manipulable feature such as first and second sets of up and down arrows 816, 818 allowing a user to correspondingly adjust the beginning and ending time lines 810, 812 within the second graphical display region 804. A second section 820 of the third graphical display region 806 may include any appropriate summary statistics for the control period (e.g., day previous to receipt of email message from server system 8) such as the demand in kW, the PDL in kW, any demand above the PDL during the control period in kW, and the time of the peak demand interval during the control period in kW. Although not illustrated, a “month-to-date data” screen may be included that may include appropriate data used throughout the user interface 800 in a format similar to the data screen illustrated in FIG. 38.

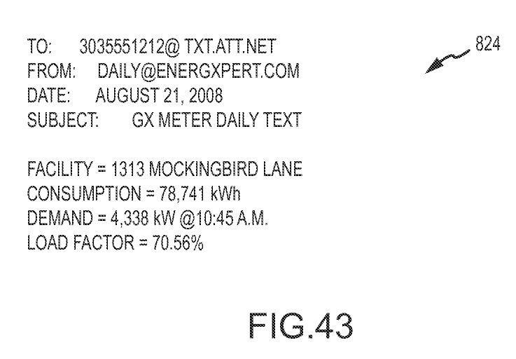

FIG. 43 illustrates an exemplary text message 824 (e.g., SMS message) that may be sent in parallel to the meter module daily spreadsheet attachment reports. The text message 824 may include summary information regarding one or more facilities that are the subject of the parallel daily spreadsheet attachment, and may be sent in a plain text or other format to a user's mobile device at a pre-defined time. The summary information may include facility information (e.g., address), energy consumption (e.g., maximum for previous day), power demand, (e.g., maximum for previous day) and load factor. It will be appreciated that the text message 824 may be generated in any appropriate manner and may be generated by any appropriate portion of the server system 8. In one embodiment, the trigger sent to the email server 132 upon creation of the HTML data page (see FIG. 28) to create the spreadsheet attachment and transmit and email the attachment may also trigger the email server 132 to create and send a corresponding text message 824 to a mobile device of the user. Other arrangements are also possible.

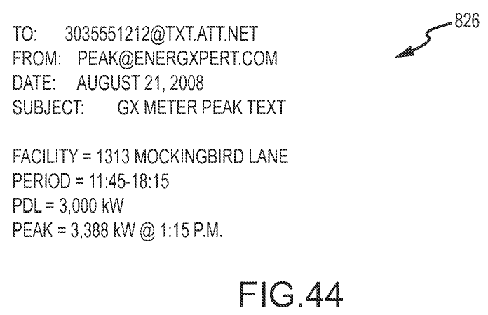

FIG. 44 illustrates another text message 826 that may be sent in parallel to the meter module daily spreadsheet attachment reports. However, the text message 826 may be customized for customers on peak control rates. For instance, this message may sometimes only be sent on control days or during peak control months (e.g., June through September).

It will be appreciated that the various features, aspects and components of the various screens of the above described meter module associated spreadsheet attachments may be appropriately modified or else incorporated into other screens or even other regions or sections of the same screen.

Bill Module:

The bill module generally operates to create and send utility usage analysis tools to users (e.g., customers) by way of, for instance, attaching such tools to email messages. For instance, the bill module may prepare or generate one or more spreadsheet reports or attachments on a ubiquitous software platform (e.g., Microsoft Excel) and may obtain utility usage data from the server system 8 in a manner similar to how the spreadsheet attachment 604 of the meter module obtains data (e.g., see data flow of FIG. 28). However, the bill module may be designed to incorporate enterprises with multiple accounts, multiple facilities and even multiple utilities into one or more integrated reports. Similar to the meter module, the bill module may consist of two components, namely, an email message and an attachment with interactive reporting capability that may be generated in conjunction with the server system 8 (e.g., central data server 10 and email server 132). As the inclusion of multiple accounts could involve different billing periods on different schedules, the reports may be sent on any appropriate regular basis (e.g., a weekly basis every Monday morning).

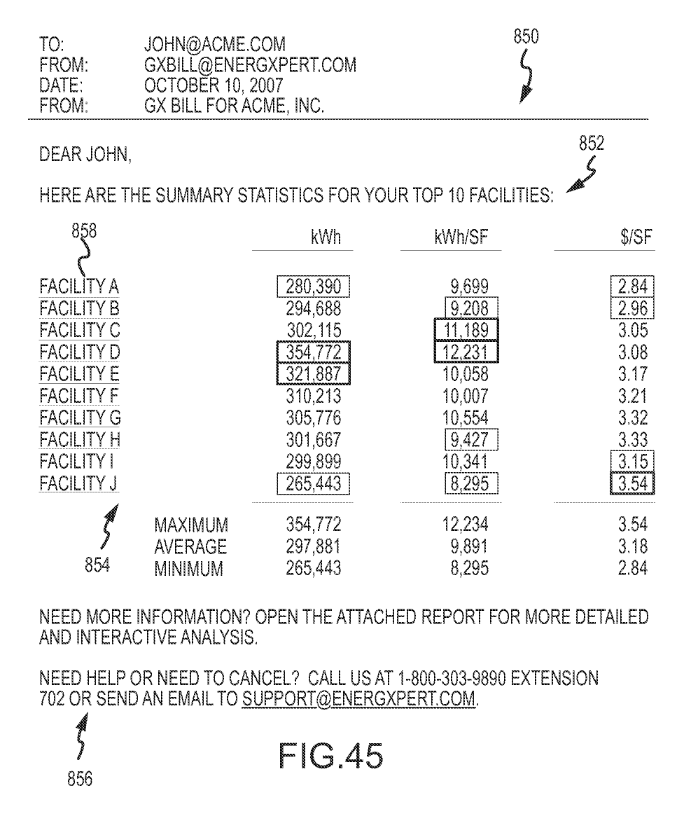

FIG. 45 presents an email report screen 850 that may be generated by the bill module and that may be appropriately sent to a user or customer with a spreadsheet attachment in an email message according to a regular basis (e.g., weekly) or any user configurable schedule. A body 852 of the screen 850 may include one or more sections each conveying different types of information and as shown, may include first and second sections 854, 856. The first section 854 may include one or more utility usage summary statistics for one or more customer facilities while the second section 856 may include any appropriate notes (e.g., open attached report) and/or help and/or cancellation instructions and information. While it can be seen that kWh, kWh/SF (e.g., for the past week) and $/SF have been displayed for each facility (e.g., Facilities A-J), it should be expressly understood that the email report screen 850 may be configurable to display those variables important to each customer. For instance, the customer may appropriately contact the administrator of the server system 8 to provide those variables the customers desires to be included within the email report screen 850 or else the email message may be interactive with any appropriate user manipulable features (e.g., drop down menus, up and down arrows) to select appropriate variables. Moreover, the facilities listed in the email report screen 850 may be appropriately sorted by any variable or calculated variable, and the variables may be appropriately manipulated (e.g., via coloring, shading) to indicate those variables in the highest and/or lowest percentile (e.g., greater than 80^{th} percentile, less than 20^{th} percentile) relative to the variables of other facilities. For instance, the variables of those facilities in the highest percentile may be color coded red while the variables of those facilities in the lowest percentile may be color coded green.

Each facility listed in the email report screen 850 may be in the form of a hyperlink 858 (or other user manipulable feature) in any appropriate color and font (e.g., blue underlined font). If a user reviewing the email report screen 850 wants to view more specific or detailed information for a particular facility, then the user may appropriately manipulate (e.g., click, touch) the hyperlink for such facility. Manipulation of this hyperlink (e.g., a “drill down” feature) will appropriately transmit a message to the server system 8 (e.g., central data server 10) which will then send a corresponding meter module email and spreadsheet attachment 604 (e.g., monthly and/or daily) to the addressee of the original email (e.g., the original email report screen 850 created and sent by the bill module. Such a design may provide a link between summary financial information contained in the email report screen 850 and detailed technical data contained in the monthly and/or daily spreadsheet report created by the meter module.

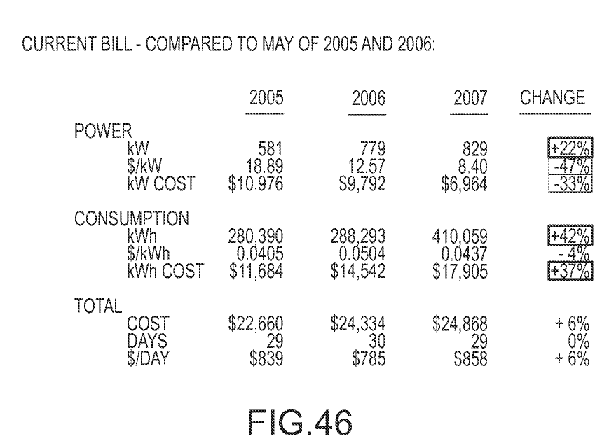

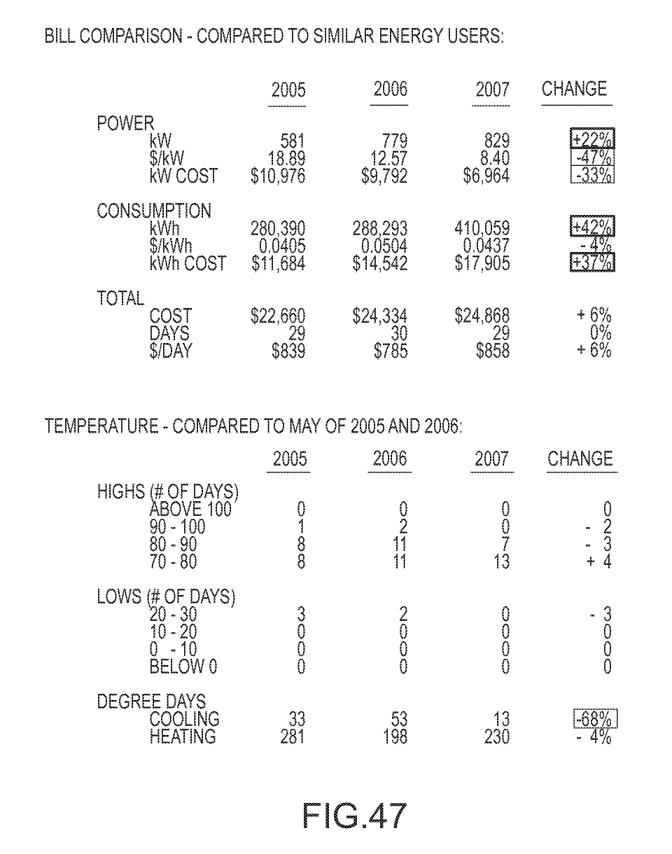

The email report screen 850 may also include additional regions or sections which may be in the form of a “current bill analysis”, a “bill comparison” and a “temperature” analysis as can be seen in FIGS. 46 and 47. As such sections are similar to those of FIGS. 19 and 20 which have been previously described, the sections will not be further discussed.

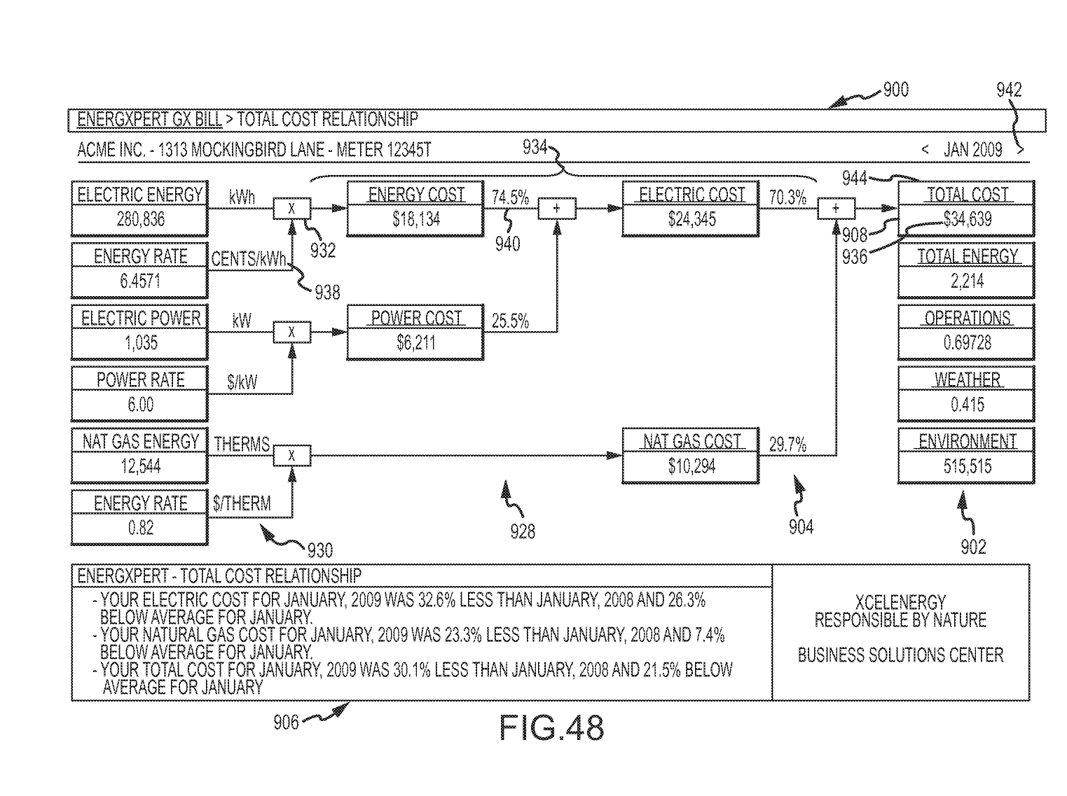

With reference to FIG. 48, a “total cost” screen of a user interface 900 of the bill module spreadsheet attachment may be presented once the user has chosen to open the spreadsheet attachment and the data (e.g., billing, interval) has finished downloading from the server system 8 (e.g., in the manner of FIG. 28). It will be appreciated that the bill module may be operable to create spreadsheet report attachments for one or more of the various facilities of each customer. The user interface 900 may include any appropriate number of menus, icons, pointing devices (e.g., cursors) and/or windows, for instance. Moreover, the user interface 900 may be manipulated in any appropriate manner including without limitation stylus, mouse, a user's appendage (e.g., finger), voice or eyes, etc. The user interface 900 may include one or more screens (e.g., Total Cost screen, Total Energy screen), each of which may include any appropriate number of regions (e.g., graphical display regions). Moreover, each of the graphical display regions may be operable to convey various types of information to a user and/or allow the user to manipulate the user interface 900. For instance, the user interface 900 may include first, second and third graphical display regions 902, 904, 906, each of which may include any appropriate number of boxes, cells, sections, tables, graphs, etc.

The first graphical display region 902 may be in the form of a “navigation area” including one or more navigation tabs or buttons 908. Each of the navigation buttons 908 may be appropriately manipulable or selectable and may direct a user to a different analysis tool on a different page or sheet. When a user appropriately selects a navigation button 908, the selected button 908 may be appropriately indicated and/or differentiated from the other buttons 908 to indicate the selection. For instance, the selected button 908 may acquire a background of one color (e.g., green) while the remaining buttons may all acquire a background of a different color (e.g., grey).

The second graphical display region 904 may be in the form of an “analysis area” which may provide the primary analysis area on each page depending upon the selected navigation button 908, and in this regard may include one or more graphical representations. The second graphical display region 904 may be generally organized to present the user with a simplified estimate of a number of elements (e.g., total cost, weather, environment). For instance, the second graphical display region 904 may include a graphical step-by-step calculation diagram 928 of the each of the elements, and the graphical step-by-step calculation diagram 928 may include any number of inputs, outputs, and calculation or operator symbols.

The graphical step-by-step calculation diagram 928 may organize the primary components of each element into a “cause and effect” type diagram that flows from left to right such that a number of inputs eventually result in one or more outputs. For instance, the diagram 928 may include a number of inputs 930 such as electric energy and energy rate, electric power and power rate, and natural gas energy and energy rate. Each quantity of utility usage (e.g., electric energy, electric power, natural gas energy) may be multiplied by its respective rate as may be illustrated by one or more operator symbols 932 to obtain a number of outputs or intermediate values 934. As can be seen, the intermediate values may be appropriately combined (e.g., added, divided, multiplied, subtracted) as is illustrated by additional operator symbols 932 to obtain a final output value 936 (e.g., total cost of $34,639). Stated otherwise, the operator symbols 932 may be operable to define mathematical relationships between inputs, intermediate values, etc. One or more unit and/or percentage graphics 938, 940 may be illustrated in the diagram 928 where appropriate. It will be appreciated that the structure of the rate calculations may vary for each utility and each jurisdiction within each utility.

The third graphical display region 906 may be in the form of one or more sections that convert numerical or tabular data from the second graphical display region 904 (e.g., inputs, intermediate values, outputs) into sentence or word form for efficient interpretation by managers, financial analysts, etc. The third graphical display region 906 may also include one or more marketing messages, advertisements, logos, and the like. A portion of the user interface 900 may also include any appropriate user manipulable feature allowing the user to modify the month of utility usage data being viewed. For instance, the user interface 900 may include a set of scroll arrows 942 that when manipulated allow the user to modify the month of utility data being viewed.

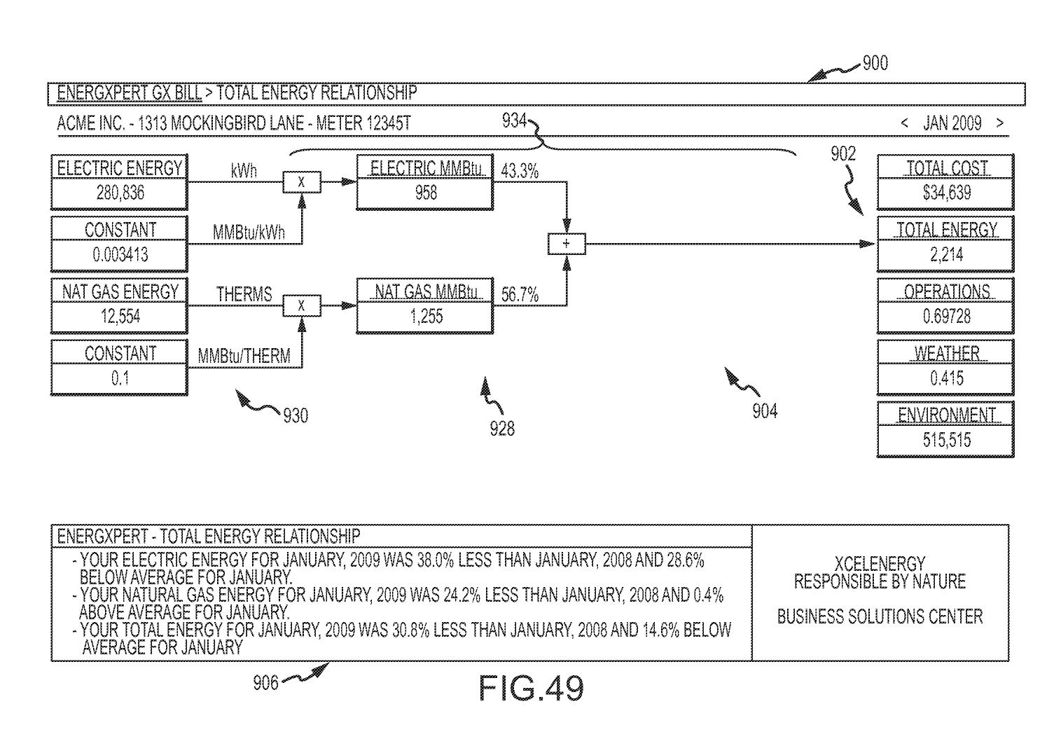

A “total energy” screen of the user interface 900 of the spreadsheet attachment is illustrated in FIG. 49. It may be important to understand the total energy (e.g., electric and natural gas energy) relationship because in some situations, savings may be realized for one utility service but offset by another utility server. Stated otherwise, a project to reduce electric energy consumption could create an equal and opposite increase in natural gas energy consumption resulting in a zero or near zero net reduction in utility consumption. Thus, it may be important to monitor the total energy contribution as well as the percentage contribution of all energy inputs. In this screen, the inputs 930 to the graphical step-by-step calculation diagram 928 of the second graphical display region 904 may be electric energy in kWh and natural gas energy in Therms as well as respective constants. For instance, each constant may by operable to, when multiplied by the electric energy and natural gas energy, convert each of the electric energy and natural gas energy into the same units. Thus, as illustrated, each of the respective constants is operable to convert the electric energy and natural gas energy into MMBtu (e.g., British Thermal Units) which may then be added together to generate a total cost in MMBtu.

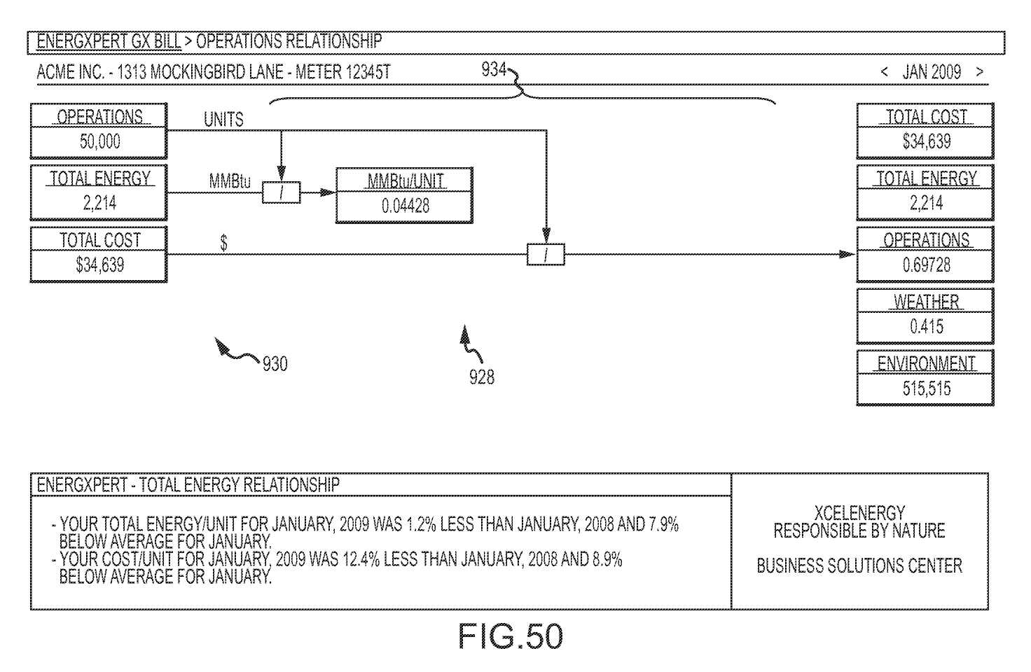

An “operations” screen of the user interface 900 of the spreadsheet attachment is illustrated in FIG. 50. In this screen, the inputs 930 may be “operations” or in other words units of a good, service, or building area (e.g., widgets, square footage), total energy in MMBtu (from the “total energy” screen), and total cost (from the “total cost” screen). This screen essentially “normalizes” any operational unit against Total Energy and/or Total Cost. Stated otherwise, this screen may produce and illustrate a quantity of energy per unit and/or a quantity of money per unit.

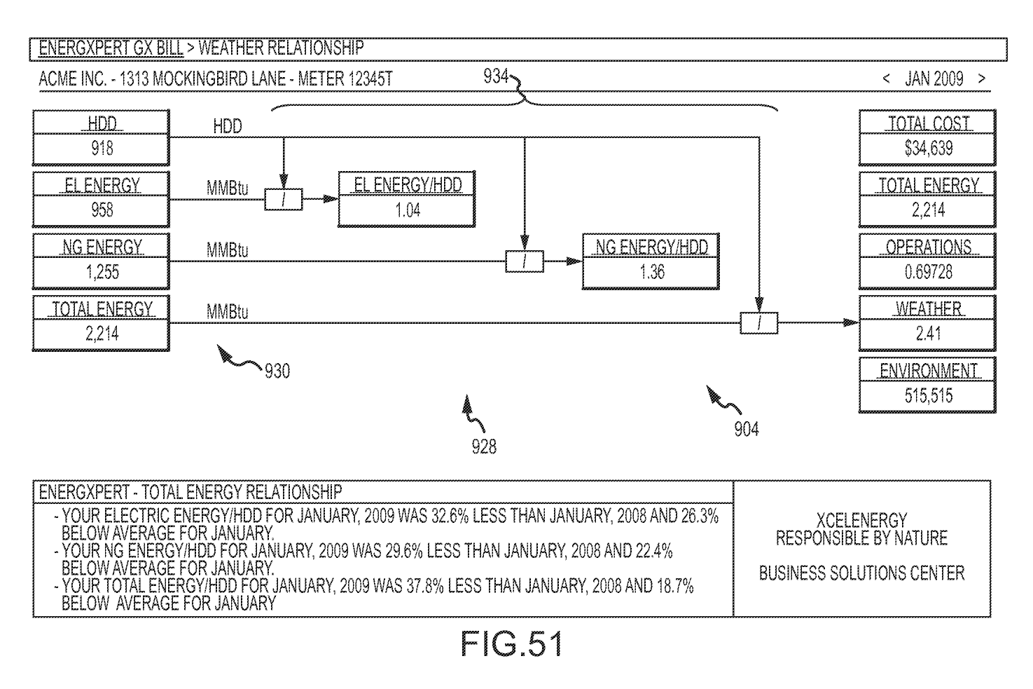

A “weather” screen of the user interface 900 of the spreadsheet attachment is illustrated in FIG. 51. In this screen, the inputs 930 may be heating or cooling degree days (HDD or CDD), electric energy in MMBtu (from the “total energy” screen), natural gas energy in MMBtu (from the “total energy” screen), and total energy (from the “total energy” screen). This screen essentially “normalizes” electric energy, natural gas energy and/or total energy against HDD in the winter or CDD in the summer. In other words, this screen produces and illustrates a quantity of electrical energy, natural gas energy, and/or total energy per HDD or CDD.

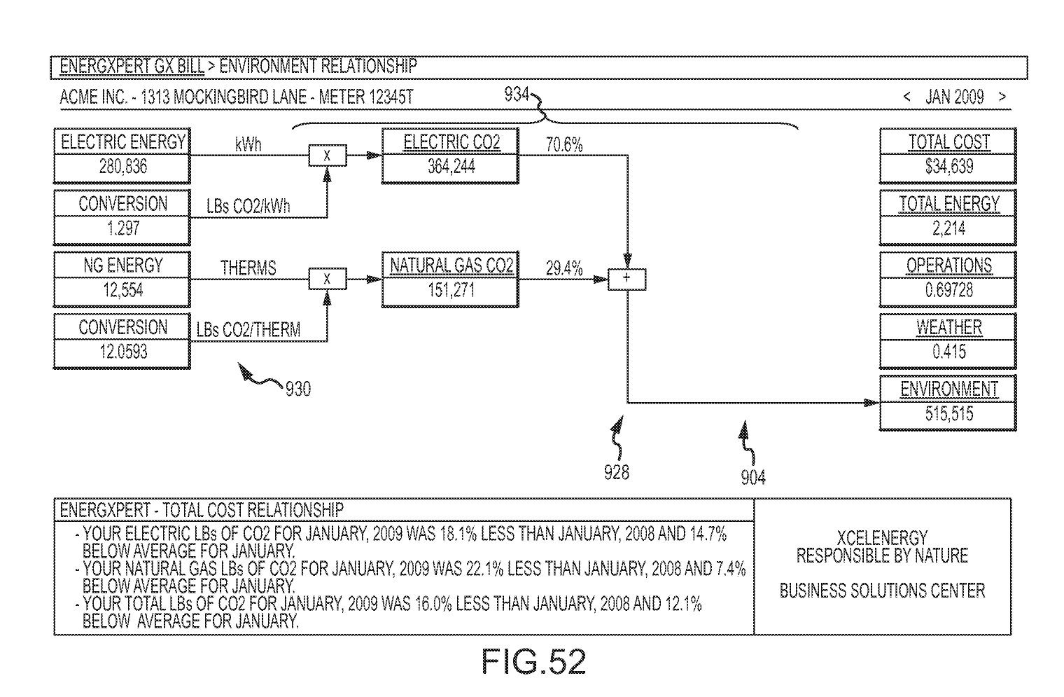

An “environment” screen of the user interface 900 of the spreadsheet attachment is illustrated in FIG. 52. In this screen, the inputs 930 may be electric energy in kWh, natural gas energy in Therms, and conversion factors for each to convert the electric and natural gas energy into any appropriate environmental pollutant or contaminant. For instance, each conversion factor may be operable to convert the electric and natural gas energy into a quantity of carbon dioxide (e.g., CO₂) in anticipation of increased environmental regulations. The converted intermediate values 934 may then be appropriately summed to generate a total quantity of CO₂ produced by electricity and natural gas use.

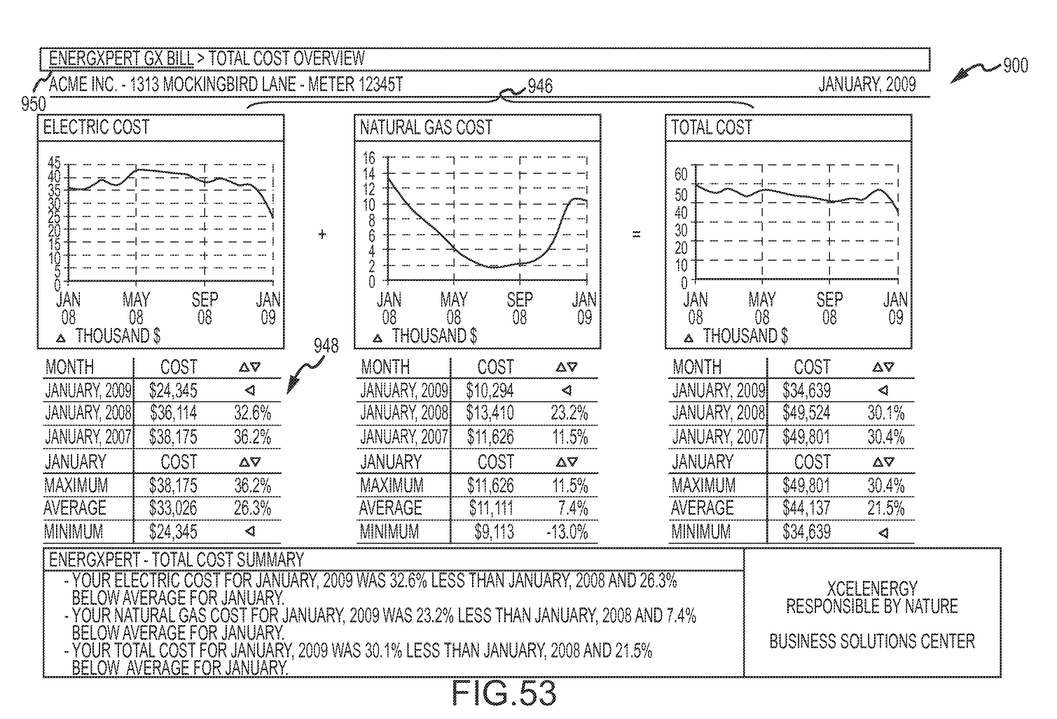

One or more of the inputs 930, intermediate values 934, outputs 936 and/or manipulation buttons 908 of the user interface 900 may include any appropriate user manipulable feature that may be manipulated by any appropriate user manipulable device to display more detailed or in-depth information regarding the specific input 930, intermediate value 934, output 936, and/or manipulation button 908 manipulated. For instance, with reference back to FIG. 48, the manipulation button 908 corresponding to “total cost” may include a hyperlink 944 or other feature (e.g., any portion of the manipulation button 908) that may be appropriately manipulated (e.g., double clicked) to cause the display of the “total cost overview” screen in FIG. 53.

The total cost overview screen illustrated in FIG. 53 generally may present the relationship between total cost and related components (e.g., electric cost and natural gas cost). In this screen, the first graphical display region 902 may be removed from the user interface 900 and the second graphical display region 904 may include one or more charts, tables with tabular information, and the like. For instance, the second graphical display region 904 may include a chart 946 and tabular data 948 corresponding to each of electric cost, natural gas cost and total cost. Each of the charts 946 may advantageously present the respective cost over the past thirteen months so the user may see the information for the same month in the previous year, although other time periods may be illustrated. The tabular data 948 may include a first portion with values for the current month as well as for the same month for previous years (e.g., 2 years) in addition to a percentage difference between the current month and values from the previous years. The tabular data 948 may also include a second portion with values for the current month (e.g., maximum, average, minimum) in addition to a percentage difference between the minimum value and the average and maximum values. Presenting utility usage information in various manners (e.g., charts, tables, sentences) advantageously allows people of all learning styles to appropriately retain information.

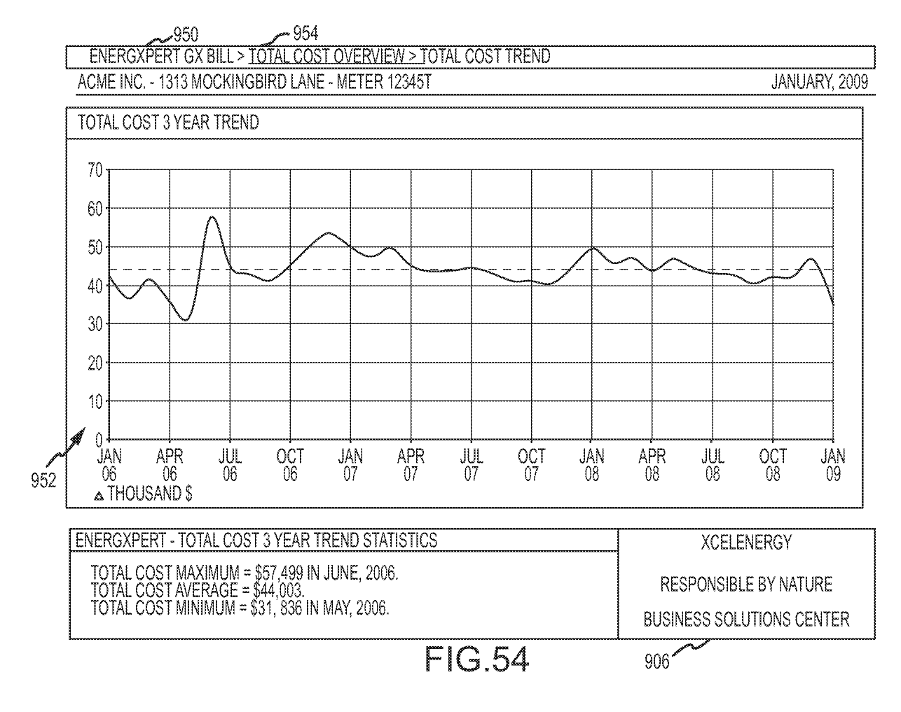

To return to the previous screen, the user may manipulate any appropriate user manipulable feature such as button or hyperlink 950. However, the user may additionally “drill-down” further into data on the “total cost overview” screen (or other screen) for further information. For instance, a portion of the second graphical display region 904 such as the chart 946 corresponding to “total cost” may include a button or hyperlink 952 that when appropriately manipulated may cause the display of the “total cost trend” screen in FIG. 54.

The total cost trend screen illustrated in FIG. 54 generally may present a continuous or long-term trend or view of total cost over any appropriate period of time (e.g., three years). In this screen, the first graphical display region 902 may be removed from the user interface 900 and the second graphical display region 904 may include one or more charts, tables with tabular information, and the like. For instance, the second graphical display region 904 may include a chart 952 plotting total cost versus time for three years in three month increments. The total cost trend screen may include another button or hyperlink 954 that when manipulated may return the user to the previous screen (e.g., total cost overview screen).

With reference to FIGS. 45-53 various data, values, inputs, and the like may be indicated or distinguished from other data, values, inputs or the like in any appropriate manner (e.g., patterning, coloring, shading) to provide an indication to a user that a particular piece of data needs attention, needs to be watched or is normal (e.g., ok). As can be seen in FIG. 45 for instance, the various values may be appropriately colored according to a “stop-light” color-coding scheme where red indicates that attention is needed, yellow indicates that the value needs to be watched, and green indicates that no action is needed (e.g., the value is ok). Logic associated with the server system 8 may be operable to systematically process one or more pieces of utility usage data included in the email messages, spreadsheet attachments, modules and the like and the result of the logic may determine the color each value or piece of data is to be.

For instance, a first input may consider a past period of data (e.g., thirteen months) and is “true” if the current or other billing period of data is within a particular percentile (e.g., top 20^{th} percentile). A second input may consider seasonal variations and may be compared to the same month one year earlier. This input may be “true” if the variable or particular piece of data for the current month is greater than some degree (e.g., 80%) of the same month one year earlier. The logic may then cause the piece of data to be colored red if the first and second inputs are true which signifies a high long-term and seasonal correlation. The logic may cause the piece of data to be colored yellow if either the first or second input is true which signifies a high long-term or seasonal correlation. The logic may cause the piece of data to be green if both the first and second inputs are false which signifies no long-term or seasonal correlation.

It will be appreciated that the various components of the distributed processing system 4 herein may be utilized in numerous other manners or locations other than in those specific embodiments disclosed herein. For instance, while the meter and bill modules were disclosed as being available to a user by way of a spreadsheet attached to an email, it is contemplated that such modules may be available to a user by way of accessing one or more websites via the Internet or even by way of purchasing such modules in a store. In such case, the previously described web query function could be used to acquire utility usage data or else one of the mobile and/or desktop modules could work in conjunction with the data synchronization module to acquire the utility usage data. Moreover, the utility usage data of various other types of utilities other than just those disclosed herein may be incorporated into the distributed processing system 4.

The foregoing description has been presented for purposes of illustration and description. Furthermore, the description is not intended to limit the invention to the form disclosed herein. Consequently, variations and modifications commensurate with the above teachings, and skill and knowledge of the relevant art, are within the scope of the embodiments disclosed herein. The embodiments described hereinabove are further intended to explain the best modes known of practicing the invention and to enable others skilled in the art to utilize the embodiments with various modifications required by the particular application(s). It is intended that the appended claims be construed to include alternative embodiments to the extent permitted by the prior art.

1. A method for allowing an end user to analyze utility usage data, the method comprising:
receiving utility usage data related to the end user at a server system, the server system including at least one memory module and at least one processor module;
storing the utility usage data in the at least one memory module; and
sending, using the at least one processor module, a first message to the user, the first message including a spreadsheet attachment that is operable to access and analyze the utility usage data.

2. The method of claim 1, further comprising:
using the at least one processor module to create an HTML webpage that includes the utility usage data; and
after creation of the HTML webpage, using the at least one processor module to trigger the server system to send the first message to the end user.

3. The method of claim 2, wherein the spreadsheet attachment is operable to access the utility usage data from the HTML webpage.

4. The method of claim 3, wherein the spreadsheet attachment is operable to access the HTML webpage using a web query function.

5. The method of claim 2, wherein upon creation of the HTML webpage, triggering the server system to send a second message to the end user.

6. The method of claim 5, wherein the server system sends the first and second messages at the same time.

7. The method of claim 5, wherein the second message is a text message.

8. The method of claim 1, wherein the spreadsheet attachment is operable to access the utility usage data upon the spreadsheet attachment being opened.

9. The method of claim 1, further comprising storing the spreadsheet attachment and utility usage data on a computing device.

10. The method of claim 2, wherein the server system is triggered on a monthly basis.

11. The method of claim 2, wherein the server system is triggered on a daily basis

12. The method of claim 1, wherein the spreadsheet attachment is operable to be run on a computing device that includes a display module;
wherein the spreadsheet attachment is operable to provide a display of an analysis of the utility usage data on the display module; the display comprising:
a first region providing access to a plurality of types of analysis of the utility usage data, and
a second region that is operable to provide an output of a selected one of the plurality of types of analysis.

13. The method of claim 12, wherein the first region comprises a plurality of buttons; wherein each of the plurality of buttons is operable to be manipulated by a user to provide access to a selected one of the plurality of types of analysis.

14. The method of claim 12, wherein the second region is operable to provide utility usage data from a number of time periods in a first year for a first location generally adjacent to utility usage data from a number of time periods in a second year for the first location.

15. The method of claim 12, wherein the second region is operable to provide an output of a selected one of the plurality of types of analysis for a first type of utility usage data over a plurality of time periods.

16. The method of claim 15, wherein the output is operable to be modified.

17. The method of claim 16, wherein a number of time periods of the plurality of time periods is operable to be selectively adjusted.

18. The method of claim 17, wherein the number of time periods of the plurality of time periods is operable to be selectively adjusted by way of a slide bar.

19. The method of claim 12, wherein the second region is operable to provide an output of a selected one of the plurality of types of analysis for first and second types of utility usage data over a plurality of time periods, the first and second types of utility usage data being different.

20. The method of claim 19, wherein the output of the first type of utility usage data is associated with a first color and the output of the second type of utility usage data is associated with a second color.

21. The method of claim 20, wherein the second region includes a first axis with utility usage information related to the first type of utility usage data and a second axis with utility usage information related to the second type of utility usage data.

22. The method of claim 21, wherein the first axis is associated with the first color and the second axis is associated with the second color.

23. The method of claim 12, wherein the output of a selected one of the plurality of types of analyses comprises a visual indication of a calculation of a value in a summary of a user's utility usage.

24. The method of claim 23, wherein the summary is a billing statement.

25. The method of claim 24, wherein at least one input in the calculation is operable to be manipulated.

26-69. (canceled)

70. A method for use with utility usage data, comprising:
using a gateway device to communicate with a plurality of utility usage recording devices over at least one telephone line;
receiving, in response to the using step, utility usage data from each of the plurality of utility usage recording devices in the gateway device over the at least one telephone line;
storing the utility usage data of each of the plurality of utility usage recording devices in a memory module of the gateway device; and
sending the utility usage data of at least one of the plurality of utility usage recording devices to a server system via at least one communication network, the server system being operable to manipulate the utility usage data for at least one end user.

71. The method of claim 70, wherein the using step further comprises:
calling each of the plurality of utility usage recording devices.

72. The method of claim 71, wherein the calling step further comprises:
establishing a connection with a modem of each of the plurality of utility usage recording devices.

73. The method of claim 70, wherein the using step further comprises:
communicating with a different one of the plurality of utility usage recording devices after each quantity of a predetermined period of time.

74. The method of claim 73, wherein the predetermined period of time is one minute.

75. The method of claim 70, wherein the sending step further comprises:
utilizing file transfer protocol.

76. The method of claim 70, wherein the sending step occurs multiple times per day.

77. The method of claim 76, wherein the sending step occurs approximately every hour.

78. The method of claim 70, further comprising:
sending, using at least one processor module, a first message to a user, the first message including a spreadsheet attachment that is operable to access and analyze the utility usage data from at least one of the utility usage recording devices.

79. The method of claim 78, further comprising:
using the at least one processor module to create an HTML webpage that includes the utility usage data; and
after creation of the HTML webpage, using the at least one processor module to trigger the server system to send the first message to the end user.

80. The method of claim 79, wherein the spreadsheet attachment is operable to access the utility usage data from the HTML webpage.

81. A system for use in allowing a user to analyze utility usage data, the system comprising:
a storage module for storing utility usage information;
computer readable instructions stored in the storage module that are operative to generate a first message to be sent to the user, the first message including a spreadsheet attachment that is operable to access and analyze the utility usage data; and
a processor module that is operative to execute the computer readable instructions to generate the first message and send the first message to the user.

82. The system of claim 81, wherein the computer readable instructions are operative to create an HTML webpage that includes the utility usage data, wherein the utility usage data is accessible by the spreadsheet attachment from the HTML webpage.

83. The system of claim 82, wherein the processor module is operative to send the first message to the user after creation of the HTML webpage.

84. The system of claim 83, wherein the processor module is operative to send the first message to the user on a configurable schedule.

85. The system of claim 84, wherein the configurable schedule is once every month.

86. The system of claim 84, wherein the configurable schedule is once every day.

87. The system of claim 82, wherein the computer readable instructions are operative to generate a second message to be sent to the user

88. The system of claim 87, wherein the processor is operable to send the first and second messages at the same time.

89. The system of claim 87, wherein the second message is a text message.

90. The system of claim 81, wherein the spreadsheet attachment is operable to be run on a computing device that includes a display module;
wherein the spreadsheet attachment is operable to provide a display of an analysis of the utility usage data on the display module; the display comprising:
a first region providing access to a plurality of types of analysis of the utility usage data, and
a second region that is operable to provide an output of a selected one of the plurality of types of analysis.

91. The system of claim 90, wherein the first region comprises a plurality of buttons; wherein each of the plurality of buttons is operable to be manipulated by a user to provide access to a selected one of the plurality of types of analysis.

92. The system of claim 90, wherein the second region is operable to provide utility usage data from a number of time periods in a first year for a first location generally adjacent to utility usage data from a number of time periods in a second year for the first location.

93. The system of claim 90, wherein the second region is operable to provide an output of a selected one of the plurality of types of analysis for a first type of utility usage data over a plurality of time periods.

94. The system of claim 93, wherein the output is operable to be modified.

95. The system of claim 94, wherein a number of time periods of the plurality of time periods is operable to be selectively adjusted.

96. The system of claim 95, wherein the number of time periods of the plurality of time periods is operable to be selectively adjusted by way of a slide bar.

97. The system of claim 90, wherein the second region is operable to provide an output of a selected one of the plurality of types of analysis for first and second types of utility usage data over a plurality of time periods, the first and second types of utility usage data being different.

98. The system of claim 97, wherein the output of the first type of utility usage data is associated with a first color and the output of the second type of utility usage data is associated with a second color.

99. The system of claim 98, wherein the second region includes a first axis with utility usage information related to the first type of utility usage data and a second axis with utility usage information related to the second type of utility usage data.

100. The system of claim 99, wherein the first axis is associated with the first color and the second axis is associated with the second color.

101. The system of claim 90, wherein the output of a selected one of the plurality of types of analyses comprises a visual indication of a calculation of a value in a summary of a user's utility usage.

102. The system of claim 101, wherein the summary is a billing statement.

103. The system of claim 102, wherein at least one input in the calculation is operable to be manipulated.

104. A system for use in allowing a user to analyze utility usage data, the system comprising:
a creation module for creating an HTML webpage that includes utility usage data; and
a triggering module for sending a first message to the user after creation of the HTML webpage, the first message including a spreadsheet attachment that is operable to access and analyze the utility usage data.

105. The system of claim 104, wherein the spreadsheet attachment is operable to access the utility usage data from the HTML webpage.

106. The system of claim 105, wherein the spreadsheet attachment is operable to access the HTML webpage using a web query function.
